(19) United States
(12) Patent Application Publication
(10) Pub. No.: US 2015/0370935 A1
(43) Pub. Date: Dec. 24, 2015

(54) AGRONOMIC SYSTEMS, METHODS AND APPARATUSES

(71) Applicant: 360 Yield Center, LLC, Morton, IL (US)

(72) Inventor: Daryl B. Starr, Lafayette, IN (US)

(21) Appl. No.: 14/749,082

(22) Filed: Jun. 24, 2015

Related U.S. Application Data
(60) Provisional application No. 62/016,624, filed on Jun. 24, 2014.
(60) Provisional application No. 62/054,870, filed on Sep. 24, 2014.

(51) Int. Cl. G06F 17/50

(52) U.S. Cl. CPC G06F 17/5009

(57) ABSTRACT

In one aspect, a method of operating an agricultural system is provided and includes obtaining, with a computing element, first data associated with a plurality of agronomic characteristics from at least one source, identifying one of the plurality of agronomic characteristics that limits the yield of an agricultural crop with the computing element based on the first data, generating second data associated with the one of the plurality of agronomic characteristics that limits the yield of an agricultural crop with the computing element, and communicating, with the computing element, the second data associated with the one of the plurality of agronomic characteristics that limits the yield of an agricultural crop over a network to an electronic device. In one aspect, an agricultural system is provided and includes a source, a computing element including a processor and a memory, a network, and an electronic device.

### RELATED APPLICATIONS

The present application claims the priority benefit of co-pending U.S. Provisional Patent Application Nos. 62/016,624, filed Jun. 24, 2014, and 62/054,870, filed Sep. 24, 2014, the contents of all of which are incorporated by reference herein in their entirety.

### FIELD OF THE INVENTION

The present disclosure relates generally to agronomics and, more particularly, to agronomic systems, methods and apparatuses.

### BACKGROUND

Today, the most common farming practice includes planting identical plant variety and consistent plant population across an entire field and applying inputs, such as fertilizers, herbicides, insecticides, etc., to the entire field at a constant rate. These conventional practices are performed with a belief that a uniform plant variety, uniform plant population, and/or uniform rate of input application over the entire field will maximize crop yield. Unfortunately, these conventional practices result in maximizing crop yield much less than they succeed. Many reasons exist that cause these conventional practices to fail such as, for example, inconsistent soil types and conditions, inconsistent crop conditions, inconsistent weather patterns, inconsistent soil slopes, etc. Thus, many inconsistencies exist across an entire field that impact the growth of a crop. These conventional practices may also result in wasted money, actually reduce crop yield, and potentially damage the environment through over application of inputs (e.g., fertilizers, herbicides, insecticides, or any other chemicals or inputs applied to the field).

Precision farming is a term used to describe the management of intra-field variations in soil and crop conditions, specifically tailoring soil and crop management to conditions at discrete, usually contiguous, locations throughout a field. Typical precision farming techniques include: Varying plant varieties and plant population based on the ability of the soil to support growth of the plants; and selective application of farming inputs or products such as herbicides, insecticides, and fertilizers. Thus, precision farming may have at least three advantages over conventional practices. First, precision farming may increase crop yields by at least determining correct plant varieties and application rates of seeds, herbicides, pesticides, fertilizer and other inputs for specific fields. This advantage may also result in greater profits for the farmer. Second, precision farming may lower a farmer's expense associated with producing a crop by utilizing appropriate quantities of seeds and inputs for each particular field. That is, application rates of seeds, herbicides, pesticides, fertilizer, and other inputs are determined based on specific characteristics of each field. Finally, precision farming may have a less harmful impact on the environment by reducing quantities of excess inputs and chemicals applied to a field, thereby reducing quantities of inputs and chemicals that may ultimately find their way into the atmosphere and water sources, such as ponds, streams, rivers, lakes, aquifers, etc.

However, precision farming practices used today fail to account for many agronomic factors required to effectively manage crops and fields, nor do these precision farming practices identify an agronomic factor that limits a yield for crops and fields. Moreover, past efforts pertaining to precision farming are time consuming and focus on a limited set of agronomic factors.

Furthermore, agronomic forecasting is dependent heavily on historic data from previous planting seasons. As is often the case, past performance is not a guarantee of future results. That is, agronomic factors differ from year to year and heavy reliance on historic data (e.g., rainfall) can increase the inaccuracy of forecasts.

Still further, many growers or farmers set expectations for crop yield prior to planting, then formulate forecasts on how to achieve these expectations. Forecasting in this manner sets artificial restrictions on yield and often results in inefficiencies and wasted resources.

### SUMMARY

In one example, there is a need for one or more agronomic systems, methods and/or apparatuses that cure one or more of these problems.

In one example, there is a need for a system, method and/or apparatus that increases crop yield.

In one example, there is a need for a system, method and/or apparatus that identifies an agronomic factor that limits crop yield.

In one example, there is a need for a system, method and/or apparatus that senses soil and/or crop conditions in real-time, evaluates agronomic factors impacting a particular crop, identifies the agronomic factor that limits crop yield (i.e., the limiting factor) and informs a user/farmer of the limiting factor to enable the user/farmer to take action to decrease or eliminate the limiting factor's impact on the crop.

In one example, a method of operating an agricultural system is provided and includes obtaining, with a computing element, first data associated with a plurality of agronomic characteristics from at least one source, identifying one of the plurality of agronomic characteristics that limits the yield of an agricultural crop with the computing element based on the first data, generating second data associated with the one of the plurality of agronomic characteristics that limits the yield of an agricultural crop with the computing element, and communicating, with the computing element, the second data associated with the one of the plurality of agronomic characteristics that limits the yield of an agricultural crop over a network to an electronic device.

In one example, the source includes at least one of a database, a data collection device, an agricultural device and an electronic device.

In one example, the electronic device associated with the source is at least one of a personal computer and a mobile electronic communication device.

In one example, the data collection device is at least one of a sensor, a soil testing device, a thermometer, a barometer, an aerial vehicle, an image capturing device, a wind speed determining device, a moisture sensor, and a satellite.

In one example, the electronic device associated with the source is the same as the electronic device to which the second data is communicated.

In one example, the source includes at least two of a database, a data collection device, an agricultural device and an electronic device.

In one example, the electronic device is at least one of a personal computer, a mobile electronic communication device and an agricultural device.

In one example, the agricultural device is at least one of a tractor, a planter, a harvester, a sprayer, an irrigation system, and a soil working implement.

In one example, the electronic device is an agricultural device, the method further comprising displaying an image associated with the one of the plurality of agronomic characteristics that limits the yield of an agricultural crop on a display of the agricultural device.

In one example, the plurality of agricultural characteristics is associated with at least one of seed characteristics, weather characteristics and soil characteristics.

In one example, the plurality of agricultural characteristics is associated with at least two of seed characteristics, weather characteristics and soil characteristics.

In one example, the plurality of agricultural characteristics is associated with at least two of tillage practices, drainage, irrigation, seed traits, seed population, row width, vegetative state, sunlight, soil properties, nutrient uptake, micronutrient uptake, organic matter, root room, aeration, soil temperature, soil moisture, cation exchange capacity, soil pH, historical weather, plant moisture, water quality, slope of land area, as applied planting data, historical planting data, historical yield data, as applied fertilizer data, historical fertilizer data, historical weather data, current weather data, pests, diseases, weeds, and economic data.

In one example, the obtaining first data further comprises obtaining first data associated with planting date, row width, seed traits, seed population, soil properties, nutrient uptake, organic matter, a soil sample, historical weather data and current weather data.

In one example, obtaining first data further comprises obtaining first data associated with a tillage practice, drainage, irrigation, planting date, relative maturity, plot trial data, growing degree days, ear flex, crop water requirements, crop nutrient and micronutrient needs, actual seed population, row width, current vegetative state, soil properties, previous and current crop nutrient uptake, previous and current crop micronutrient uptake, organic matter, initial nitrogen content, initial potassium content, initial phosphorous content, nitrogen losses, nitrogen form, soil water holding capacity, mineralization, C:N ratio, root room, aeration, soil temperature, soil moisture, cation exchange capacity, soil pH, historical weather, plant moisture, sodicity, salinity, boron, chloride, pH of available water, slope of land area, as applied and historical planting data, historical harvest data, as applied and historical fertilizer data, weather patterns, short range weather forecast, long range weather forecast, rainfall, frost, wind, air temperature, humidity, barometric pressure, sunlight, type of weather events, pests, diseases, weeds and economic data.

In one example, obtaining further comprises obtaining the first data associated with the plurality of agronomic characteristics from a plurality of sources.

In one example, the method further comprises outputting information associated with the second data with an output device of the electronic device.

In one example, outputting further comprises displaying the one of the plurality of agronomic characteristics that limits the yield of an agricultural crop on a display.

In one example, the method further comprises performing an agricultural action with an agricultural device based on the information outputted by the output device.

In one example, the method further comprising performing an agricultural action with an agricultural device based on the second data communicated by the computing element.

In one example, the second data comprises identification of the one of the agricultural characteristics that limits yield of a crop and a recommendation of an agricultural action to be taken to address the one of the agricultural characteristics that limits yield of a crop as being the limiting agronomic characteristic.

In one example, the method further comprises displaying an image associated with the one of the plurality of agronomic characteristics that limits the yield of an agricultural crop on a display of the electronic device.

In one example, the network is at least one of a cellular network, an Internet, an intranet, a local area network (LAN), a wide area network (WAN), and a cable network.

In one example, the method further comprises determining a crop yield with the computing element based on the first data, generating third data associated with the crop yield with the computing element, and communicating, with the computing element, the third data associated with the crop yield over a network to the electronic device.

In one example, the crop yield is a first crop yield, the method further comprises obtaining, with the computing element, fourth data associated with the plurality of agronomic characteristics from the at least one source, wherein the fourth data is different than the first data, identifying one of the plurality of agronomic characteristics that limits the yield of an agricultural crop with the computing element based on the fourth data, determining a second crop yield with the computing element based on the fourth data, generating, with the computing element, fifth data associated with the second crop yield, generating, with the computing element, sixth data associated with the one of the plurality of agronomic characteristics that limits the yield of an agricultural crop based on the fourth data, and communicating, with the computing element, the fifth data and the sixth data over a network to the electronic device.

In one example, the method further comprises altering at least one of the plurality of agronomic characteristics to provide the fourth data.

In one example, the method further comprises altering at least one of the plurality of agronomic characteristics with an input device on the electronic device to provide the fourth data.

In one example, altering occurs subsequent to communicating the second data to the electronic device and prior to obtaining the fourth data.

In one example, the plurality of agricultural characteristics is associated with at least one of a seed characteristic, a weather characteristic, a soil characteristic and an economic characteristic.

In one example, the economic characteristic is associated with at least one of seed cost, cost per seed, input cost, fuel cost, labor cost, break even cost and fuel efficiency of equipment.

In one example, the input cost is associated with at least one of nitrogen cost, irrigation cost and pesticide cost.

In one example, an agricultural system is provided and includes a source including first data associated with a plurality of agricultural characteristics, a computing element including a processor and a memory, wherein the computing element is configured to receive the first data from the source and identify a limiting agronomic characteristic from the plurality of agronomic characteristics that limits a yield of a crop, and wherein the computing element is configured to generate second data associated with the limiting agronomic characteristic, a network over which the computing element is configured to communicate the second data, and an electronic device configured to receive the second data over the network from the computing element, wherein the electronic device includes an output device for outputting information associated with the second data.

In one example, the source includes at least one of a database, a data collection device, an agricultural device and an electronic device.

In one example, the electronic device associated with the source is at least one of a personal computer and a mobile electronic communication device.

In one example, the data collection device is at least one of a sensor, a soil testing device, a thermometer, a barometer, an aerial vehicle, an image capturing device, a wind speed determining device, a moisture sensor, and a satellite.

In one example, the electronic device associated with the source is the same as the electronic device to which the second data is communicated.

In one example, the source includes at least two of a database, a data collection device, an agricultural device and an electronic device.

In one example, the electronic device is at least one of a personal computer, a mobile electronic communication device and an agricultural device.

In one example, the agricultural device is at least one of a tractor, a planter, a harvester, a sprayer, an irrigation system and a soil working implement.

In one example, the electronic device is an agricultural device, and wherein the agricultural device includes a display that is configured to display an image associated with the one of the plurality of agronomic characteristics that limits the yield of an agricultural crop.

In one example, the plurality of agricultural characteristics is associated with at least one of seed characteristics, weather characteristics and soil characteristics.

In one example, the plurality of agricultural characteristics is associated with at least two of seed characteristics, weather characteristics and soil characteristics.

In one example, the plurality of agricultural characteristics is associated with at least two of tillage practices, drainage, irrigation, seed traits, seed population, row width, vegetative state, sunlight, soil properties, nutrient uptake, micronutrient uptake, organic matter, root room, aeration, soil temperature, soil moisture, cation exchange capacity, soil pH, historical weather, plant moisture, water quality, slope of land area, as applied planting data, historical planting data, historical yield data, as applied fertilizer data, historical fertilizer data, historical weather data, current weather data, pests, diseases, weeds, and economic data.

In one example, the first data is associated with at least two of planting date, row width, seed traits, seed population, soil properties, nutrient uptake, organic matter, soil sample, historical weather data and current weather data.

In one example, the first data is associated with at least five of a tillage practice, drainage, irrigation, planting date, relative maturity, plot trial data, growing degree days, ear flex, crop water requirements, crop nutrient and micronutrient needs, actual seed population, row width, current vegetative state, soil properties, previous and current crop nutrient uptake, previous and current crop micronutrient uptake, organic matter, initial nitrogen content, initial potassium content, initial phosphorous content, nitrogen losses, nitrogen form, soil water holding capacity, mineralization, C:N ratio, root room, aeration, soil temperature, soil moisture, cation exchange capacity, soil pH, historical weather, plant moisture, sodicity, salinity, boron, chloride, pH of available water, slope of land area, as applied and historical planting data, historical harvest data, as applied and historical fertilizer data, weather patterns, short range weather forecast, long range weather forecast, rainfall, frost, wind, air temperature, humidity, barometric pressure, sunlight, type of weather events, pests, diseases, weeds and economic data.

In one example, the source is one of a plurality of sources, and wherein the first data originates from the plurality of sources.

In one example, the electronic device includes an output device configured to output information associated with the second data.

In one example, the output device is a display and the electronic device is configured to display an image thereon associated with the one of the plurality of agronomic characteristics that limits the yield of an agricultural crop.

In one example, the system further comprises an agricultural device configured to perform an agricultural action based on the information outputted by the output device.

In one example, the system further comprises an agricultural device configured to perform an agricultural action based on the second data.

In one example, the second data comprises identification of the one of the agricultural characteristics that limits yield of a crop and a recommendation of an agricultural action to be taken to address the one of the agricultural characteristics that limits yield of a crop as being the limiting agronomic characteristic.

In one example, the electronic device includes a display configured to display an image associated with the one of the plurality of agronomic characteristics that limits the yield of an agricultural crop.

In one example, the network is at least one of a cellular network, an Internet, an intranet, a local area network (LAN), a wide area network (WAN), and a cable network.

In one example, a method of operating an agricultural system is provided an includes obtaining, with a computing element, first data associated with a first agricultural characteristic, determining a first crop yield based on the first data with the computing element, determining, with the computing element, a crop yield loss associated with the first crop yield, obtaining, with a computing element, second data associated with a second agricultural characteristic, determining a second crop yield based on the second data with the computing element, determining, with the computing element, a crop yield loss associated with the second crop yield, comparing, with the computing element, the first crop yield and the second crop yield, identifying, with the computing element, a largest crop yield and a lowest crop yield of the first crop yield and the second crop yield, and establishing, with the computing element, the one of the first and second agricultural characteristics associated with the lowest crop yield as a limiting agricultural characteristic.

In one example, the first and second agricultural characteristics are associated with two of a seed characteristic, a weather characteristic and a soil characteristic.

In one example, the method further comprises communicating, with the computing element, third data associated with the limiting agricultural characteristic over a network to an electronic device.

In one example, the method further comprises displaying an image associated with the limiting agricultural characteristic on a display of the electronic device.

In one example, the method further comprises obtaining, with the computing element, third data associated with a third agricultural characteristic, determining a third crop yield based on the third data with the computing element, determining a crop yield loss associated with the third crop yield, wherein comparing further comprises comparing, with the computing element, the first crop yield, the second crop yield and the third crop yield, wherein identifying further comprises identifying, with the computing element, a largest crop yield, a middle crop yield and a lowest crop yield of the first crop yield, the second crop yield and the third crop yield, and wherein establishing further comprises establishing, with the computing element, the one of the first, second and third agricultural characteristics associated with the lowest crop yield as a limiting agricultural characteristic.

In one example, the first agricultural characteristic is a seed characteristic, the second agricultural characteristic is a weather characteristic and the third agricultural characteristic is a soil characteristic.

In one example, the crop yield loss is a crop yield loss percentage.

In one example, a method of operating an agricultural system is provided and includes obtaining, with a computing element, first data associated with a slope of a land area, obtaining, with the computing element, second data associated with a quantity of water for the land area, determining, with the computing element, a distributed quantity of water for the land area at least partially based on effect of the slope on the quantity of water, determining, with the computing element, soil moisture of the land area at least partially based on the distributed quantity of water, determining, with the computing element, a limiting agronomic characteristic that limits a yield of a crop on the land area at least partially based on the soil moisture, and communicating, with the computing element, third data associated with the limiting agronomic characteristic over a network to an electronic device.

In one example, the method further comprises displaying an image associated with the limiting agricultural characteristic on a display of the electronic device.

In one example, the electronic device is at least one of a personal computer, a mobile electronic communication device and an agricultural device.

In one example, the network is at least one of a cellular network, an Internet, an intranet, a local area network (LAN), a wide area network (WAN), and a cable network.

In one example, a method of determining soil moisture for a land area is provided and includes obtaining first data, with a computing element, associated with an initial soil water volume of the land area from a first source, obtaining second data, with the computing element, associated with a soil moisture volume change of the land area from a second source, and determining the soil moisture of the land area at least partially based on the initial soil water volume and an effect the soil moisture volume change has on the initial soil water volume.

In one example, the first source and the second source are a same source.

In one example, the first source is a database.

In one example, the first source and the second source are at least one database.

In one example, the first source is a moisture sensor.

In one example, the first source and the second source is a moisture sensor.

In one example, the first source is a database and the second source is a moisture sensor.

In one example, the soil moisture volume change is a positive value if water is added to the land area and the soil moisture volume change is a negative value if water is not added to the land area, and wherein the soil moisture increases when the soil moisture volume change is positive and the soil moisture decreases when the soil moisture volume change is negative.

In one example, water may be added to the land area by at least one of rainfall and irrigation.

In one example, the soil moisture volume change is referred to as soil dryout when the soil moisture volume is negative, and wherein the soil dryout is between about −0.005 and about −0.05 inches per hour.

In one example, the soil moisture volume change is referred to as soil dryout when the soil moisture is negative, and wherein the soil dryout is between about −0.010 and about −0.021 inches per hour.

In one example, the method further comprises determining an end soil water volume based on the effect the soil moisture volume change has on the initial soil water volume with the computing element, and dividing the end soil water volume by a soil water holding capacity with the computing element to determine the soil moisture with the computing element.

In one example, the method further comprises designating a new initial soil water volume of the land area based on the determined soil moisture with the computing element, obtaining third data, with the computing element, associated with a second soil moisture volume change of the land area, and determining a second soil moisture of the land area based on the new initial soil water volume and an effect the second soil moisture volume change has on the new initial soil water volume.

In one example, determining the second soil moisture occurs at a time increment after determining the soil moisture, and wherein the time increment may be one of a second, a plurality of seconds, a minute, a plurality of minutes, an hour, a plurality of hours, a day, a plurality of days, a month, a plurality of months, or a year.

In one example, the method further comprising displaying the soil moisture of the land area on a display.

In one example, the method further comprises displaying a map image and an indicator associated with the soil moisture of the land area on a display.

In one example, the method further comprises determining a color of the indicator based on the soil moisture of the land area.

In one example, the indicator may be at least one of text, one or more numbers and color coded based on the soil moisture.

In one example, a method of increasing yield of an agricultural crop is provided and includes obtaining first data associated with a first value of an agricultural characteristic with a computing element, determining a first crop yield based on the first data with the computing element, obtaining second data associated with a second value of the agricultural characteristic with the computing element, determining a second crop yield based on the second data with the computing element, determining if the second crop yield is greater than the first crop yield with the computing element, and outputting information with an output device associated with a lowest of the first crop yield and the second crop yield.

In one example, the second value is less than the first value.

In one example, the second value is greater than the first value.

In one example, the method further comprises obtaining third data associated with a third value of the agricultural characteristic with a computing element, and determining a third crop yield based on the third data with the computing element.

In one example, a first interval is defined between the first value and the second value and a second interval is defined between the second value and the third value.

In one example, the first interval is equal to the second interval.

In one example, the first interval is different than the second interval.

In one example, the second interval is smaller than the first interval.

In one example, the first interval is smaller than the second interval.

In one example, the method further comprises determining the first interval and the second interval with the computing element.

In one example, the method further comprises selecting the first interval and the second interval with an input device, and communicating data associated with the selected first interval and the second interval to the computing element.

In one example, an interval is defined between the first value and the second value, the method further comprising determining the interval with the computing element.

In one example, an interval is defined between the first value and the second value, the method further comprises selecting the interval with an input device, generating interval data associated with the selected interval with the input device, and communicating the interval data associated with the selected interval to the computing element.

In one example, the agricultural characteristic is associated with one of a seed characteristic, a nitrogen characteristic or a water characteristic.

In one example, the first value and the second value of the agricultural characteristic are two of a plurality of values associated with the agricultural characteristic, the method further comprises establishing an upper threshold of values associated with the agricultural characteristic and a lower threshold of values associated with the agricultural characteristic, and obtaining data associated with the plurality of values of the agricultural characteristic within the upper and lower thresholds.

In one example, establishing an upper threshold and a lower threshold further comprises establishing the upper threshold and the lower threshold with the computing element.

In one example, the method further comprises preventing modification of the upper and lower thresholds with the computing element.

In one example, establishing an upper threshold and a lower threshold further comprises selecting the upper threshold with an input device, generating upper threshold data associated with the selected upper threshold with the input device, selecting the lower threshold with the input device, generating lower threshold data associated with the selected lower threshold with the input device, and communicating the upper threshold data and the lower threshold data associated with the selected upper and lower thresholds to the computing element.

In one example, the first value and the second value of the agricultural characteristic are two of a plurality of values associated with the agricultural characteristic, the method further comprises continuing to obtain data, with the computing element, associated with the plurality of values of the agricultural characteristic until a difference between resulting crop yields is less than a predetermined difference.

In one example, the first value and the second value of the agricultural characteristic are two of a plurality of values associated with the agricultural characteristic, the method further comprises continuing to obtain data, with the computing element, associated with the plurality of values of the agricultural characteristic until a resulting crop yield is less than a prior determined crop yield.

In one example, the first value and the second value of the agricultural characteristic are two of a predetermined quantity of values associated with the agricultural characteristic, the method further comprises obtaining data associated with the predetermined quantity of values of the agricultural characteristic with the computing element, and determining a predetermined quantity of crop yields, with the computing element, based on the data associated with the predetermined quantity of values.

In one example, the method further comprises comparing, with the computing element, the predetermined quantity of crop yields to identify a largest crop yield.

In one example, the second value is greater than the first value and a first difference is provided between the first value and the second value, the method further comprises obtaining third data associated with a third value of the agricultural characteristic with the computing element, wherein the third value is less than the first value and a second difference is provided between the first value and the third value, determining a third crop yield based on the third data with the computing element, and determining if the third crop yield is greater than at least one of the first crop yield and the second crop yield with the computing element.

In one example, the output device is a display, and wherein outputting further comprises displaying information on the display associated with the lowest of the first crop yield and the second crop yield.

In one example, a method of associating at least one agricultural characteristic with an agricultural land area is provided and includes determining, with a computing element, a quantity of water associated with the agricultural land area, determining a centroid of the agricultural land area with the computing element, determining a slope of the agricultural land area with the computing element, and establishing, with the computing element, a water value of the agricultural land area based on the slope of the land area, and associating, with the computing element, the water value with the centroid of the agricultural land area.

In one example, determining a quantity of water impacting the agricultural land area further comprises obtaining weather data associated with the agricultural land area from a database by the computing element.

In one example, determining a quantity of water impacting the agricultural land area further comprises measuring a quantity of water impacting the agricultural land area with a water measurement device, generating weather data based on a quantity of water measured by the water measurement device, and communicating the weather data from the water measurement device to the computing element over a network.

In one example, determining a quantity of water impacting the agricultural land area further comprises obtaining first weather data associated with the agricultural land area from a database by the computing element, and obtaining second weather data from a water measurement device configured to measure a quantity of water associated with the agricultural land area.

In one example, determining a centroid of the agricultural land area further comprises determining a geographic midpoint of the agricultural land area.

In one example, determining a centroid of the agricultural land area further comprises determining a latitude and longitude coordinate associated with the agricultural land area, converting the latitude and longitude coordinate to a Cartesian coordinate with the computing element, multiplying each of a x-coordinate, a y-coordinate and a z-coordinate of the Cartesian coordinate with a weighting factor with the computing element to obtain a second Cartesian coordinate, determining an intersection between a line extending from a center of Earth to the second Cartesian coordinate with the computing element, assigning the intersection as the centroid of the agricultural land area with the computing element, and converting the centroid to a latitude and longitude centroid coordinate.

In one example, determining a centroid further comprises determining a centroid of the agricultural land area with the computing element without the computing element having a land identifier code.

In one example, associating the water value with the centroid of the agricultural land area further comprises associating, with the computing element, the water value with the centroid of the agricultural land area without the computing element having a land identifier code.

In one example, determining a slope of the agricultural land area further comprises allocating a negative value to the slope, with the computing element, if the agricultural land area is configured to collect water, and allocating a positive value to the slope, with the computing element, if the agricultural land area is configured to allow water to runoff.

In one example, establishing a water value further comprises increasing the water value, with the computing element, if the slope has the negative value, and decreasing the water value, with the computing element, if the slope has the positive value.

In one example, establishing a water value further comprises establishing a higher water value, with the computing element, if the slope of the agricultural land area is configured to collect water, and establishing a lower water value, with the computing element, if the slope of the agricultural land area is configured to shed water.

In one example, establishing a water value further comprises equating the water value to the quantity of water associated with the agricultural land area, with the computing element, if the slope of the agricultural land area is substantially flat.

In one example, the quantity of water associated with the agricultural land area is a result of one or more of rainfall and irrigation.

In one example, the agricultural land area is a first portion of a field, the centroid is a first centroid, and the water value is a first water value, the method further comprising determining, with the computing element, a second water value associated with a second portion of the field.

In one example, determining a second water value associated with a second portion of the field further comprises determining a quantity of water associated with the second portion of the field with the computing element, determining a second centroid of the second portion of the field with the computing element, determining a slope of the second portion of the field with the computing element, establishing, with the computing element, a second water value of the second portion of the field based on the slope of the second portion of the field, and associating, with the computing element, the second water value with the second centroid of the second portion of the agricultural land area.

In one example, the method further comprises determining, with the computing element, a quantity of nitrogen associated with the agricultural land area, establishing, with the computing element, a nitrogen value of the agricultural land area based on at least one of the slope of the land area and the water value, and associating, with the computing element, the nitrogen value with the centroid of the agricultural land area.

In one example, a method of operating an agricultural system is provided and includes receiving, with a computing element of the system, first data associated with a first agricultural land area having a first boundary, determining a first centroid of the first agricultural land area with the computing element, receiving, with the computing element, second data associated with a second agricultural land area having a second boundary, determining a second centroid of the second agricultural land area with the computing element, comparing, with the computing element, the first centroid and the second centroid, determining a distance between the first centroid and the second centroid with the computing element, identifying the first agricultural land area and the second agricultural land area as being duplicative if the distance is less than a predetermined quantity, generating third data, with the computing element, if the distance is less than the predetermined quantity, communicating the third data to an output device, and outputting information, with the output device, associated with the third data.

### BRIEF DESCRIPTION OF THE DRAWINGS

The disclosure can be better understood with reference to the following drawings and description. The components in the figures are not necessarily to scale, emphasis instead being placed upon illustrating principles of the disclosure.

FIG. 1 is a block schematic diagram of one example of a system of the present disclosure, the system is configured to perform at least a portion of the functionality and methods of the present disclosure.

FIG. 2 is a block schematic diagram of another example of a system of the present disclosure, the system is configured to perform at least a portion of the functionality and methods of the present disclosure.

FIG. 3 is a front view of examples of devices that may be included in one or more of the systems, in this example the devices are a personal computer and a mobile electronic communication device.

FIG. 4 is one example of a visual format of data communicated by one or more of the systems, in this example the visual format is a map including a plurality of zones color coded based on soil characteristics.

FIG. 5 is one example of a visual format of data communicated by one or more of the systems, in this example the visual format is a map including a plurality of zones color coded based on seed characteristics.

FIG. 6 is one example of a visual format of data communicated by one or more of the systems, in this example the visual format is a chart and graphic illustrating the impact of water uptake, nutrient uptake and seed varieties on projected yields.

FIG. 7 is one example of a visual format of data communicated by one or more of the systems, in this example the visual format is a map including a plurality of zones color coded based on nitrogen characteristics.

FIG. 8 is an exemplary schematic illustration demonstrating that land areas of interest have varying slopes.

FIG. 9 is another exemplary illustration demonstrating that land areas of interest have varying slopes and associated properties in this example, the properties determine whether the land is shedding water or collecting water and rates at which the land is doing so.

FIG. 10 is one example of a visual format of data communicated by one or more of the systems, in this example the visual format is a map including a plurality of zones color coded based on soil characteristics and contour lines for illustrating different slopes.

FIG. 11 is one example of a visual format of data communicated by one or more of the systems, in this example the visual format is a map including a plurality of zones color coded based on soil characteristics and contour lines for illustrating different slopes.

FIG. 12 is one example of a visual format of data communicated by one or more of the systems, in this example the visual format is a bar graph including a plurality of bars of varying heights for illustrating different slopes of a land area of interest.

FIG. 13 is one example of a visual format of data communicated by one or more of the systems, in this example the visual format is a map including contour lines for illustrating different slopes and a plurality of zones color coded based on water flow of the land area of interest.

FIG. 14 is one example of a visual format of data communicated by one or more of the systems, in this example the visual format includes a plurality of maps illustrating weather data.

FIG. 15 is one example of a visual format of data communicated by one or more of the systems, in this example the visual format is an image of at least one exemplary plant in a crop planted on a land area of interest illustrating a growth state of the plant, projected yield of the crop, and a cross-sectional representation of an ear of corn at a particular date.

FIG. 16 is one example of a visual format of data communicated by one or more of the systems, in this example the visual format is an image of at least one exemplary plant in a crop planted on a land area of interest illustrating a growth state of the plants, projected yield of a crop, and a cross-sectional representation of an ear of corn at a particular date.

FIG. 17 is one example of a visual format of data communicated by one or more of the systems, in this example the visual format is a map including contour lines for illustrating different slopes and a plurality of zones color coded based on projected crop yield of the land area of interest.

FIG. 18 is one example of a visual format of data communicated by one or more of the systems, in this example the visual format is a bar graph for illustrating percentage yield losses as they relate to three agronomic factors, in this example the agronomic factors are soil, seed and weather and the agronomic factor that has a highest percentage yield loss (weather in this example) is a limiting factor.

FIG. 19 is one example of a visual format of data communicated by one or more of the systems, in this example the visual format is a bar graph for illustrating percentage yield losses as they relate to three agronomic factors, in this example the agronomic factors are soil, seed and weather and the agronomic factor that has a highest percentage yield loss (seed in this example) is a limiting factor.

FIGS. 20-32 are multiple examples of visual formats of data communicated by one or more of the systems in the present disclosure.

FIGS. 33A-33F are examples of visual formats of data communicate by one or more of the systems of the present disclosure, in this example the usual formats are a chart.

FIG. 34 is one example of a visual format of data communicated by one or more of the systems of the present disclosure, in this example the visual format is a chart illustrating one example of end soil moisture ranges or categories.

FIG. 35 is one example of a visual format of data communicated by one or more of the systems of the present disclosure, in this example the visual format is a map demonstrating various end soil moistures across various zones, this exemplary map includes one example of color coded indicators for demonstrating end soil moistures in various zones.

FIG. 36 is one example of a visual format of data communicated by one or more of the systems of the present disclosure, in this example the visual format is a chart illustrating another example of a manner of determining end soil moisture.

### DETAILED DESCRIPTION

The present disclosure provides systems, methods and apparatuses for improving agronomics in one or more land areas of interest, which may be comprised of one or more fields (or portions of a field) including one or more crops. The systems, methods and apparatuses receive and/or generate large quantities of data associated with agronomic characteristics and/or agronomic factors, analyze the data, characteristics and/or factors, and provide agronomic information to users based on the received and/or generated data, characteristics and/or factors. The agronomic information may be communicated to a device capable of outputting the agronomic information in any format (e.g., visual, audible, etc.) so the users may take appropriate action based on the agronomic information, or the agronomic information may be communicated directly to one or more agricultural device(s) where the agricultural device(s) may take appropriate action.

Many factors may impact and limit a crop's yield. The systems, methods and apparatuses of the present disclosure monitor, receive and/or generate agronomic data associated with the many factors that impact or limit a crop's yield and optimize a crop's yield based on the data. Agronomic data may be collected and/or generated in a variety of manners including, but not limited to, satellite, unmanned aerial vehicles, soil samples from soil sampling devices, cameras or other image capturing devices, ground sensors or sensors located anywhere or on anything relative to a crop or field, public weather data from public databases, seed characteristics, etc., and may be retrieved and/or generated by the systems, methods and apparatuses of the present disclosure. The systems, methods and apparatuses process the agronomic data to identify one or more limiting agronomic factors (i.e., the agronomic factor(s) preventing a crop from reaching a maximum yield). The systems, methods and apparatuses of the present disclosure are capable of receiving, collecting, retrieving, determining, processing, analyzing, etc., a wide variety of agronomic data, characteristics and/or factors. Examples of such data and factors include, but are not limited to: Growth cycle or growing period; sunlight; temperature; rooting; aeration; organic matter present in soil; water quantity; nutrients (NPK); water quality; salinity; sodicity; boron; chloride toxicities; pH; micronutrients; other toxicities; pests; diseases; weeds; flood; storm; wind; frost; seed variety characteristics; soil slope; corn moisture; weather patterns; economic characteristics, data or factors such as, for example, seed costs, cost per seed, input costs (e.g., nitrogen, irrigation, pesticides, etc.), fuel costs, labor costs, etc.; and other factors. Identifying the limiting agronomic factor for a particular field and accommodating or optimizing for the limiting factor may require multiple sets of data including, but not limited to: 1) Pre-planting information; 2) an accurate map of actual plant progress; 3) harvest information; and 4) post-harvest information. At least some of these agronomic factors will be described in more detail below to demonstrate exemplary principles of the present disclosure. Failure to address any particular agronomic factor with further specificity is not intended to be limiting upon the present disclosure in any manner. Rather, the present disclosure is intended to include all possible agronomic factors.

In one example, a growing cycle or growing period of a crop may be considered a period of time required for a crop to complete the states of a growth cycle. A growth cycle may include planting, establishment, growth, production of harvested part, and harvesting. Some crops are annual crops and complete their growth cycle once a year. In some examples, crops may be perennial crops and have growing cycles of more than one year. The growing period for annual crops may be a duration of the year when temperature, soil, water supply and other factors permit crop growth and development. The growing period is a major determinant of land suitability for crops and cultivars on a worldwide and continental scale. Growth cycles and growing periods differ around the World and are dependent upon the climates in those portions of the World.

Sunlight is another factor impacting growth of a crop. Sunlight may have three relevant aspects including, but not limited to: Day length; its influence on photosynthesis and dry matter accumulation in crops; and its effects on evapotranspiration. Sunlight levels may also be important in the drying and ripening of crops. The vegetative growth of most plants increases linearly with sunlight up to a limit beyond which no further increase occurs. As plant populations necessarily increase to keep up with increasing yield expectations, sunlight may become one of the most dominant growth-limiting factors. In one example, the systems, methods and apparatuses of the present disclosure may include one or more sensors for measuring sunlight and generating or creating data associated with the measured sunlight for further consideration by the systems, methods and apparatuses. In another example, the systems, methods and apparatuses may retrieve, collect or receive data associated with sunlight from a data source such as, for example, a database, containing sunlight data.

Temperature is another factor that impacts growth of a crop. Growth of most crops ceases below a critical low temperature and crops experience adverse effects above very high temperatures (usually above 86-95 degrees Fahrenheit). Between a minimum temperature for growth and an optimum temperature for photosynthesis, the rate of growth increases more or less linearly with temperature. The growth rate may then reach a plateau within the optimum temperature range before falling off at higher temperatures. Temperature also interacts with sunlight. Growth potential for crops may be achieved with both sunlight and temperatures in optimal ranges. In one example, the systems, methods and apparatuses of the present disclosure may include one or more thermometers for measuring temperature and generating or creating data associated with the measured sunlight for further consideration by the systems, methods and apparatuses. In another example, the systems, methods and apparatuses may retrieve, collect or receive data associated with temperature from a data source such as, for example, a database, containing temperature data.

Plants require water and nutrients, which are conveyed from the soil to the productive parts of the plants through roots. If root growth, or the development or function of a root system is impaired by adverse land characteristics (e.g., deficiencies or excessive quantities of water, nutrients, inputs, etc.), the growth and yield of the crop may likewise be impaired. Root room is a space for root development and may be limited in a variety of manners including, but not limited to: Effective soil depth; volume percent occupied (or not occupied) by impediments; impenetrable (or penetrable) soil volume; or other manners. Root-occupied soil volume varies with time in the case of annual crops developing root systems from seedling establishment to plant maturity and this process can be slowed by mechanical impedance. Mechanical impedance relates to soil strength and, in some examples, an amount of root penetration force that roots must exert or resistance they must overcome to penetrate the soil. Root room and mechanical impedance produce differences in water, nutrient, and other input uptake by crops that affect final yields, production or quality. In one example, the systems, methods and apparatuses of the present disclosure may include one or more sensors for measuring root growth, root space, root room and/or root penetration, and generating or creating data associated with the measured root characteristics for further consideration by the systems, methods and apparatuses. In another example, the systems, methods and apparatuses may retrieve, collect or receive data associated with root growth, root space, root room and/or root penetration from a data source such as, for example, a database, containing root growth, root space, root room and/or root penetration data. The systems, methods and apparatuses of the present disclosure may also include one or more devices for sampling root growth, root space, root room and/or root penetration, and generating or creating data associated with the measured root characteristics for further consideration by the systems, methods and apparatuses.

Respiring plant roots consume large quantities of oxygen and obtain their oxygen mainly through the soil. Thus, an adequate supply of oxygen through the soil throughout the growing season is a requirement for many crops. Poor aeration may lead to inefficient use of nitrogen applied in manures and fertilizers. Losses of nitrogen may occur from denitrification and leaching. Aeration may be addressed through permanent and/or temporary field drains. In one example, the systems, methods and apparatuses of the present disclosure may include one or more sensors for measuring oxygen content and/or oxygen consumption by roots, and generating or creating data associated with the measured oxygen content and/or oxygen consumption by the roots for further reconsideration by the systems, methods and apparatuses. In another example, the systems, methods and apparatuses may retrieve, collect or receive data associated with oxygen content and/or oxygen consumption by roots from a data source such as, for example, a database, containing oxygen content and/or oxygen consumption by roots data. The systems, methods and apparatuses of the present disclosure may also include one or more devices for sampling oxygen content and/or oxygen consumption by roots, and generating or creating data associated with the measured oxygen content and/or oxygen consumption by the roots for further reconsideration by the systems, methods and apparatuses.

Crop water requirement may be an amount of water necessary to meet maximum evapotranspiration rate of a crop when soil water is not limiting. In one example, evapotranspiration is a rate of water loss through transpiration from vegetation, plus evaporation from the soil surface or from standing water on the soil surface. When irrigation is utilized, crop water requirements are typically calculated by determining a net irrigation water requirement and then gross irrigation water requirements. In one example, net irrigation water requirement may be an amount of water required to meet the crop water requirement, minus contributions in the field by precipitation, run-on, groundwater and stored soil water, plus field losses due to run-off, seepage and percolation. In one example, gross irrigation water requirement may be the net irrigation water requirement, plus conveyance losses between a source of water and a field, plus any additional water for leaching over and above percolation. In one example, the systems, methods and apparatuses of the present disclosure may include one or more sensors for measuring crop water requirements and generating or creating data associated with the measured crop water requirement for further consideration by the systems, methods and apparatuses. In another example, the systems, methods and apparatuses may retrieve, collect or receive data associated with crop water requirements from a data source such as, for example, a database, containing crop water requirement data. The systems, methods and apparatuses of the present disclosure may also include one or more devices for sampling crop water requirements and generating or creating data associated with the sampled crop water requirement for further consideration by the systems, methods and apparatuses.

In some areas, crop water requirements may be partially provided by rain falling directly on land areas of interest (e.g., field(s)). In other areas, where measurable rainfall is less frequent and reliable, the crop water requirements may be provided by a combination of rainfall and/or irrigation through center pivot, drip tape or other irrigation methods. With respect to water requirements, not all the water received in a field is directly effective. Part of the water may be lost to run-off, deep percolation, or by evaporation of rain intercepted by plant foliage. Land characteristics such as slope, relief, infiltration rate, cracking, permeability and soil management may all influence crop water requirements.

Water quality becomes an issue when irrigation is utilized. In one example, water quality criteria may be generally interpreted in the context of, but not limited to, salinity, infiltration and toxicities and their effects on the soil. A salinity problem can occur if a total quantity of soluble salts accumulates in a crop root zone to an extent that affects yields. Excessive soluble salts in the root zone may be caused by irrigation water or indigenous salt, which may inhibit water uptake by plants. In such instances, the plants suffer from salt-induced drought. Infiltration problems occur when a rate of water infiltration into and through the soil is reduced (because of water quality) to such an extent that the crop is not adequately supplied with water, thereby resulting in reduced yield. Poor soil infiltration may also add to cropping difficulties through crusting of seed beds, waterlogging of surface soil and accompanying disease, salinity, weed, oxygen and nutritional problems. Toxicity issues usually relate to higher amounts of specific ions in the water, namely, boron, chloride and sodium. In one example, the systems, methods and apparatuses of the present disclosure may include one or more sensors for measuring water quality and generating or creating data associated with the measured water quality for further consideration by the systems, methods and apparatuses. In another example, the systems, methods and apparatuses may retrieve, collect or receive data associated with water quality from a data source such as, for example, a database, containing water quality data. The systems, methods and apparatuses of the present disclosure may also include one or more devices for sampling water quality and generating or creating data associated with the measured water quality for further consideration by the systems, methods and apparatuses.

Nutrients are another factor that impact crop yield. In one example, three major nutrients are commonly applied as fertilizers to a crop. These nutrients include: Nitrogen (N); Phosphorous (P); and Potassium (K). In other examples, other nutrients may be used as fertilizer. The mineral composition of plant dry matter as a measure of crop nutrient requirements necessitates regular sampling during the life of the crop to ensure accurate results. However, crop nutrient uptake may be taken as the nutrient content of the harvested crops, which may provide a guide as to the nutrients required to maintain soil fertility at about the existing level. Supplies of plant nutrients to replace those removed at harvest may come from, for example: Soil mineralization (i.e. the transformation of soil minerals or organic matter from non-available into available nutrients); manures and fertilizers; or fixation from the air. In one example, the systems, methods and apparatuses of the present disclosure may include one or more sensors for measuring nutrient levels in the soil and generating or creating data associated with the measured nutrient levels for further consideration by the systems, methods and apparatuses. In another example, the systems, methods and apparatuses may retrieve, collect or receive data associated with nutrient levels from a data source such as, for example, a database, containing nutrient level data. The systems, methods and apparatuses of the present disclosure may also include one or more devices for sampling nutrient levels and generating or creating data associated with the measured nutrient levels for further consideration by the systems, methods and apparatuses.

Of these exemplary nutrients, the availability of nitrogen may be a substantial factor affecting yields. Nitrogen fertilizers give fairly predictable yields where lack of nitrogen is a principal limiting factor. Several considerations in determining a quantity of nitrogen that should be applied to obtain a given yield are, for example: Amounts of nitrogen removed by the crop; initial nitrogen content of the soil; contribution from nitrogen fixation; and nitrogen losses due to leaching, denitrification, etc. The cost of applying fertilizer nitrogen may vary from land unit to land unit. Soils requiring high nitrogen inputs may be initially low in nitrogen, or may utilize nitrogen applications inefficiently due to leaching or other losses. In practice, however, farmers often use the same amounts of fertilizer on a given land unit, and yields from field to field may vary on account of different efficiencies of utilization.

Insufficient regard for potential pest, disease and weed problems commonly results in poor crop performance. These problems can come in the form of, for example: Wild animals; arthropods including insects and mites; parasitic nematodes; fungal pathogens; bacterial pathogens; virus diseases; among others. In reconnaissance studies these should be considered in selecting alternative land areas. Climate plays a significant role in the increased incidence of many fungal and bacterial leaf diseases. For example, humid sites may be more disease-prone since the number of hours during which the leaf surface is wet often encourages fungal and bacterial pathogens, and reduces the effectiveness of control measures. The impracticability of weed control during periods of wet weather on heavy soils restricts the range of crops that can be grown and weeds that are not a problem early in the life of a project may become so with time or vice versa. Poorly drained soils predispose certain crops to root and foot rots. Nematode problems may be more severe on sandy soils than on clay soils. In one example, the systems, methods and apparatuses of the present disclosure may include one or more sensors for measuring infestation or other crop problems and generating or creating data associated with the measured infestation or other crop problems for further consideration by the systems, methods and apparatuses. In another example, the systems, methods and apparatuses may retrieve, collect or receive data associated with infestations or other crop problems from a data source such as, for example, a database, containing infestation data or other crop problem data. The systems, methods and apparatuses of the present disclosure may also include one or more devices for sampling infestation or other crop problems and generating or creating data associated with the measured infestation or other crop problems for further consideration by the systems, methods and apparatuses.

As one can see a variety of factors may impact crop yield. It is important for the systems, methods and apparatuses of the present disclosure to consider as much data or as many agronomic characteristics and/or factors as possible in order to provide as accurate an assessment of the scenario in the land area of interest as possible, which may result in optimizing crop yield, reducing the cost associated with growing a crop, and reducing environmental impacts when growing crops. The following examples of systems, methods and apparatuses are provided to demonstrate principles of the present disclosure and are not intended to limit the present disclosure in any manner. Other examples and alternative systems, methods and apparatuses are possible and are intended to be within the spirit and scope of the present disclosure.

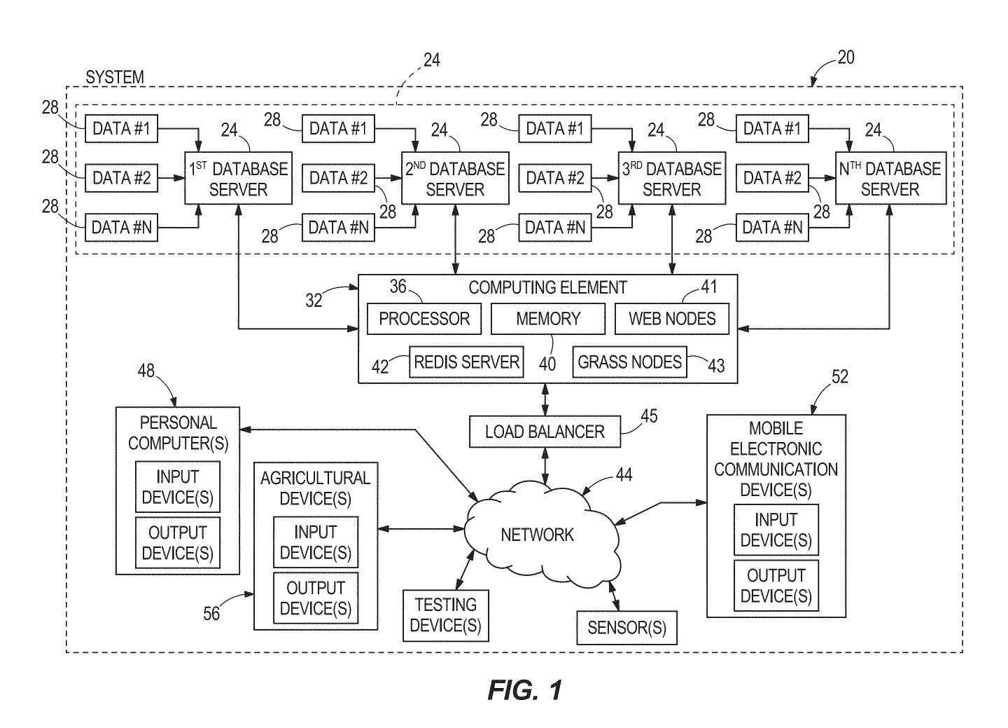

With reference to FIG. 1, one example of a system 20 of the present disclosure is illustrated. The system 20 is one example of many systems of the present disclosure and is not intended to limit the present disclosure in any manner. The exemplary system 20 is provided to demonstrate at least some of the principles of the disclosure. The system 20 is capable of performing all the functionalities, operations and methods of the present disclosure and includes all the necessary hardware and software to achieve the functionalities, operations and methods of the present disclosure. While the present disclosure may describe in detail at least a portion of the hardware and software required to achieve the functionalities, operations and methods of the present disclosure, the present disclosure is not intended to be limited to only the hardware and software described and illustrated, but rather is intended to include any hardware and software required. If any such hardware and software may be omitted from the description and/or drawings, such hardware and/or software may be conventional items known to those skilled in the art and the omission of such items may be a result of their conventionality.

With continued reference to FIG. 1, the exemplary system 20 includes a plurality of databases or database servers 24. In one example, the databases or database servers 24 may be only databases and in other examples the databases or database servers 24 may be database servers. For the sake of simplicity, elements 24 will be referred to hereinafter as databases, however, it should be understood that elements 24 may be either or both databases and database servers. In one example, the databases 24 store a variety of types of data or information. In other examples, the databases 24 store data as suggested above and additionally perform calculations and/or other functionality associated with the system and methods of the present disclosure. The system 20 may include any number of databases 24 as represented by the three databases and an Nth Database. The databases 24 may relate to any aspect of agronomics. Each database 24 may pertain to a different characteristic of agronomics, each database 24 may pertain to multiple characteristics of agronomics, or multiple databases 24 may pertain to similar agronomic characteristics. In the illustrated example, each of the databases 24 is configured to receive and/or store any quantity of data 28 as represented by Data #1, Data #2 and Data Nth. The databases 24 may receive and/or store as few as one data input 28 or may receive and/or store any number of data inputs 28. Moreover, the data 28 received and/or stored by the databases 24 may pertain to any agronomic characteristics, factor or data. In one example, the data 28 received and/or stored by each database 24 will relate to the agronomic characteristic associated with the database 24. For example, if the database 24 is a weather database, the data 28 received and/or stored by the database 24 will pertain to weather. Also, for example, if the database 24 is a soil database, the data 28 received and/or stored by the database 24 will pertain to soil. In one example, the system 20 may include only a single database 24 (see dashed box 24 in FIG. 1), which includes all the features, characteristics and functionality associated with the multiple databases illustrated in FIG. 1.

In one example, the databases 24 are configured to store the received data 28 therein for use by a computing element 32. The computing element 32 communicates with the databases 24 to retrieve and send information or data as necessary. The computing element 32 may include any necessary hardware, software or any combination thereof to achieve the processes, methods, functionalities, operations, etc., of the present disclosure. In one example, the computing element 32 is a web server and includes all the conventional hardware and software associated with a web server.

In one example, the computing element 32 may be comprised of one or more of software and/or hardware in any proportion. In such an example, the computing element 32 may reside on a computer-based platform such as, for example, a server or set of servers. Any such server or servers may be a physical server(s) or a virtual machine(s) executing on another hardware platform or platforms. The nature of the configuration of such server or servers is not critical to the present disclosure. Any server, or for that matter any computer-based system, systems or elements described herein, will be generally characterized by one or more processors and associated processing elements and storage devices communicatively interconnected to one another by one or more busses or other communication mechanism for communicating information or data. In one example, storage within such devices may include a main memory such as, for example, a random access memory (RAM) or other dynamic storage devices, for storing information and instructions to be executed by the processor(s) and for storing temporary variables or other intermediate information during the use of the system and computing element described herein. In one example, the system 20 and/or the computing element 32 may also include a static storage device such as, for example, read only memory (ROM), for storing static information and instructions for the processor(s). In one example, the system 20 and/or the computing element 32 may include a storage device such as, for example, a hard disk or solid state memory, for storing information and instructions. Such storing information and instructions may include, but not be limited to, instructions to compute, which may include, but not be limited to processing and analyzing agronomic data or information of all types. Such agronomic data or information may pertain to, but not be limited to, weather, soil, water, crop growth stage, infestation data, historical data, future forecast data, economic data associated with agronomics or any other type of agronomic data or information. In one example, the system's and/or computing element's processing and analyzing of agronomic data may pertain to processing and analyzing limiting agronomic factors obtained from externally gathered image data, and issue alerts if so required based on pre-defined acceptability parameters. RAMs, ROMs, hard disks, solid state memories, and the like, are all examples of tangible computer readable media, which may be used to store instructions which comprise processes, methods and functionalities of the present disclosure. Exemplary processes, methods and functionalities of the system 20 and/or computing element 32 may include determining a necessity for generating and presenting alerts in accordance with examples of the present disclosure. Execution of such instructions by the system 20 and/or the computing element 32 causes the various computer-based elements of the system 20 and the computing element 32 to perform the processes, methods, functionalities, operations, etc., described herein. In some examples, the systems 20 and the computing elements 32 of the present disclosure may include hard-wired circuitry to be used in place of or in combination with, in any proportion, such computer-readable instructions to implement the disclosure.

In one example, such as the example illustrated in FIG. 1, the computing element 32 may include a processor 36, memory 40, one or more web nodes 41, a REDIS server 42 and one or more GRASS nodes 43. In one example, the web nodes 41 may be servers or other elements comprised of one or both of hardware and/or software to handle requests from a load balancer 45. In one example, the load balancer may be a server or other element comprised of one or both of hardware and/or software that passes off or allocates requests from a network 44 (e.g., from a web browser) to the computing element 32. In one example, the one or more web nodes may be one or more servers that handle requests from the load balancer, retrieve data from database or memory, perform calculations, and send data and user interface(s) back to the network 44 (e.g., back to the web browser). The system 20 and/or the computing element 32 are capable of including any number of web nodes. In one example, the system 20 and/or computing element 32 include six web nodes. In one example, the REDIS server may be a temporary and fast data storage element for behind the scenes capabilities that may control a data cache. In one example, the REDIS server may hold short term data that may not be required for storing long term in another database or may hold data that are frequently accessed to allow quicker performance than if the data was stored in a long term database. In one example, the one or more GRASS nodes may be one or more servers that may run a GIS program. The one or more GRASS nodes may accept shape files from a web node and process the shape files into land areas of interest with slope. The GRASS nodes may return a file or data to a web node where the file or data is stored in one or more databases 24 for use by the system 20. The system 20 and/or computing element 32 may include any number of GRASS nodes. In one example, the system 20 and/or computing element 32 include four GRASS nodes.

In one example, to facilitate user interaction, collection of information, and provision of results, the systems 20 of the present disclosure may include one or more output devices such as, for example, a display device, though such a display may not be included with a server, which may communicate results to a client/manager station (via an associated user/client/manager interface) rather than presenting the same locally. User/client/manager stations may also include one or more input devices such as, for example, keyboards, touch screens, and/or mice (or similar input devices) for communicating information and command selections to the local station(s) and/or server(s). Additionally, the system 20 may output, communicate or transmit data over one or more networks to external or independent devices such as, for example, mobile electronic communication devices, agricultural devices, etc.

In one example, the computing element 32 may include at least one conventional processor 36 and at least one conventional type memory 40. The memory 40 stores necessary data therein that may be retrieved by the processor 36 in order for the computing element 32 to perform the operations, functionalities, methods, etc., of the present disclosure. The processor 36 may also store data as necessary in the memory 40 for later use. Functionalities, operations, methods, etc., of the computing element 32 and the system 20 will be described in greater detail below.

With continued reference to FIG. 1, the computing element 32 is configured to communicate over one or more networks 44. In the illustrated example, only one network 44 is illustrated; however, the computing element 32 is capable of communicating over multiple networks 44. In examples where the computing element 32 may communicate over multiple networks 44, the computing element 32 may communicate over the networks 44 contemporaneously or independently (e.g., one at a time). The computing element 32 selectively communicates over a desired network 44 when communicating independently. The network 44 may be a wide variety of types of networks and the present disclosure contemplates using any type of network. For example, the network 44 may be one of an Internet, an intranet, a cellular network, a local area network (LAN), a wide area network (WAN), a cable network, or any other type of network that is capable of transmitting information, such as digital data, and the like. In examples where the system 20 includes multiple networks 44, the multiple networks 44 may be similar types of networks or the networks 44 may be different types of networks. For example, the system 20 may communicate over a cellular network and over the Internet.

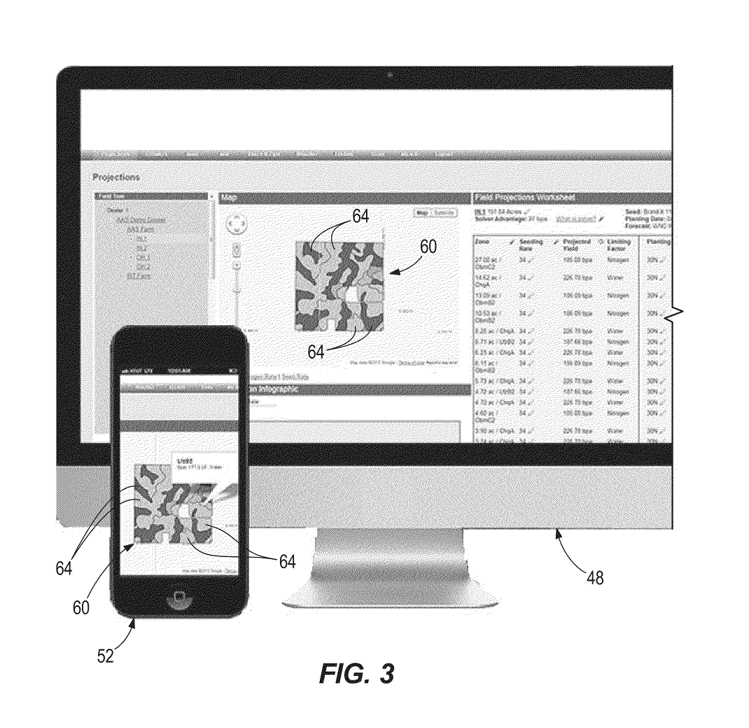

The computing element 32 is configured to communicate data to a wide variety of devices over one or more networks 44 and any such devices are intended to be within the spirit and scope of the present disclosure. In the illustrated example, the computing element 32 is configured to communicate over one or more networks 44 with personal computers 48, mobile electronic communication devices 52, and/or agricultural devices 56. The mobile electronic communication devices 52 may be a wide variety of devices including, but not limited to, a personal desktop assistant (PDA), a portable computer, a mobile telephone, a smartphone, a netbook, a mobile vehicular computer, a tablet computer, or any other type of mobile electronic communication device. Examples of personal computers 48 and mobile electronic communication devices 52 are illustrated in FIG. 3. The agricultural devices 56 may be a wide variety of agricultural devices including, but not limited to, tractors, planters, harvesters, sprayers, any input application device, irrigation devices, soil sampling devices, agronomic sensors, agronomic devices for sampling agronomic characteristics, etc. The computing element 32 is also configured to communicate over one or more networks 44 with a single device at a time or multiple devices contemporaneously or intermittently. For example, the computing element 32 may communicate with a user's smartphone over a cellular network. Also, for example, the computing element 32 may communicate with a tractor over a cellular network. Further, for example, the computing element 32 may communicate with a user's personal computer over the Internet and communicate with the user's smartphone over a cellular network.

The system 20 and computing element 32 are capable of performing a wide variety of functionalities or operations that improve agronomic conditions. For example, the computing element 32 receives one or more types of data from one or more databases 24, analyzes the one or more types of data and communicates data to one or more devices 48, 52, 56 over one or more networks 44 pertaining to the analyzed agronomic data. The data communicated to the one or more devices will assist with improving the agronomic conditions of a particular land area of interest that includes one or more fields (or portion of a field) and one or more crops. In one example, the communicated data may be viewed by a user, farmer, crop consultant, agronomist, etc. (collectively referred to hereafter as “user”) or a device such as a mobile electronic communication device, personal computer, or display on an agricultural device, and the user may take action in accordance with the communicated data. In one example, the communicated data is communicated to one or more agricultural devices 56 and the one or more agricultural devices 56 may operate or be operated by a user in accordance with the communicated data. In one example, communicated data may be communicated to a device 48, 52 where a user may view the data in a visual format (see FIG. 3) and also be communicated to one or more agricultural devices 56. In this example, the user may take action based on the communicated data and the one or more agricultural devices 56 may operate in accordance with the communicated data.

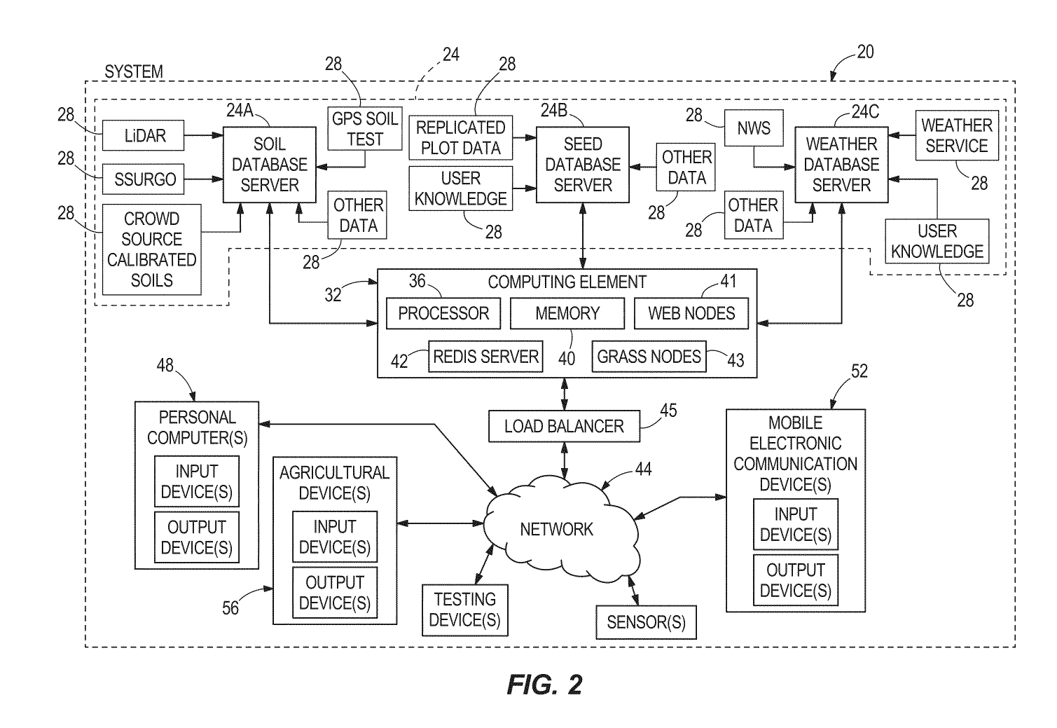

Referring now to FIG. 2, another example of a system 20 of the present disclosure is illustrated. The system 20 illustrated in FIG. 2 is one example of many possible systems of the present disclosure and is not intended to limit the present disclosure in any manner. Rather, the exemplary system 20 is provided to demonstrate principles of the disclosure. The system 20 is capable of performing all the functionalities, operations, methods, etc., of the present disclosure and includes all the necessary hardware and software to achieve the functionalities, operations, methods, etc., of the present disclosure. While the present disclosure may describe in detail at least a portion of the hardware and software required to achieve the functionalities, operations, methods, etc., of the present disclosure, the present disclosure is not intended to be limited to only the hardware and software described and illustrated, but rather is intended to include any hardware and software required. If any such hardware and software may be omitted from the description and/or drawings, such hardware and/or software may be conventional items known to those skilled in the art and the omission of such items may be a result of their conventionality.

With continued reference to FIG. 2, the exemplary system 20 includes three databases or database servers 24A, 24B, 24C for storing a variety of types of data or information. Reference is made to the description above pertaining to FIG. 1 with respect to databases and database servers and all of such description above applies to the system 20 illustrated in FIG. 2 and described herein. The three databases include a soil database 24A, a seed database 24B and a weather database 24C. Each database 24A, 24B, 24C is configured to receive and store data 28 associated with the agronomic characteristic of the database 24A, 24B, 24C (e.g., soil, seed and weather, respectively). In this example, the soil database 24A may collect or receive GPS soil test data, LiDar data, SSURGO data, crowd source calibrated soils data, and data from social media (e.g., FACEBOOK, TWITTER, INSTAGRAM, etc.). In one example, through the use of social media, peer users may compare soil, seed and weather information with others, including those other users who have land areas in relative proximity and therefore may be subject to similar soil, seed and weather conditions. In some examples, databases 24A, 24B, 24C may be supplemented with information provided by a social media. In this example, the system 20 is configured to allow one or more users to communicate information between one another that may be relevant to soil, seed and weather status, status updates of current crops for peer farmers, or prescriptions and strategies of peer farmers. On some occasions, the system 20 may receive data via a social network from other users and store said data in an appropriate database(s). In one example, pest problems on a nearby field operated by another farmer may be relevant to the user's fields; e.g., rootworm or aphids on a nearby field with a crop similar to a user's fields.

The seed database 24B may collect or receive and store replicated plot data and user knowledge data. The weather database 24C may collect or receive and store national weather service data, other weather service data (e.g., The Weather Channel data, Weather Underground data, etc.), and user knowledge data. The soil database 24A, seed database 24B and weather database 24C store this data 28 for retrieval by the computing element 32.

In one example, the system 20 illustrated in FIG. 2 may include only a single database 24 (see dashed box 24 in FIG. 2), which includes all the features, characteristics and functionality associated with the multiple databases illustrated in FIG. 2.

It should be understood that the data 28 described and illustrated in the context of this example are presented for exemplary purposes to demonstrate at least some of the principles of the present disclosure and are not intended to limit the present disclosure in any manner. Rather, any type of data associated with soil, seed and weather may be received and stored in the respective databases and all of such possibilities are intended to be within the spirit and scope of the present disclosure.

The databases 24A, 24B, 24C are configured to store the received data 28 therein for use by the computing element 32. The computing element 32 communicates with the databases 24A, 24B, 24C to retrieve and send data as necessary. The computing element 32 may include any necessary hardware, software and any combination thereof to achieve the functionalities, operations, methods, etc., of the present disclosure. In one example, the computing element 32 is a web server and may include all the conventional hardware and software associated with a web server. In one example, the computing element 32 may include at least one conventional processor 36 and at least one conventional type of memory 40. The memory 40 stores necessary data therein that may be retrieved by the processor 36 in order for the computing element 32 to achieve the functionalities, operations, methods, etc., of the present disclosure. The processor 36 may also store data as necessary in the memory 40 for later use. The computing element associated with FIG. 2 is capable of being similar to the computing element associated with FIG. 1. Thus, the description above associated with the computing element of FIG. 1 may apply to the computing element associated with FIG. 2.

In one example, the system 20 illustrated in FIG. 2 is capable of including a load balancer 45 similar to the load balancer illustrated in FIG. 1 and described above. Thus, the description above associated with the load balancer of FIG. 1 may apply to the load balancer associated with FIG. 2.

With continued reference to FIG. 2, the computing element 32 is configured to communicate over one or more networks 44. In the illustrated example, only one network 44 is illustrated; however, the computing element 32 is capable of communicating over multiple networks 44. In examples where the computing element 32 may communicate over multiple networks 44, the computing element 32 may communicate over the networks 44 contemporaneously or independently (e.g., one at a time). The computing element 32 selectively communicates over a desired network 44 when communicating independently. The network 44 may be a wide variety of types of networks and the present disclosure contemplates using any type of network. For example, the network 44 may be one of an Internet, an intranet, a cellular network, a local area network (LAN), a wide area network (WAN), a cable network, or any other type of network that is capable of transmitting information, such as digital data, and the like. In examples where the system 20 includes multiple networks 44, the multiple networks 44 may be similar types of networks or the networks 44 may be different types of networks. For example, the system 20 may communicate over a cellular network and over the Internet.

The computing element 32 is configured to communicate data to a wide variety of devices over one or more networks 44 and any such devices are intended to be within the spirit and scope of the present disclosure. In the illustrated example, the computing element 32 is configured to communicate over one or more networks 44 with personal computers 48, mobile electronic communication devices 52, and agricultural devices 56. Examples of personal computers 48 and mobile electronic devices 52 are illustrated in FIG. 3. Reference is made to the description presented above in connection with FIG. 1 pertaining to the devices with which the computing element 32 is configured to communicate, and all of such possibilities also apply to the devices associated with the system 20 illustrated and described in connection with FIG. 2.

The system 20 and computing element 32 are capable of performing a wide variety of functionalities, operations, methods, etc., that improve agronomic conditions. For example, the computing element 32 receives, retrieves or collects one or more types of data from one or more databases 24A, 24B, 24C, analyzes the one or more types of data and communicates data to one or more devices 48, 52, 56 over one or more networks 44 pertaining to the analyzed agronomic data. The data communicated to the one or more devices 48, 52, 56 will assist with improving the agronomic conditions of a particular land area of interest that includes one or more fields (or a portion of a field) and one or more crops. In one example, the communicated data may be viewed by a user on one or more devices 48, 52, 56 and the user may take action in accordance with the communicated data or a user may operate one or more agricultural devices in accordance with the communicated data. In one example, the communicated data is communicated to one or more agricultural devices 56 and the one or more agricultural devices 56 may operate in accordance with the communicated data. In one example, communicated data may be communicated to a device 48, 52 where a user may view the data in a visual format (see, e.g., FIG. 3) and also be communicated to one or more agricultural devices 56. In this example, the user may take action based on the communicated data and the one or more agricultural devices 56 may operate in accordance with the communicated data.

More specifically, for example, the computing element 32 may receive, retrieve or collect data from the soil database 24A, analyze the data 28 relating to soil and communicate data to one or more devices 48, 52, 56 over one or more networks 44 pertaining to the analyzed soil data 28. The soil data communicated to the one or more devices 48, 52, 56 may assist with improving agronomic conditions of a land area of interest, field or crop as they relate to soil. Also, for example, the computing element 32 may receive data from the seed database 24B, analyze the data 28 relating to seed and communicate data to one or more devices 48, 52, 56 over one or more networks 44 pertaining to the analyzed seed data 28. The seed data communicated to the one or more devices 48, 52, 56 may assist with improving agronomic conditions of a particular land area of interest, field or crop as they relate to seed. Further, for example, the computing element 32 may receive, retrieve or collect data from the weather database 24C, analyze the data 28 relating to weather and communicate data to one or more devices 48, 52, 56 over one or more networks 44 pertaining to the analyzed weather data 28. The weather data communicated to the one or more devices 48, 52, 56 may assist with improving agronomic conditions of a particular land area of interest, field or crop as they relate to weather. The computing element 32 may retrieve, receive or collect only one of soil, seed or weather data 28 at a time and analyze only the one retrieved data 28, or the computing element 32 may retrieve, receive or collect any number and combination of soil, seed and weather data 28. In examples where only one type of data is retrieved and analyzed, only that single criteria is contemplated to improve the agronomic conditions of a particular land area of interest, field and/or crop. In examples where more than one type of data is retrieved and analyzed, the multiple data may be contemplated in unison and their combined effect on agronomic conditions of a particular land area of interest, field and/or crop may be considered to improve the agronomic conditions.

In one example, the communicated soil, seed and/or weather data 28 may be viewed by a user on one or more devices 48, 52, 56 and the user may take action in accordance with the communicated soil, seed and/or weather data 28. In one example, the communicated soil, seed and/or weather data 28 is communicated to one or more agricultural devices 56 and the one or more agricultural devices 56 may operate in accordance with the communicated soil, seed and/or weather data 28 or the user may operate the agricultural device 56 in accordance with the communicated soil, seed and/or weather data 28. In one example, communicated soil, seed and/or weather data 28 may be communicated to a device 48, 52 where a user may view the soil, seed and/or weather data 28 and also be communicated to one or more agricultural devices 56. In this example, both the user may take action based on the communicated soil, seed and/or weather data 28 and the one or more agricultural devices 56 may operate in accordance with the communicated soil, seed and/or weather data 28.

The system 20 and computing element 32 may be utilized in a variety of manners. In one example, the system 20 and computing element 32 may be used to perform pre-season crop planning. In another example, the system 20 and computing element 32 may be used to perform in-season monitoring and adjustment. The system 20 and computing element 32 may analyze and output or communicate data in a similar manner in both pre-season and in-season examples, but a difference between pre-season and in-season examples may occur depending on how the communicated data is utilized. For example, in pre-season crop planning, a user may input or retrieve various combinations of data for the computing element 32 to analyze and the outputted or communicated data may simply be viewed by the user and/or stored for later viewing or use, without actually taking action on a crop or with an agricultural device. For in-season scenarios, for example, actual data occurring in real-time may be input into or retrieved by the computing element 32, the computing element 32 analyzes the data, outputs data to be viewed by a user, and the user may take action based on the outputted data or the outputted data may be communicated to an agricultural device to control operation of the agricultural device.

The data communicated to the user by the computing element 32 may have several benefits and assist the user in many ways whether the computing element 32 is used for pre-season crop planning or in-season adjustment. For example, the computing element 32 may analyze seed types or varieties to determine appropriateness of the user specified/selected seed type or variety, determine the most appropriate planting date, determine the most appropriate seed rate (e.g., how many seeds to plant per acre), determine the most appropriate amounts of inputs to apply to a crop, determine which inputs to apply to a crop, determine most appropriate time to harvest the crop, improve crop yields by performing the preceding aspects, improve the efficiency of the planting process and reduce a user's cost by performing the preceding aspects, decreasing the impact on the environment from the planting process by performing the preceding aspects, among others.

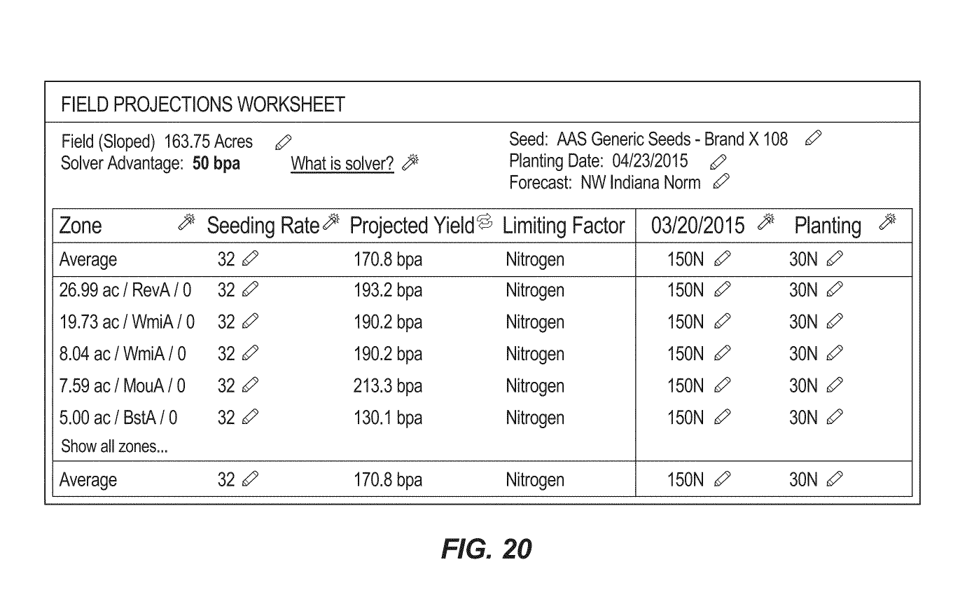

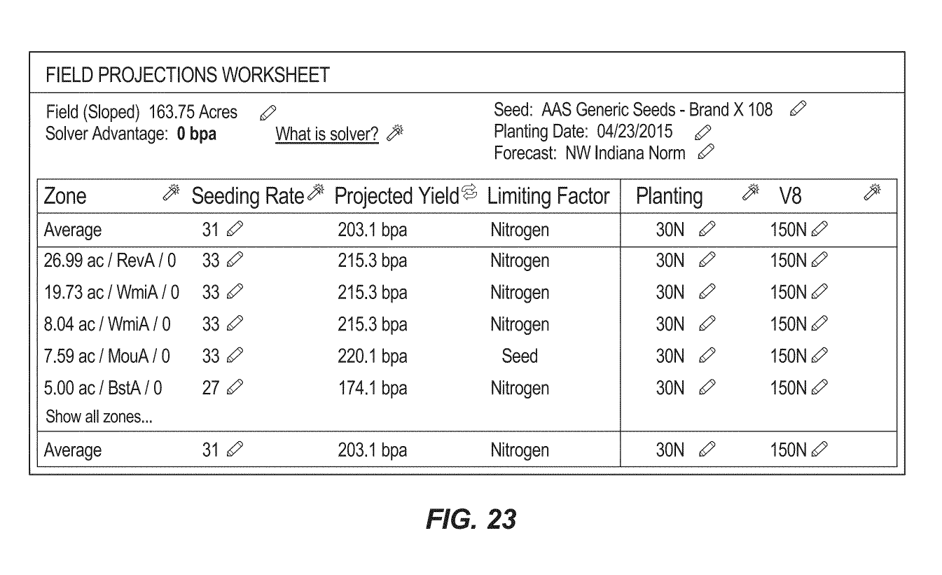

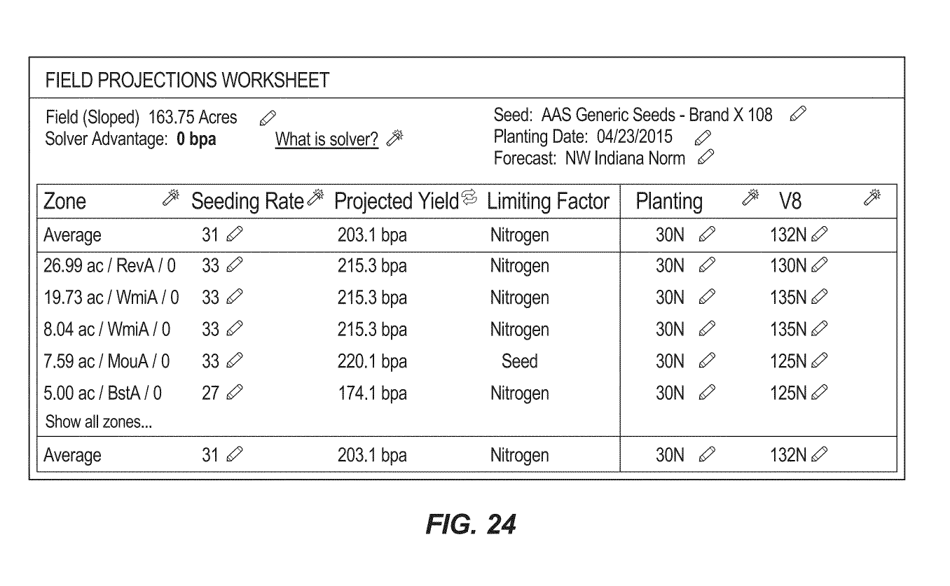

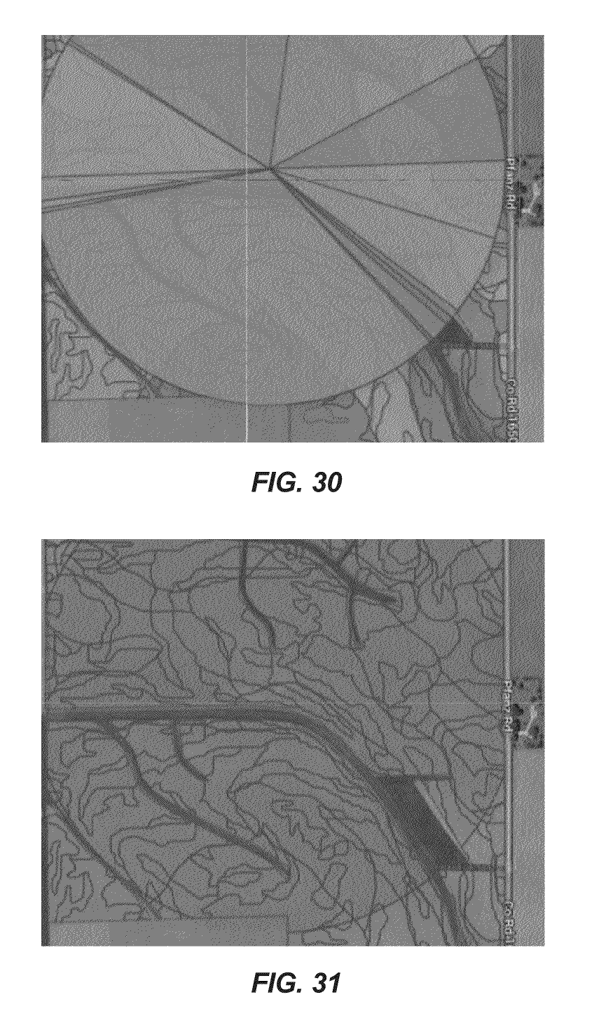

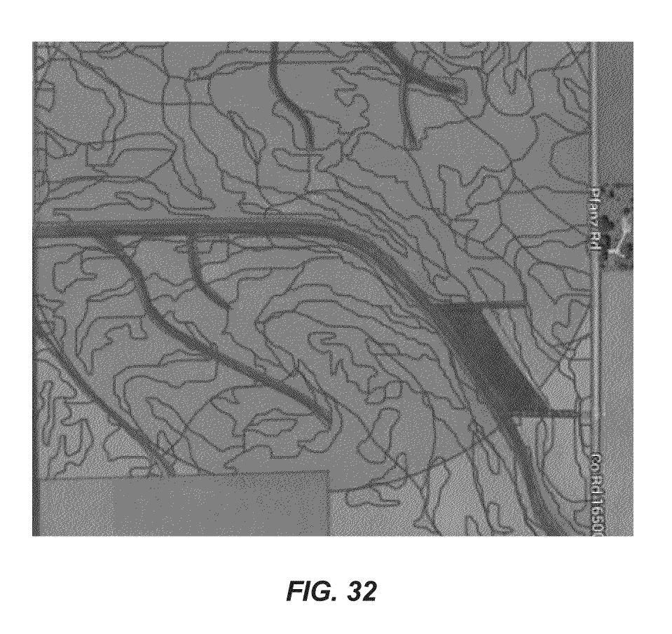

In one example of pre-season and/or in-season crop planning, with reference to FIGS. 20-32, the system 20 and the computing element 32 may analyze a large quantity or all possible iterations of pre-season crop planning data to solve for ideal pre-season crop planning data, e.g., the highest possible crop yield, highest possible crop yield with lowest plant population, or many others. In another example, the system 20 and computing element 32 do not analyze all of the possible iterations but select random combinations of pre-season crop planning data, establish upper and lower limits for yield loss, and continue iterating until the dataset has been narrowed down to only a handful of combinations showing the highest possible crop yield at the lowest possible plant population.

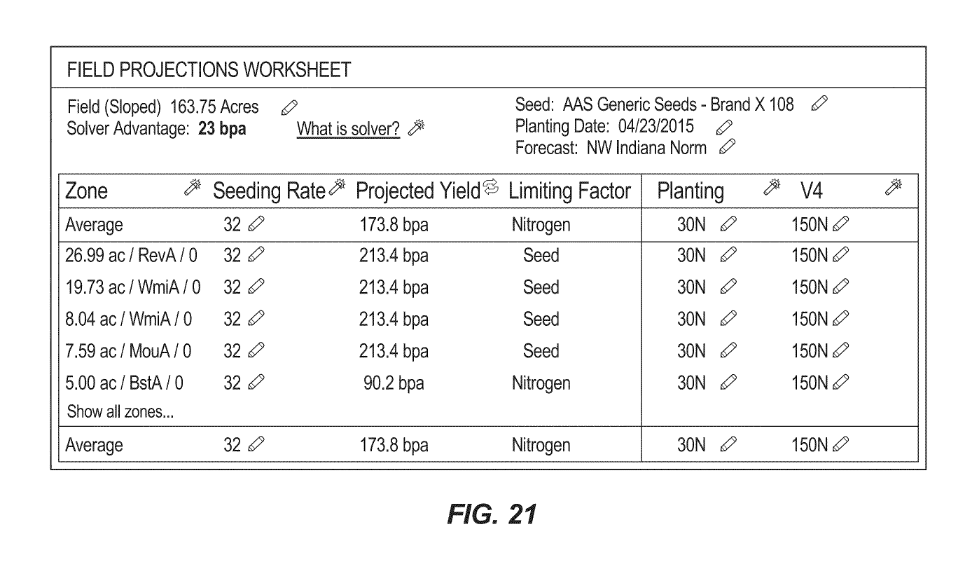

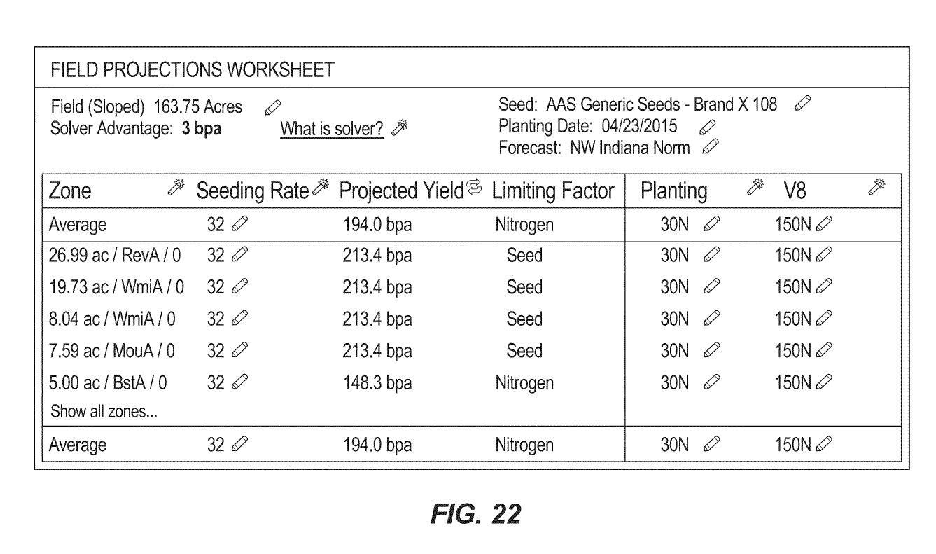

With particular reference to FIGS. 20-24, one example of a visual format provided by the system 20 is provided as it relates to a limiting factor. This visual format may be displayed on a display of any electronic device of the system 20 and capable of being viewed by a user. This example is not intended to be limiting. Rather, this example is provided to demonstrate some of the principles of the present disclosure. With reference to FIG. 20, a plurality of land areas of interest, zones or fields are represented in the various rows. For all of these land areas of interest, nitrogen is identified by the computing element 32 as the limiting factor (see fourth column with the header “Limiting Factor”). This represents to a user that the land areas of interest illustrated in FIG. 20 have a shortage of nitrogen. Depending on whether the user is using the system for pre-season planning analysis or in season analysis, a user may either actually go to the land area of interest and apply more nitrogen to the land area of interest (for in season scenarios) and input the amount of nitrogen added into the system 20 or the user may merely adjust the amount of nitrogen using an input device on the electronic device (for pre-season planning analysis). Either way, FIG. 21 accounts for the increase in nitrogen to the land areas of interest, thereby resulting in a larger crop yield for most of the land areas of interest (see third column from left). Since nitrogen has been added, nitrogen is no longer the limiting factor. Instead, FIG. 21 now shows seed as the limiting factor for some of the land areas of interest (see fourth column). FIGS. 22-24 show additional visual formats of this example when considering different values of agricultural characteristics and/or performing different activities.

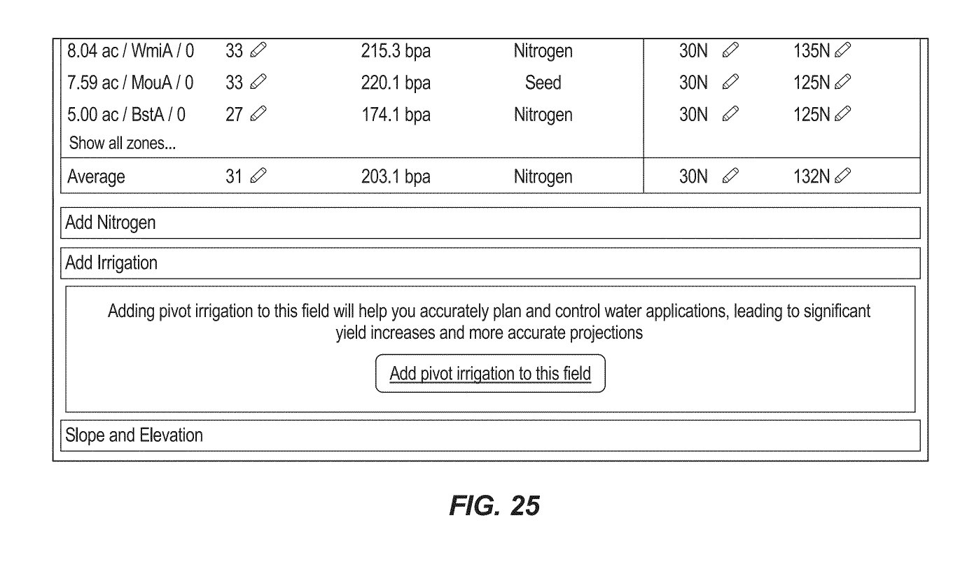

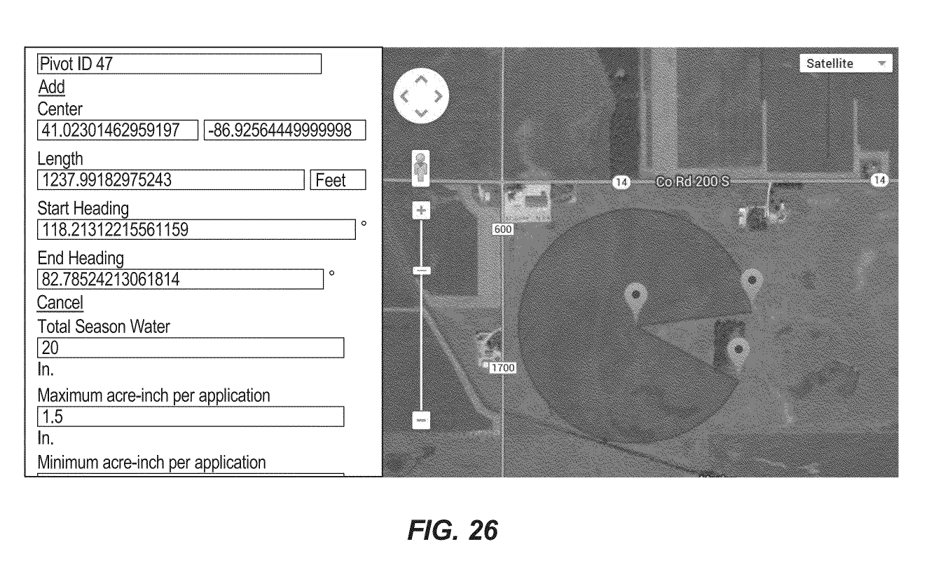

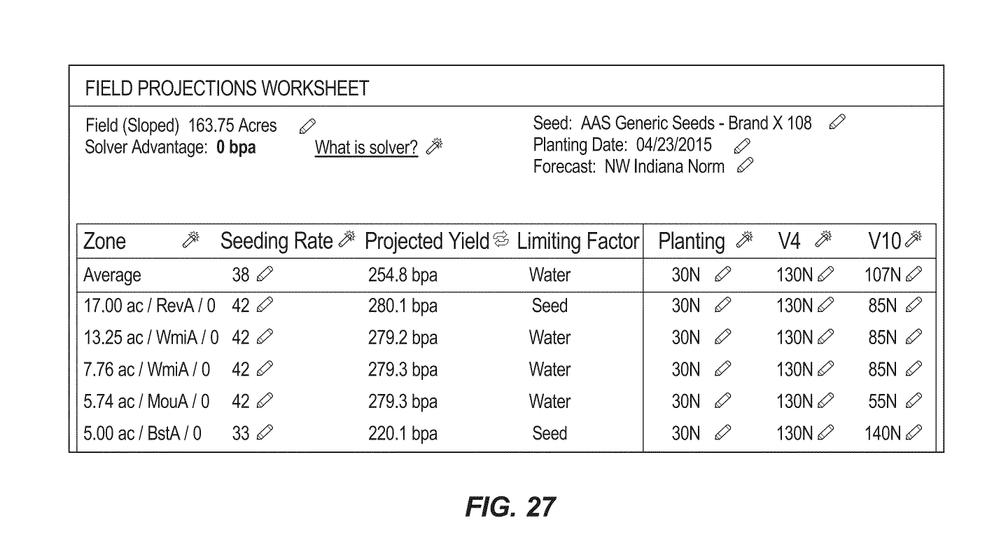

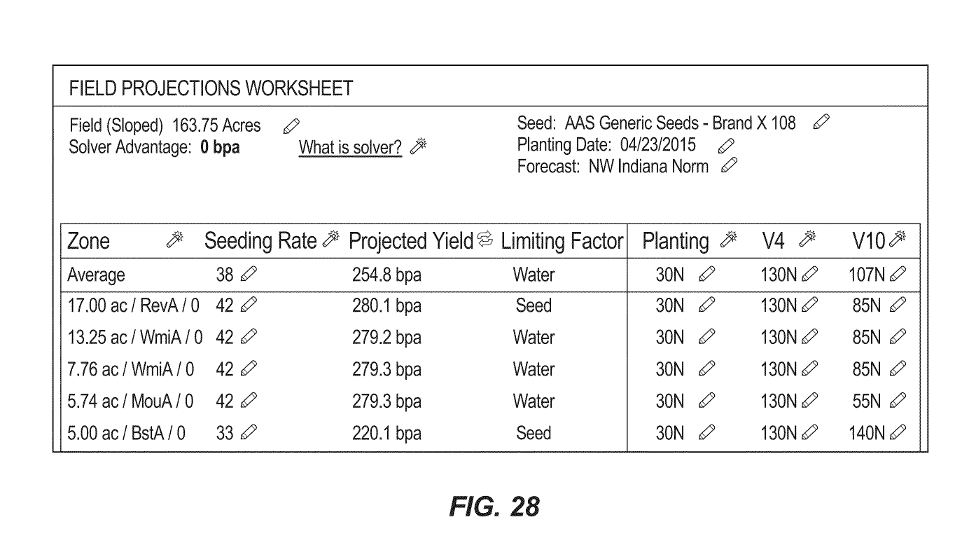

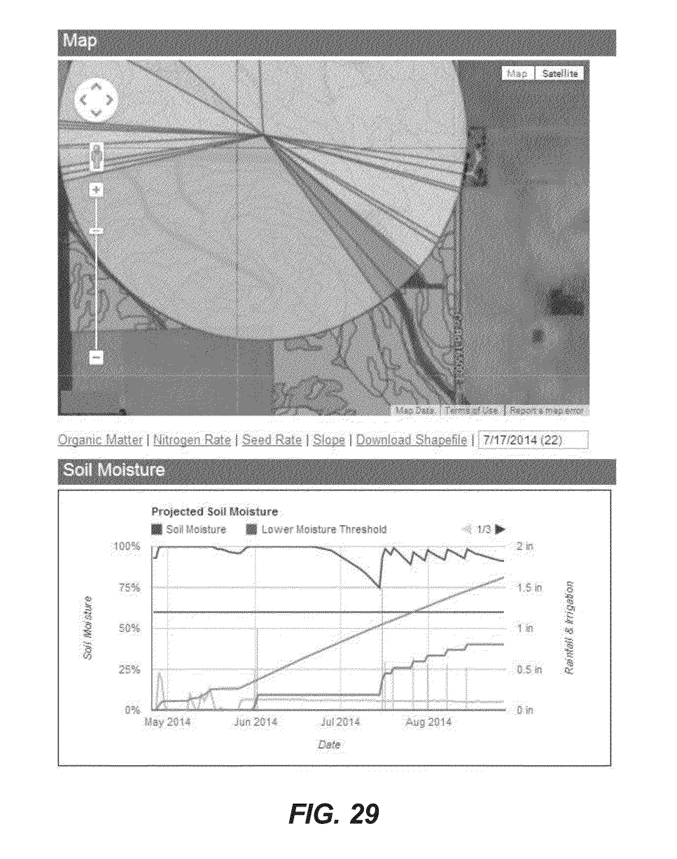

With reference to FIGS. 25 and 26, the system 20 is configured to allow introduction of an irrigation system into the system associated with a land area of interest. A land area of interest may not initially have an irrigation system when considered by the system 20. Subsequently an irrigation system may be added and it is important for the impact of irrigating on the land area of interest to be considered. With reference to FIG. 25, the system 20 displays one example of a visual format on a display of an electronic device for viewing by the user. The visual format includes an icon selectable by a user to add an irrigation system to the land area of interest. A user selects the icon and the visual format illustrated in FIG. 26 is displayed on a display of an electronic device for viewing by a user. The visual format illustrated in FIG. 26 includes several sections where information pertaining to the irrigation system may be inputted. The user may input the appropriate information with an input device associated with the electronic device. With reference to FIGS. 27 and 28, various visual formats displayable by the system 20 are illustrated and account for water now that irrigation was added in connection with FIGS. 25 and 26. FIGS. 29-32 illustrate various visual formats displayed by the system 20 on displays of an electronic device. The visual formats illustrate an irrigation system overlaid on land areas of interest.

In one example of in-season adjustments, the system 20 and the computing element 32 may analyze a large quantity of or all possible iterations of agronomic factors to solve for the limiting agronomic factor. In another example, the system 20 and computing element 32 do not analyze all of the possible iterations but select random combinations of agronomic factors, establish upper and lower limits for yield loss, and continue iterating until the dataset has been narrowed down to only a handful of combinations from which the user can identify the limiting agronomic factor.

As indicated above, the system 20 and computing element 32 of the present disclosure have a variety of features, functionalities, operations, methods, etc. The following features, functionalities operations, methods, etc., are not intended to be limiting upon the present disclosure, but rather are provided as examples to demonstrate principles of the present disclosure. Other features, functionalities, operations, methods, etc., may be possible and are intended to be within the spirit and scope of the present disclosure.

In one example, a system 20 provides the ability for a user to upload data or information pertaining to a land area of interest. This land area of interest may be a single field, a portion of a field, a plurality of fields, or other land area of interest. For purposes of this description and for simplifying the description, the word land or phrase land area of interest will be referred to herein and can account for any size of land and any number of fields, including one field or a portion of a field.

In one example, to begin use of the system 20, data associated with the land area of interest must be introduced, uploaded or communicated into the system 20. The land data may be uploaded into the system 20 in a variety of manners. In one example, the user may input (via, e.g., a keyboard, mouse, touch screen, storage medium such as, for example, memory stick, or any other type of input device) data associated with the land such as, for example, a name of the farmer/grower, name of the farm, name of the land or field, etc. Then the user may select a land area of interest (e.g., a common land unit) from a farm service agency (FSA) including field maps with the system 20. If the land area of interest includes more than one field, the user may select multiple land areas of interest from the FSA and such land areas of interest may be grouped together and associated with the data input by the user.

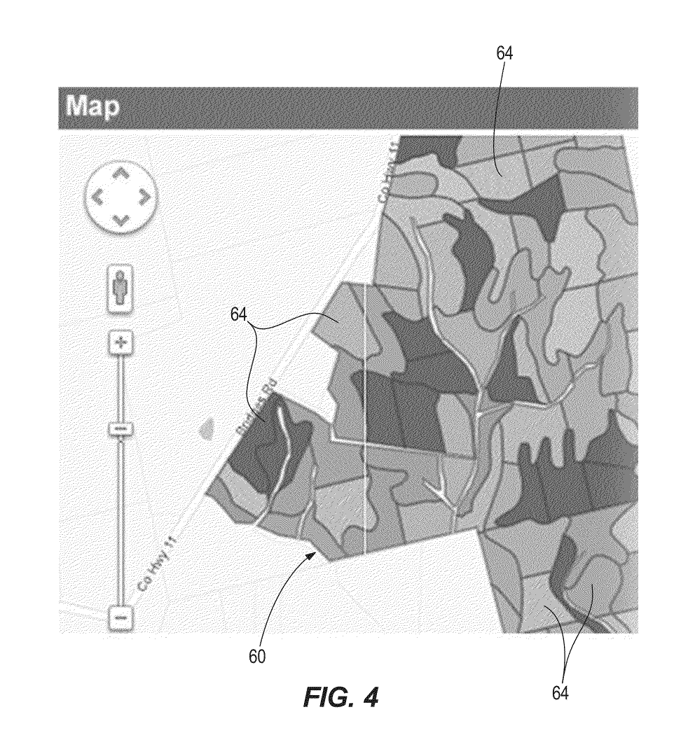

With reference to FIG. 4, one example of a land area of interest 60 is illustrated. In this example, the land area of interest 60 includes a plurality of zones 64. The different shading in the zones 64 may represent different characteristics between zones 64. The different characteristics may be a wide variety of characteristics and all of such possibilities are intended to be within the spirit and scope of the present disclosure. For example, the different characteristics may relate to, but are not limited to, differences in soil characteristics, plant population, etc. Such soil differences may pertain to, but are not limited to, quantity of organic matter present in soil, pH, phosphorous content, nitrogen content, potassium content, cation exchange capacity, slope, etc.

In another example, the land data may be uploaded into the system 20 in one or more bulk files such as, for example, one or more binary spatial coverage files. Such a bulk file includes all the necessary information associated with the land area of interest 60. In this example, the land data is exported to a binary spatial coverage file. Such exported information may include, but is not limited to, soil type layer or customized management zone with MUSYM (map unit symbol) attribute. Once such data is uploaded to the system 20, Geographic Information Systems (GIS) software may name each file within the bulk file by field name. GIS software may obtain desired land data and may include all the necessary land data for the land area of interest. When the land data is uploaded in bulk, the system 20 uses the file name to assign the field name by default. Names may be subsequently edited. If too many files are uploaded, the unwanted files may be subsequently deleted. The system 20 provides the ability to export all files, upload all files, then provides a preview where a user may select and delete unwanted files. Once the land files are uploaded, the system 20 links standard practices and weather forecasts, and determines land, field and/or zone centroids for establishing virtual rain gauges with the uploaded land files.

Field centroids are determined, in one example, by geographic midpoint. In one example, the system 20 may calculate the geographic midpoint by finding a center of gravity for the land area of interest. The system 20 may convert the latitude and longitude for each land area of interest into Cartesian (x,y,z) coordinates. The system 20 may multiply the x, y, and z coordinates by a weighting factor and add them together. A line can be drawn from a center of the earth out to this new x, y, z coordinate, and the point where the line intersects the surface of the earth is the geographic midpoint. The system 20 converts this surface point into latitude and longitude for the midpoint. This is one example of the system 20 determining the centroid of a land area of interest. The system 20 may determine the field centroid in a variety of other manners including, but not limited to, triangle centroids, plumb line method, integral formula, balancing method, finite set of points, geometric decomposition, bounded regions, L-shaped, polygon, cone, pyramid, or other manners. The system 20 determining the field centroid allows a user to upload large quantities of files associated with a large number of fields or land area(s) of interest and identifying each of the fields or land area(s) of interest using the associated centroid(s) without the use of a land/field identifier (typically a 12 digit field code).

In one example, the system 20 is configured to determine if duplicate files having the same, substantially the same or overlapping zone or land area boundaries. In such an example, files may be associated with one another based on their boundary and duplicates may be determined based on the boundaries. In this example, the system 20 may display, output or otherwise prompt a user with information identifying the potentially duplicative files. The user may then make a selection via an input device whether the files are duplicative. If the user indicates that the files are duplicative, the system 20 may delete one of the duplicative files. In one example, each land area or zone file and its associated boundary may be associated with a centroid. Then, the system 20 may measure or determine distances between the centroids of the land area or zone files. In some examples, distances between the centroids may be used to identify or determine duplicative files. In some examples, if centroids of land areas or zones are close together, this may be an indicator that the land areas or zones are duplicative.

Standard practices may be farming practices compiled over a period of time for a given area. Such practices may include row width, planting dates, planting rates (e.g., seed rates), input applications such as, for example, nitrogen, average bushels per acre (e.g., 5 year average) or any other practices. The system 20 may generate the map illustrated in FIG. 4 by uploading data associated with such compiled farming practices.

In a further example, the system 20 may communicate with a Geographic Information Systems (GIS) software to obtain desired land data. GIS software may include all the necessary land data for the land area of interest. The system 20 may generate the map illustrated in FIG. 4 by communication with and data received by GIS software.

In still another example, the system 20 may obtain land data from SSURGO, which includes digital soils data produced and distributed by the Natural Resources Conservation Service-National Cartography and Geospatial Center, and the user may customize the information with their own data. For example, customized data may include soil test data. In one example, the system 20 may include a soil testing device that can be used by a user to test the soil in order to determine soil characteristics. Soil test data may be uploaded to the system 20 in a binary spatial coverage file polygon format with an appropriate MUSYM for the land area of interest. The soil layer(s) associated with SSURGO may be swapped out with the customized uploaded soil test data. The system 20 may also generate the map illustrated in FIG. 4 by communication with and data received by a combination of SSURGO and customized data.

It should be understood that these examples of introducing land data into the system 20 are not intended to be limiting upon the present disclosure and, instead, the present disclosure is intended to include other manners of introducing land data into the system 20. It should also be understood that the system 20 may receive land data from a combination of these land data sources, in any combination, and all of such possibilities are intended to be within the spirit and scope of the present disclosure. It should further be understood that the system 20 may include one or more devices configured to generate or obtain data itself as described herein.

In some examples, the system 20 and computing element 32 are configured to facilitate customization of a variety of features. The following examples of customizable features are provided to demonstrate principles of the present disclosure and are not intended to be limiting upon the present disclosure. More, less or other features may be customizable and all of such possibilities are intended to be within the spirit and scope of the present disclosure. A user may customize various features, factors, and/or characteristics in a variety of manners. All manners of customization are intended to be within the spirit and scope of the present disclosure. In one example, a user may customize one or more features, factors and/or characteristics by inputting information and/or data via one or more input devices on one or more of the devices 48, 52, 56. This inputted data is communicated to the computing element 32 where the computing element 32 analyzes the inputted data and/or stores the inputted data in memory 40 for later consideration. The inputted data may replace or overwrite corresponding data or the inputted data may be stored along with the corresponding data.

Customization of attributes or characteristics associated with the land area of interest may provide more accuracy to the system 20. In some cases, land data obtained from one or more sources (e.g., GIS, SSURGO, etc.) may not be as accurate or up to date as possible for the land area of interest. The land area of interest may have different land characteristics from year to year or may have different characteristics compared to the neighboring land or other land grouped together in the one or more sources. Thus, it is desirable for the system 20 to provide as much customization as possible to reflect, as close as possible, the reality of the land area of interest.

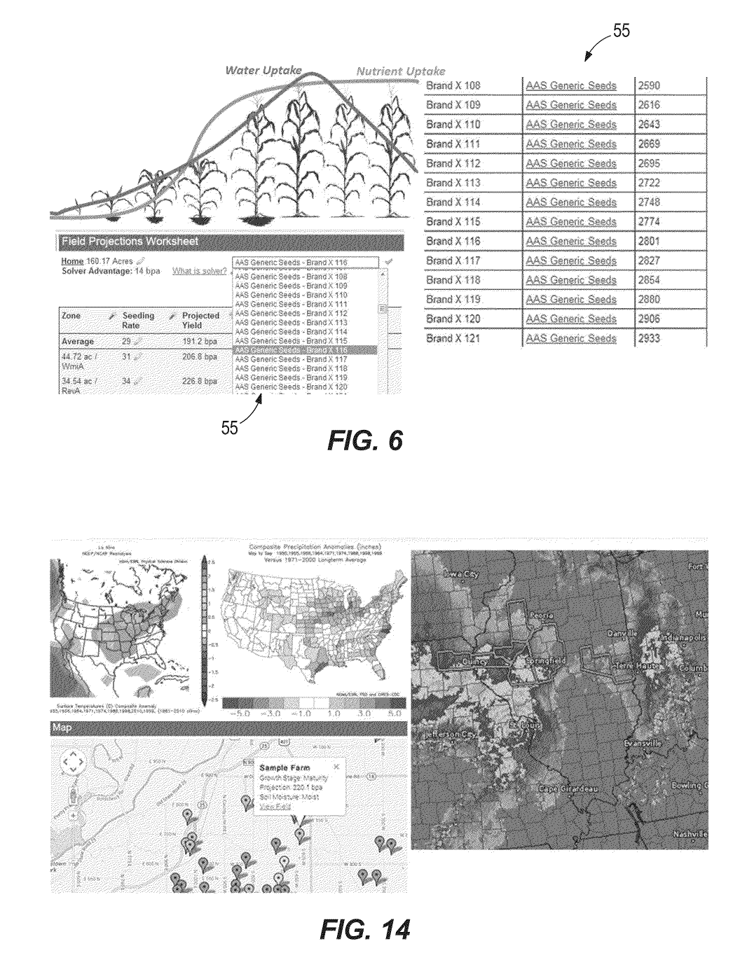

In one example, the system 20 allows customization of a seed variety or seed type. With reference to FIG. 6, the system 20 displays a large quantity of seed varieties 55 for a user to select from. The illustrated examples are only some of the many types of seed varieties and are not intended to be limiting upon the present disclosure. Rather, these examples of seed varieties are shown to demonstrate principles of the present disclosure. Each seed variety may include a seed profile, which may be comprised of a vast quantity of characteristics associated with that particular seed type. Examples of seed profile characteristics include, but are not limited to, growing degree days, water demands, nutrient demands, relative maturity, days to maturity, projected yield, genetic information (e.g., resistance to Roundup—glyphosate, etc.), among others. When a user selects a desired seed variety, the seed profile characteristics associated with the selected seed variety are considered by the system 20. In one example, the system 20 retrieves, collects, or receives the seed profile characteristics from an external database when a user selects a desired seed variety. Alternatively, the system 20 may retrieve, collect or receive the seed profile characteristics from another source or the system 20 may have the seed profile characteristics stored in memory or an internal database of the system. Once the system 20 has the seed profile characteristics based on a user's selection of a desired seed variety, the system may consider the seed profile characteristics to perform further analysis and make determinations as described elsewhere in the present disclosure.

In one example, the system 20 allows customization of the seed profile characteristics themselves. In some instances, customization of the seed profile characteristics may be based on the knowledge of the user or where a user knows seed profile characteristics originating from external databases or other sources are outdated or otherwise inaccurate. The user may alter any of the seed profile characteristics associated with a seed variety via the system 20 and altering of any such characteristic is intended to be within the spirit and scope of the present disclosure. Exemplary seed profile characteristics that may be customized or altered include, but are not limited to, growing degree days, water demands, nutrient demands, relative maturity, days to maturity, projected yield, genetic information (e.g., resistance to Roundup—glyphosate, etc.),

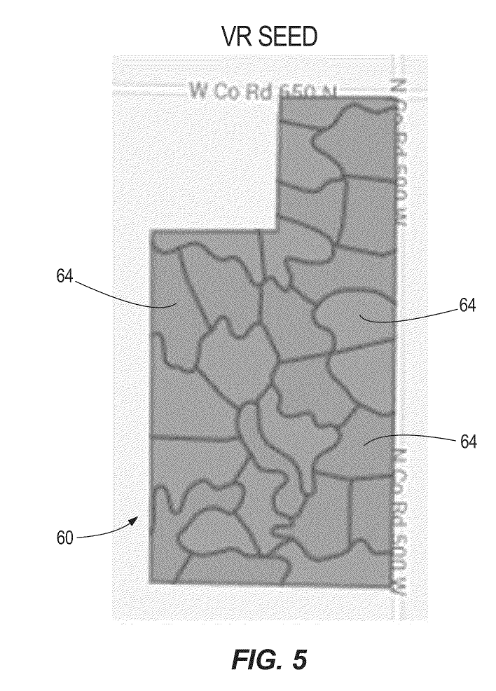

With reference to FIG. 5, one example of a land area of interest is shown and is color coded based on the selected seed variety. The system 20 may color the land area of interest differently based on the variety of seed planted in the land area of interest. In the illustrated example, the same seed variety is planted over the entire land area of interest. In other examples, multiple seed varieties may be planted over a land area of interest and, in such examples, the land area of interest will include multiple colored zones to represent multiple seed varieties.

In one example, the system 20 allows customization of the growing degree days for seed variety. In one example, growing degree days is a heuristic tool useful in determining when a plant will reach various growth stages and expected water and nutrient usage. Growing degree days accounts for aspects of local weather and predict (and even control) a plant's pace towards maturity. Unless stressed by other agronomic factors, like moisture, the development rate from emergence to maturity for many plants may depend upon the daily air temperature. In one example, growing degree days may be defined as a number of temperature degrees above a certain threshold base temperature, which varies among plant species. The base temperature may be the temperature below which plant growth is zero or almost zero. The system 20 can calculate growing degrees each day as a maximum temperature plus the minimum temperature divided by 2 (or the mean temperature), minus the base temperature. The system 20 may accumulate growing degree days by adding each day's growing degrees contribution as the season progresses. Alternatively, in some examples, the system 20 may utilize an hourly calculation instead of a daily (24 hour) calculation to allow for greater resolution. In an hourly calculation, such a calculation may include a weighted average calculated hourly and summed for the day. Further, the system 20 may account for the accumulation of growing degree days during the vegetative states and reproductive states of the crop. For example, the system 20 may consider the vegetative state of corn—planting, V2, V4, V6, V8, V10, V12, V14, V16-through the reproductive states—silks emerging, kernels in blister stage, dough state, denting, dented—until physiological maturity. In one example, the system 20 and the computing element 32 further utilize growing degree days in calculating water requirements for a crop and whether water (or weather) is a limiting factor.

In one example, the system 20 allows customization of a seeding rate or amount of seed planted per a particular size land area (e.g., number of seeds planted per acre). The seeding rate may be altered at any level of land area of interest. For example, a user may alter, via the system 20, a seeding rate for the entire land area of interest, which may be comprised of numerous fields. Also, for example, a user may alter, via the system 20, a seeding rate for each field within the overall land area of interest. Further, for example, a user may alter, via the system 20, the seeding rate within a single field. That is, different portions or zones of the same field may have different quantities of seeds planted. As indicated above, the system 20 and the computing element 32 provide a user with the ability to select amongst a large variety of seed types.

In one example, the system 20 allows customization of a planting date. Altering planting dates for a crop may have a major impact on crop maturity and stress tolerance at different times throughout the growing season. Selecting an appropriate planting date may be dependent upon one or more growth conditions such as, for example, actual and/or historical weather, weather forecasts, seed variety, etc. In pre-season scenarios, a user may wish to try different planting dates to determine the impact on crop yield. Trying different planting dates will provide windows for best crop yields based on temperature forecasts, rainfall estimates, seed variety, seeding rate, etc., and will help forecast crop maturity and harvesting dates. For both pre-season and in-season scenarios, a user can input the actual planting date and forecast when the crop will reach full maturity and when the crop will be ready for harvesting.

In one example, the system 20 allows customization of irrigation. Some land areas allow for irrigation by having an irrigation system, whereas other land areas do not. Many types of irrigation systems may be utilized with the system 20. For example, irrigation systems may be above grade (e.g., center pivot systems) or below grade (e.g., drip tape systems or tiling systems). Tiling systems may be installed several feet below the ground surface and assist with draining the soil. Tiling systems may also be gated to allow a user to selectively open or close portions of the tiling system. The user may close the tiling system (or a portion or portions thereof) when dry conditions exist to help maintain water in the soil and the user may open the tiling system when wet conditions exist to help drain water from the soil. For those areas that allow for irrigation, the system 20 may be altered to account for rainfall and/or water added to the land area. For example, in dry years, it is desirable to add an amount of water to coordinate with the water demands of the seed variety planted in the land area. A user may input an amount of water added to the land area into the system 20 in a variety of manners. In pre-season scenarios, a user may tryout various levels of irrigation in the system 20 to determine the impact on the crop yield and select the best results for the upcoming season. These pre-season scenarios may also assist a user with making in-season adjustments as water quantities in the actual field may alter from the forecasted amounts. From the pre-season trials, the user will already know how the various levels of water impacted the crop and will be ready to make the in-season adjustment that results in a better crop yield. Additionally, for in-season scenarios, the user may input real-time water quantities into the system 20 to see the impact of such water quantities on the future crop yield. The user will then be able to make the appropriate changes in the field.

The system 20 and computing element 32 may be used in conjunction with various irrigation systems and allow for in-season adjustments. In one example, the system 20 and computing element 32 predict how a user irrigated a field. The system 20 analyzes actual weather data, historical weather data, standard farming practices for the area, seed variety, and planting date—also considering the growth cycle—to project how many inches of water a user would add on any given day.

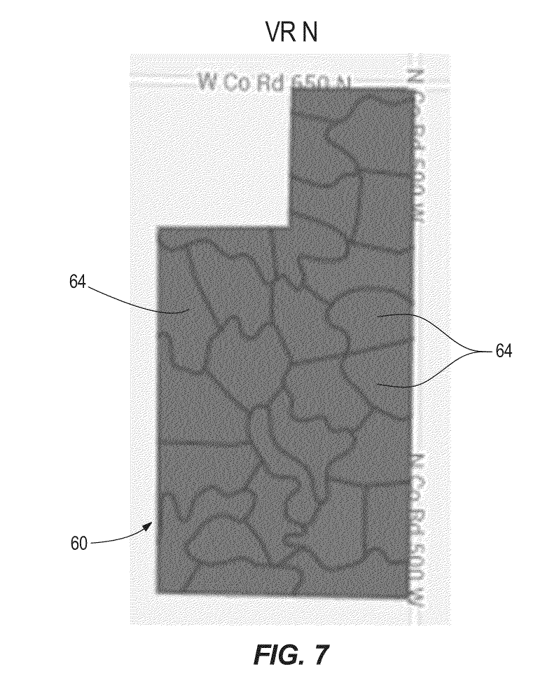

In one example, the system 20 allows customization of a nitrogen rate or amount of nitrogen required for the land area of interest. In pre-season scenarios, a user may try different permutations of crop characteristics in the system 20 (e.g., soil, seed and weather) and the system 20 will provide an estimate of how much nitrogen to apply and when to apply the nitrogen. For in-season scenarios, the amount and time to apply nitrogen may change as other crop characteristics change (e.g., weather, water, temperature, etc.). The system 20 will adapt based on these changes and provide an updated amount and time to apply nitrogen, accounting for any previous applications of nitrogen in the pre-season, at the time of planting or at one or more growth stages. A user may also input the amount and time of applying nitrogen into the system 20 and the system 20 will determine the effect of such nitrogen application on the crop. With reference to FIG. 7, one example of a land area of interest is illustrated and is color coded by the system 20 based on a nitrogen rate. The system 20 colors the land area of interest differently based on the nitrogen rate in the land area of interest. In the illustrated example, the entire land area of interest has the same nitrogen rate (which is why the system 20 colors the entire land area of interest with a single color). In other examples, the land area of interest may have zones with different nitrogen rates and, in such examples, the system 20 will color the land area of interest with multiple colored zones to represent multiple nitrogen rates.

In one example, the system 20 allows customization of the soil type. Soil type may be customized via the system 20 if the soil types received from a 3^{rd} party source (e.g., SSURGO) are not accurate or are not sufficiently accurate to the soil type of the land area of interest. Soil type information of the land area of interest may be supplemented by performing a soil test to receive soil test data. The system 20 may include a soil testing device configured to test the soil and generate soil test data. Soil test data may pertain to various characteristics associated with soil including, but not limited to, pH, organic matter, phosphorous, nitrogen, potassium, cation exchange capacity (CEC), moisture holding capacity (inches moisture deficiency at planting, inches moisture holding capacity at root zone, 50% moisture holding capacity), etc. In one example, the system 20 analyzes the soil test data and replaces prior soil data with the soil test data to customize the soil type. In another example, the system 20 analyzes the soil test data, supplements the prior soil data with the soil test data to customize the soil type, and considers both the prior soil test data and the new soil test data in combination. In such an example, the new soil test data may supplement the prior soil test data in any manner such as, for example, replace the prior data in-part, replace the prior data in-whole, or not replace any prior data. The system 20 may customize soil type at any level with respect to land areas of interest. For example, the system 20 may customize at a zone-by-zone level, a field level, or a group level comprising a plurality of fields. Referring again to FIG. 4, in this example, a user may customize the soil type of each zone via the system 20 as desired.

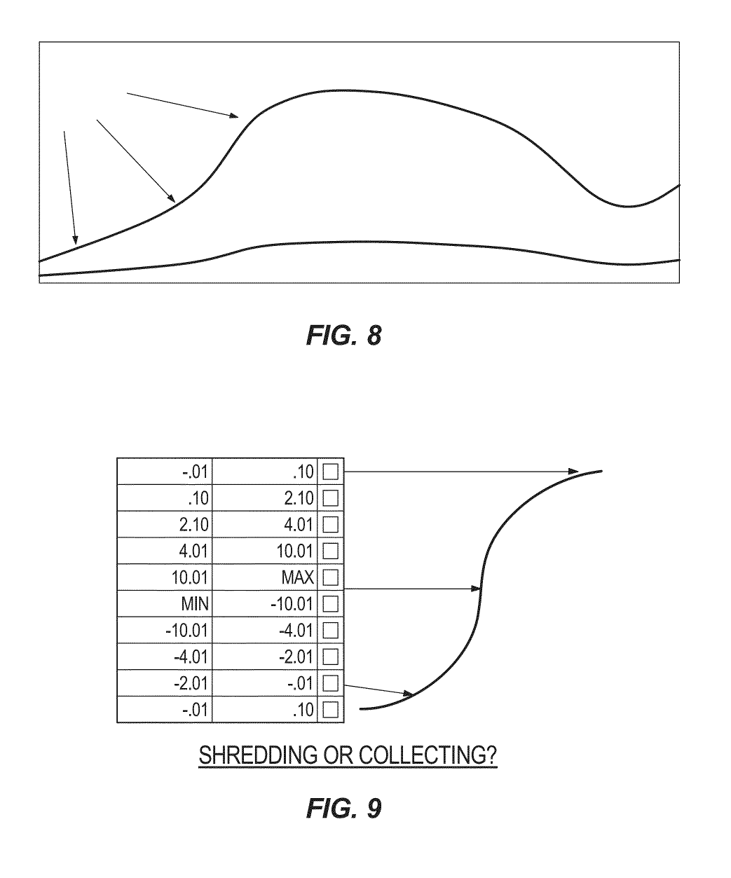

In one example, the system 20 allows customization of slope, which is the position, e.g., elevation, for a point in a land area of interest relative to neighboring points in that same land area of interest. Land is seldom flat or consistent across a land area of interest or field (see FIGS. 8 and 9). Thus, water and other inputs introduced onto or into the land area of interest may accumulate or shed differently based on the slope of the land area in particular zones. Water and other inputs are more likely to collect on flat zones and valleys, whereas water and inputs are more likely to run-off or shed from steep or inclined zones and hilltops. Thus, the slope is an important characteristic of the land area that impacts the performance of the crop. The system 20 may collect, obtain, receive and/or retrieve elevation information in a wide variety of manners and from a wide variety of sources. For example, the system 20 may obtain or retrieve elevation information from, but not limited to: Databases containing LIDAR data maintained by the United States Geological Survey (USGS); IFSAR data; active sensors including SRTM; complex linear interpolation from contours (often including hydrography—LT4X); photogrammetrically complied mass points and break lines; digital camera correlation (usually from line camera such as Leica ADS40); polynomial interpolation from contours, mass points and break lines (ANUDEM); simple linear interpolation from contours (DLG2DEM and DCASS); manual profiling via a mechanical or analytical stero-plotter; gestalt photomapper II (electronic image correlation); topobathy merged data; among other manners and sources. In one example, the system 20 may include one or more devices that measure and/or determine slope itself/themselves. In this example, the slope devices generate or creates data associated with the slope of the land and the system analyzes and/or stores the slope data for further consideration.

In another example, the system 20 may calculate slope using the position of a given point relative to a set of points around that point within a land area of interest to model water movement. In one example, the system 20 uses raster data with a single elevation point and eight neighboring elevation data points, calculates the slope of each data point and then the maximum slope of each combination of two points. The relative position of the maximum slope is established and then determined to be negative or positive. A positive maximum slope means that the single elevation point is higher than a neighboring point; while a negative maximum slope means that the single elevation point is lower than a neighboring point. This relative position of the maximum slope is then stored and retrieved to create a high-resolution raster file. The high-resolution raster file is used to group relative positions into smoothed polygons; resulting in an appropriate resolution for controllers on agricultural devices, e.g., a rate controller for a sprayer. After the system 20 and computing element 32 determine the slope for a land area or land areas, the land areas may be divided or grouped into different zones and those zones collectively may differ from one another in slope. The slopes within a land area though may differ or be similar. In one example, the slope within a land zone may be relatively uniform and similar. In another example, the slope of the land area may fluctuate. In such an example, one zone may be flat while another zone may be steep.

The system 20 may determine and utilize slope in other manners. In one example, a user may initiate (e.g., opt-in) the process. The process may be hosted in a virtual server environment (e.g., a Rackspace, etc.) and the user may provide data to the system 20. The user may provide data to the system 20 in a variety of manners. In one example, the user provides one or more binary spatial coverage files (e.g., shape files, etc.) indicating boundary and map coverage (e.g., SSURGO) from a source (e.g., Surety, a GIS system, etc.). The system 20 may locate and extract elevation data based on the user's provided data once the user provided data is received by the system 20. The system 20 may receive the elevation data from a variety of sources (as indicated above). The system 20 and computing element 32 calculate or determine the slope as a percent slope (e.g., rise/run×100%). The sign of the slope indicates a curvature condition of the soil. For example, a positive (+) slope coordinates with a hilltop, which indicates increased slope rate downhill, and a negative (−) slope coordinates with a valley, which indicates decreased slope rate downhill. Slopes may be segmented, categorized or classified into any number of ranges, categories, classes or groups. For example, ranges may be established and any slope falling between thresholds of a particular range would be associated with that range, category, class or group. In other examples, each slope may be its own category, class or group, thereby providing as many classes, categories or groups as the number of determined slopes.

The following example is presented to demonstrate principles of the present disclosure and is not intended to be limiting. In this example, the system 20 utilizes the following classes, categories or groups, which are defined by the following ranges:
−18%: slope<=−18
−16%: −18<slope<=−14
−10%: −14<slope<=−7
−4%: −7<slope<=−2
0%: −2<slope<=2
4%: 2<slope<=7
10%: 7<slope<=14
16%: 14<slope<=18
18%: 18<slope

Slopes associated with the −4%, −10%, −16% and −18% classifications are characterized as valleys and are configured to catch or collect water, whereas slopes with the 4%, 10%, 16% and 18% classifications are characterized as hilltops and are configured to allow water to runoff or otherwise lose water. Slopes in the 0% classification are characterized as flat and water is neither running-off nor collecting due to these slopes.

In one example, once the system 20 determines and categorizes the slopes, the system 20 generates a binary spatial coverage file using the slope data and sends the binary spatial coverage file to a specified location within the virtual server environment. In another example, a KML file may also be exported or sent from a GRASS (Geographic Resources Analysis Support System) VM. In a further example, binary data may be passed to or received by the system 20. The system 20 may then send ASCII data (e.g., KML, JSON, WFS, WMS, etc.) to a web server. The system 20 may then output a polygon binary spatial coverage file coverage similar to a SSURGO map to a web server with the additional calculated slope data. The slope data (e.g., on the server side) may be leveraged while performing final calculations in the system 20.

Now that the slope has been calculated, in one example, the system 20 may determine a virtual rain gauge that accurately determines how much water is in the soil after accounting for water run-off or collecting. The virtual rain gauge will have a higher water value (e.g., rainfall value) than the actual amount of rainfall for soil having negative slopes (due to collecting) and the virtual rain gauge will have a lower water value (e.g., rainfall value) than the actual amount of rainfall for soil having positive slopes (due to run-off). The water value of the virtual rain gauge may be equal to the actual amount of rainfall for soil having a slope in the 0% category since the soil is substantially flat, thereby eliminating any run-off or collection. Once the system 20 determines the water value associated with the virtual rain gauge, the system 20 may perform other steps in the disclosed processes, operations, methods, etc., using the water value (e.g., determining projecting yield, limiting factor, seed rate, nitrogen rate, etc.). Thus, the system 20 is capable of providing more accurate results due to the consideration of soil slope and its impact on water distribution.

The following is another example of the system 20 determining a slope and coordinating the slope with a user's desired zone(s), field(s), or with any land area of interest. The system 20 receives, from a user via an input devices of, for example, one or more of devices 48, 52, 56, a spatial map of their land area of interest as a set of soil zone polygons that are clipped to a boundary as a binary spatial coverage file. The binary spatial coverage file may have a variety of forms. In one example, the binary spatial coverage file is in WGS-84 spherical coordinates (i.e., latitude and longitude coordinates). The system 20 imports soil zone data from one of a variety of sources (e.g., as described elsewhere herein) into a GIS environment of the system 20. The system 20 projects the soil zone data into a planar map projection (e.g., a soil layer) in distance units and checks and cleans the geometry topology. The system 20 defines a buffer layer based on the soil layer to clip elevation data from a U.S. national elevation dataset (NED). In some examples, the buffer layer may be larger than the user's inputted zone(s), field(s) or land area of interest. The system 20 calculates a slope-signed raster layer from an elevation layer. In this step, the system 20 may determine whether the slope is positive, negative or zero (flat). The system 20 may vectorize the raster slope data. In this step, the system 20 may apply a predetermined set of rules (e.g., categorization, grouping or classification of slopes). The system 20 may clean up and smooth resulting zone polygons. Clean up may pertain to areas within a zone that are irregularities or errors as compared to surrounding areas within the zone. In one example, smoothing of the zone polygons may be performed for aesthetic purposes to increase user understanding and experience. Such clean up and smoothing may also be performed to improve performance of a monitor or other visual output device on which the resulting data and associated image may be displayed. The system 20 overlays the slope zone polygons on the soil zones inputted by the user to create new zones that are subdivisions of the inputted soil zones. That is, the lower quantity of inputted soil zones are further divided to provide multiple new zones within each soil zone based on slope of the soil. The system 20 projects the new soil zones as spherical coordinates (e.g., latitude and longitude coordinates), cleans-up the geometry of the projection, and writes the file to a binary spatial coverage file. Some monitors only work with latitudinal and longitudinal coordinates so the system may convert the outputted file to latitudinal and longitudinal coordinates.

In general, the slope of any land area of interest or zone impacts water distribution throughout the zone. The system 20 may determine the slope's impact on water distribution in a wide variety of manners and all of such manners are intended to be within the spirit and scope of the present disclosure. Some exemplary manners of slope's impact on water distribution are described above. The following are additional manners of slope's impact on water distribution.

In one example, the system 20 utilizes at least one process, such as, for example, an algorithmic function, to determine an influence of slope on water distribution and determine soil moisture for a given point. In another example, the system 20 utilizes a variety of processes, such as, for example, algorithmic functions, to determine an influence of slope on water distribution and determine soil moisture for a given point. In one example, the system 20 may determine the soil moisture at a given point by considering the slope and an amount of rainfall at the given point. If the slope at that point is positive, which indicates an increased slope rate downhill, the system 20 uses a first process, such as, for example, a first algorithmic function, to determine water distribution. If the slope at that point is negative, which indicates a decreased slope rate downhill, the system 20 uses a second process, such as, for example, a second algorithmic function, to determine water distribution. The system 20 may use any number of process, such as, for example, algorithmic functions, to determine slope's impact on water distribution. The system 20 may also consider other factors or variables in determining slope's impact on water distribution such as, for example, soil type, crop age, seed variety, duration of weather events, etc.

The system 20 determines soil moisture at a variety of points by considering water distribution at those points and may utilize the soil moisture of those points in a variety of manners. The system 20 may determine soil moisture for any number of points within a zone (including only one point), a plurality of zones, a field, a land area of interest, etc. In one example, the system 20 utilizes the soil moisture of the point(s) to determine an agronomic limiting factor. The limiting factor may be determined for a single point, a zone, a plurality of zones, a field, a land area of interest, etc. Determining the limiting factor utilizing an accurate soil moisture that considers soil slope will assist a user in a variety of manners such as, for example, producing a higher or highest possible crop yield, a highest crop yield with a lowest seed or plant population, a highest yield at a lowest cost, etc. In one example, the system 20 may determine a quantity of water required to move the seed population higher to achieve higher projected crop yields. In another example, the system 20 may determine how many inches of rainfall (or water from another source) is required to move the seed population higher or lower in any desired increments (e.g., 1000 seeds) to achieve higher projected crop yields. For example, the system 20 may decrease a total planting population from 34,000 seeds per acre to 33,000 seeds per acre based on soil moisture and provide recalculated projections on crop yield.

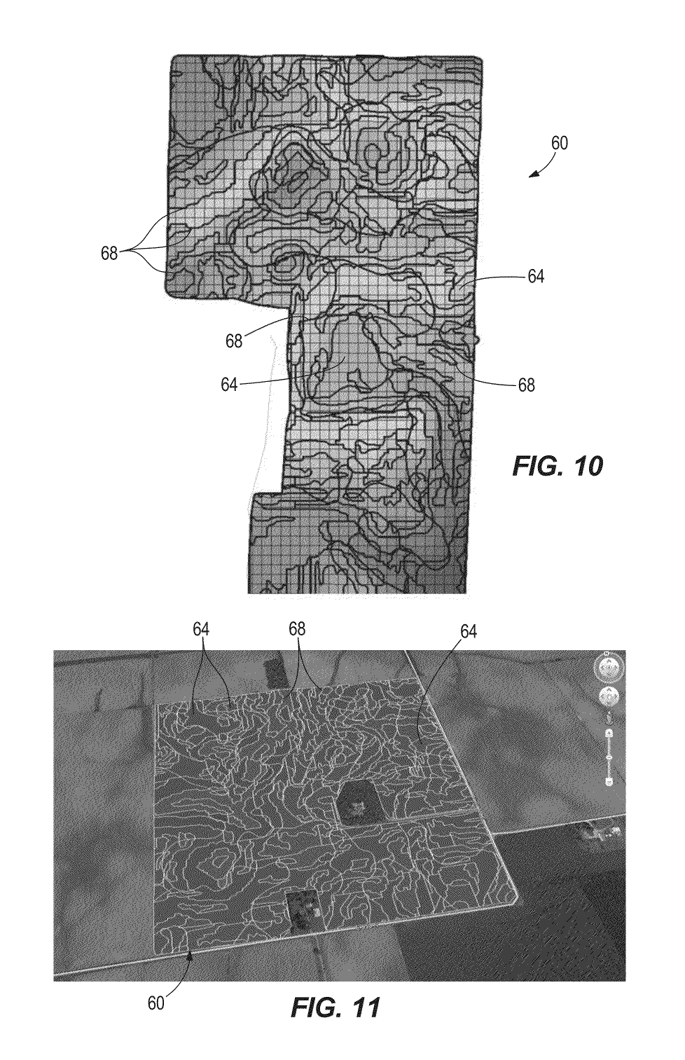

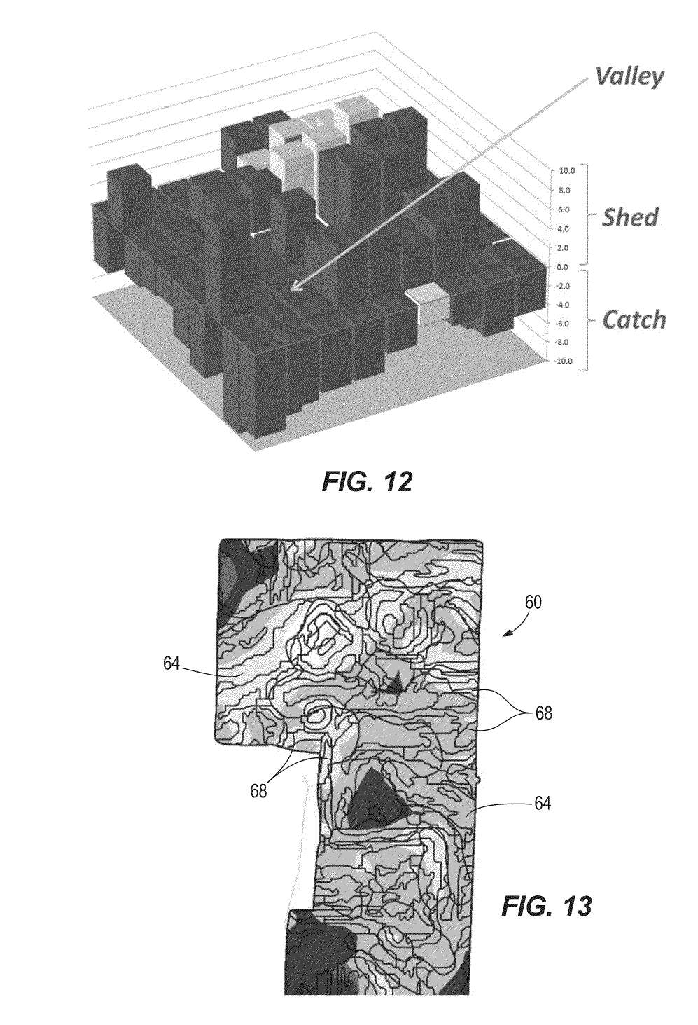

The system 20 and the computing element 32 may generate maps or illustrations of land areas of interest and incorporate slope into the land areas of interest. For example, with reference to FIGS. 10 and 11, these exemplary maps include zones 64, associated soil properties, and slope of the land. The soil properties are identified by various greyscale colors and the slope is identified by dark lines overlaying the greyscale coloring. The system 20 may represent slope in a variety of manners, but, in these illustrated examples, the system 20 represents slope using contour lines 68 in topographical maps. Alternatively, with reference to FIG. 12, the system 20 may represent slope of a land area of interest in other manners such as, for example, a 3D-bar graph.

All of these land characteristic may be important to the analysis performed by the system 20 and the computing element 32. Actual land slopes present in the land area of interest may differ from the slopes retrieved from other sources. Thus, the system 20 allows a user to customize the land slope by inputting actual land slopes of the land area of interest via an input device of the system 20 or of one or more of the devices 48, 52, 56. The system 20 allows alteration of slopes at a variety of levels including, but not limited to, a field-by-field level, a zone-by-zone level, or the user may alter slopes, via the system 20, within a single zone and as a result create new zones with different slopes within a single zone or a single zone with similar slopes within that zone. With reference again to FIG. 10, the slopes in this exemplary map may be altered at any level (e.g., at the field level, at the zone level, or even within a single zone). With reference to FIG. 13, the land slope impacts water flow on a land area of interest. The various greyscale colors included in FIG. 13 demonstrate the areas where water accumulates and where water sheds. In one example, darker colors may represent areas where more water accumulates and lighter or white colors may represent where water sheds.

In one example, the system 20 allows customization of the weather. In the pre-season, the system 20 may run a variety of scenarios based on historical weather patterns and/or on weather forecasts for the upcoming year. A user may alter the weather in the system 20 to determine how various weather conditions impact crop performance. The system 20 allows alteration of many weather characteristics which include, but are not limited to, rainfall, temperature, humidity, pressure, sunlight, wind, or any other weather characteristic. For in-season scenarios, a user may alter the weather characteristics within the system 20 to reflect real-time weather data that corresponds more closely to reality rather than forecasts.

Furthermore, the system 20 and the computing element 32 provide the ability to customize the weather to reflect weather conditions associated with an El Niño year or a La Nina year. El Niño and La Nina years have different weather patterns and weather characteristics. These differences can greatly affect a crop's growth. Thus, a user may customize the weather of the system 20 and the computing element 32 by selecting either an El Niño year or a La Nina year via an input device of the system 20 or of one of the devices 48, 52, 56. The system 20 and the computing element 32 will perform their functionalities, operations, processes, methods, etc., with consideration of the selected weather characteristics.

With reference to FIG. 14, a plurality of exemplary weather maps are illustrated and may be relied upon by the system 20 and the computing element 32 to perform the desired functionalities, operations, processes, methods, etc., of the system 20 and the computing element 32. These examples of weather maps illustrate various types of weather maps that the system 20 and the computing element 32 may utilize and they contain various types and quantities of weather information. Additionally, these exemplary weather maps may either be historical weather maps or future weather forecasts. The system 20 and the computing element 32 use this weather information to determine and/or project crop yields (see bottom left map in FIG. 14) for one or a plurality of land areas of interest.

In one example, the system 20 allows customization of any input, characteristic, factor, feature, etc., associated with growing a crop. In pre-season scenarios, the user may tryout any permutation of any input within the system 20 and the system 20 will determine the effects of the various permutations of inputs on the crop yield. The user may then use this information to make appropriate decisions for the upcoming growing season. For in-season scenarios, the user may customize and introduce into the system 20 any input, characteristic, factor, feature, etc., associated with growing a crop with real-time data to closely reflect reality in the land area of interest. As indicated above, reality often times differs from forecasts and this customization provides the system 20 with the ability to correspond as close as possible with reality.

The system 20 may facilitate customization of any number of the above characteristics in any combination and all of such possibilities are intended to be within the spirit and scope of the present disclosure. For pre-season crop planning, customizing the various characteristics in different permutations provides the user with the ability to forecast and select the proper crop to plant in the upcoming season. Selecting the proper crop is much more difficult than just planting the same crop that was planted the previous year, which is the case for many farmers. Many seed varieties exist that have various demands (e.g., water demands, sunlight demands, nutrient demands, etc.). Since soil characteristics and weather patterns differ from year to year, the system 20 provides a user with the ability to consider these changes and select the proper seed variety, amount and type of inputs, etc., for the upcoming year. For in-season crop management, growing conditions alter along the way such as, for example, nutrient requirements, temperature, rainfall, other weather conditions, water demands, etc., and the system 20 provides the user with the ability to update a wide variety of growing conditions in order to modify the forecasted crop performance to reflect reality. This enables a user to make adjustments in the field (e.g., irrigation, nutrient increase or decrease, other input increase or decrease, harvest sooner or later, etc.) based on the real conditions in the land area of interest.

In addition to the above, in one example, the system 20 allows for customized slope and weather data to provide a soil moisture. Soil moisture may be determined at any time increment such as, for example, by the second, minute, hour, day, week, or any other increment of time. In the following illustrated and described example, soil moisture will be determined on an hourly basis and will be referred to as hourly soil moisture. It should be understood that the present example is provided to demonstrate principles of the present disclosure and is not intended to be limiting.

The hourly soil moisture may be established for each zone, a group of zones, or for all the zones together. Such zone(s) may be established in a variety of manners. In one example, a zone may be an entire field. In another example, a zone may be defined by soil type and a field may include a variety of zones. In a further example, a zone may be defined by slope and a field may include a variety of zones. In still another example, a zone may be defined by considering both soil type and slope, and a field may include a variety of zones (e.g., would provide further breakdown of a field to increase detail and accuracy of the system). In a still further example, a zone may be defined by any combination of any characteristics disclosed herein or other agronomic characteristics.

In one example, hourly soil moisture may take into account moisture capacity of the soil, weighted average field capacity, dryout values of the soil, and other variables and characteristics. In one example, a weighted average of hourly soil moisture may be performed on all zones together. In another example, an hourly soil moisture may be determined for each zone. In a further example, a weighted average of hourly soil moisture on all zones together may be determined and then integrated with slope to distribute a virtual rain gauge value across all zones together. In still another example, an hourly soil moisture may be determined for each zone and then integrated with the slope of each zone to provide a virtual rain gauge for each zone. The virtual rain gauge may utilize weather data, e.g., hourly or daily, to determine how much rain has been received for a land area or point within a land area of interest (e.g., a field, zones within a field, or numerous points within a zone). In one example, the weather data is an hourly binary spatial coverage file or stream from National Oceanic and Atmospheric Administration or Next-Generation Radar (NEXRAD).

Hourly soil moisture for a zone or zones may be determined in a variety of manners. In one example, hourly soil moisture may be determined as follows:

Initial Soil Water Volume+Soil Moisture Change=End Soil Water Volume (1)

Initial soil water volume is the water volume of the soil at onset of the calculation or determination period. The initial soil water volume may be determined in a variety of manners. In one example, the initial soil water volume may be determined by an initial test of the soil using a moisture probe, sensor, or the like. In other examples, initial soil moisture may be assumed to be a certain value below saturation such as, for example, about 0.5 inches below saturation. In further examples, initial soil moisture may be downloaded from a database or received from a 3^{rd} party. In still other examples, initial soil moisture may be calculated based on historical rainfall, irrigation, combination thereof, or other moisture data. Initial soil water volume may be represented with a variety of different units of measure or may be represented as a percentage.

Soil moisture change may be a positive value if rain, irrigation or some other manner of adding water to the soil occurs. Conversely, soil moisture change may be a negative value if water is not added to the soil. In one example, if water is added to soil and the moisture value is positive, the soil moisture change value may be equal to the amount of water added (e.g., in inches or some other unit of measure). For example, if it rains 0.5 inches, then the soil moisture change value would be 0.5 inches. In one example, if water is not added to the soil and the soil moisture change is negative, the soil moisture change may be referred to as a dryout value because the soil is drying out when water is not being added. For example, if water is not added to the soil, the dryout value may be −0.015626 inches. In instances where hourly soil moisture is desired, the unit of measure for the soil moisture change value would be per hour. Referring again to the above examples, if it rains 0.5 inches in one hour, the soil moisture change value would be 0.5 inches/hour, and if it doesn't rain in an hour, the soil moisture change value would be −0.015626 inches/hour. It should be understood that the dryout value may be any value and all of such possibilities are intended to be within the spirit and scope of the present disclosure. The exemplary dryout value is provided to demonstrate principles of the present disclosure and is not intended to be limiting.

In scenarios when the soil moisture change value is positive due to water being added to the soil, soil moisture change is relatively straight forward and may equal the amount of water added to the soil. Determination of soil moisture value when water is not being added and the soil moisture change value or dryout value is negative, determination of the dryout value may be determined in a wide variety of manners and may be dependent on a variety of different characteristics. In one example, the soil moisture change or soil dryout may be dependent upon the temperature. In this example, soil moisture change or soil dryout may be a first value/rate when the temperature is low, a second value/rate when the temperature is moderate, and a third value/rate when the temperature is high. Typically, the soil dryout value will be more negative (i.e., soil will dryout at a quicker rate) when the temperature is higher. In examples where temperature is utilized to determine dryout value, the dryout value may be different for any increment of temperature. For example, the dryout value may vary for every degree of temperature change, may vary on any increment of a degree of temperature change, a range of temperatures, or any other increment or range.

Once the end soil water volume is determined, end soil moisture may be determined. End soil moisture may be determined in a variety of manners. In one example, end soil moisture may be determined as follows:

End soil moisture=End soil water volume÷Soil water holding capacity (2)

Soil water holding capacity may be determined based on a wide variety of different characteristics. In one example, soil water holding capacity may be determined based on one or more of soil type, slope, seed variety planted in soil, etc. Generally, soil water holding capacity may represent the maximum amount of water that can be held by the soil. End soil moisture may also be represented as a percentage. In such a case the end soil moisture determined from formula (2) above would be multiplied by 100% to arrive at an end soil moisture percentage.

The system 20 may display an hourly soil moisture map for each zone or zones. Such a map may include an indicator associated with the end soil moisture. The indicator may take a variety of forms. For example, the indicator may be text, numbers, a percentage, a color coded scheme, or any other manner of representing and differentiating between various end soil moistures. In one example, a color coded scheme may include a plurality of different colored pins or indicators that have colors associated with different end soil moistures. The pins may be a first color if the end soil moisture is a first value or within a first range of values, a second color if the end soil moisture is a second value or within a second range of values, a third color if the end soil moisture is a third value or within a third range of values and so on. The color coded scheme may include any number of different colored indicators.

End soil moisture may be utilized to calculate or determine a wide variety of other agronomic characteristics including, but not limited to, projected yield, solve for limiting factor, etc. The system 20 can also use hourly soil moisture in pre-season crop planning or making in-season adjustments. For example, the system 20 can use hourly soil moisture when solving for the ideal combination of pre-season crop planning data, e.g., the highest possible crop yield or highest possible crop yield with lowest plant population.

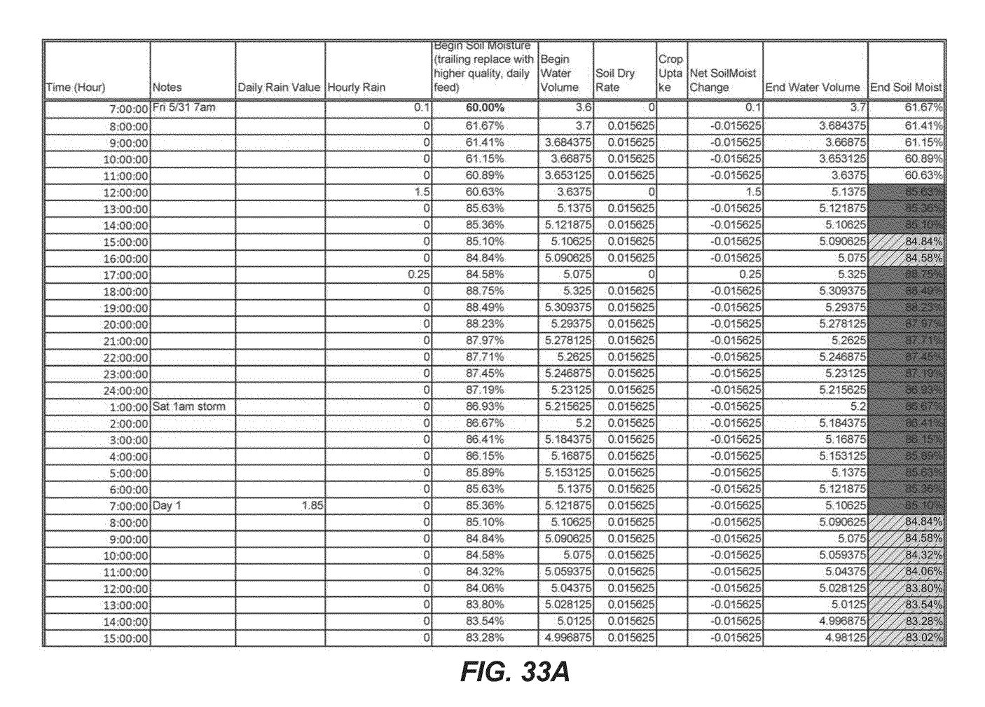

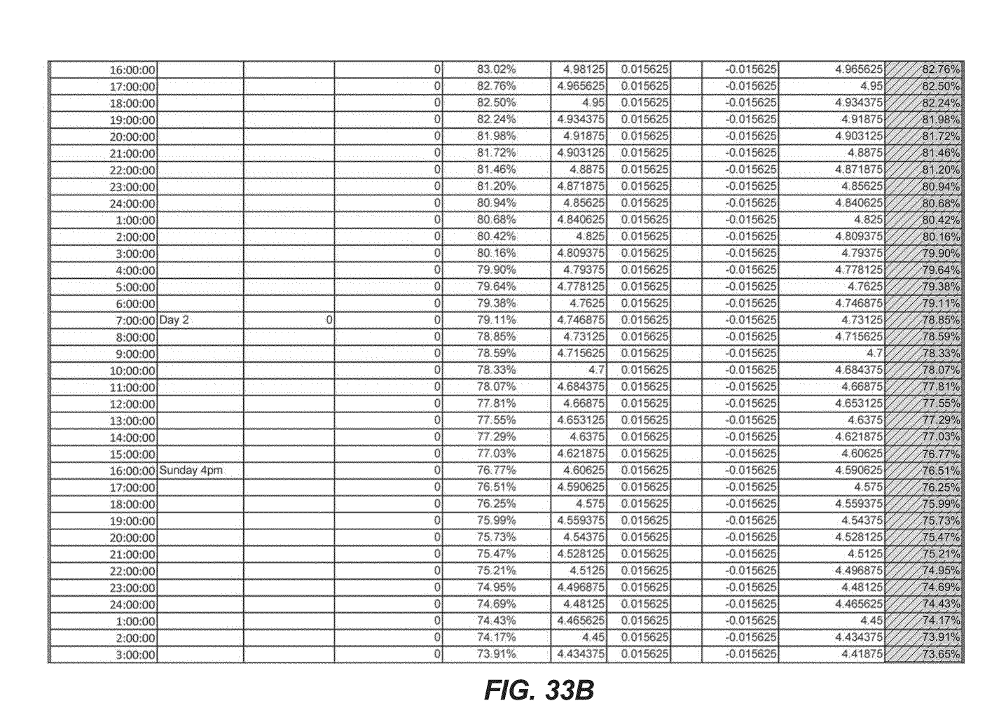

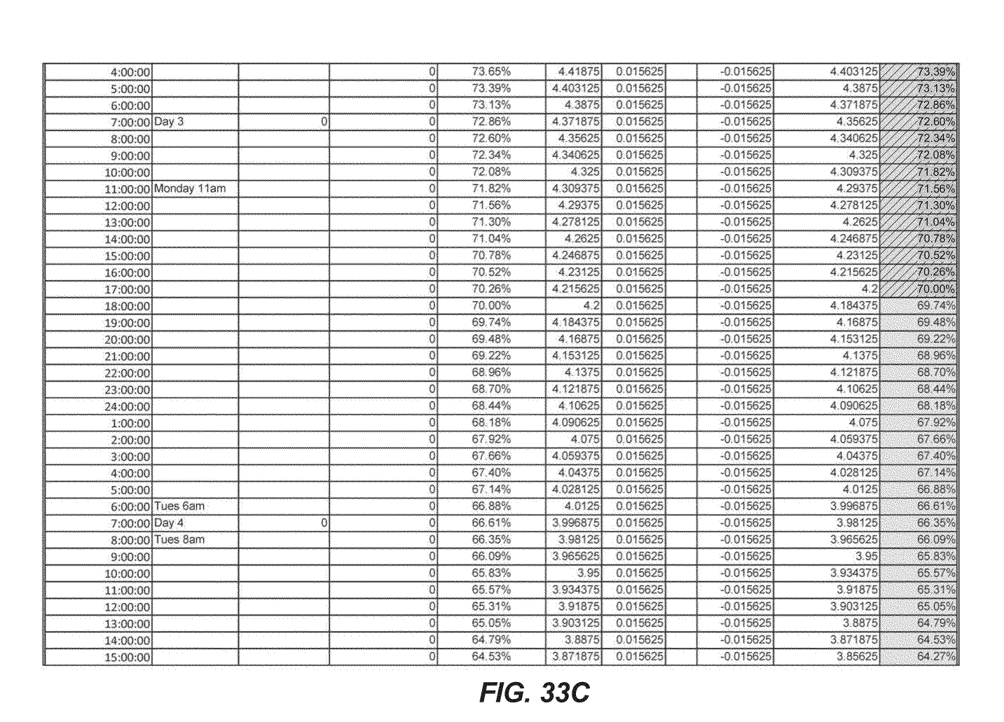

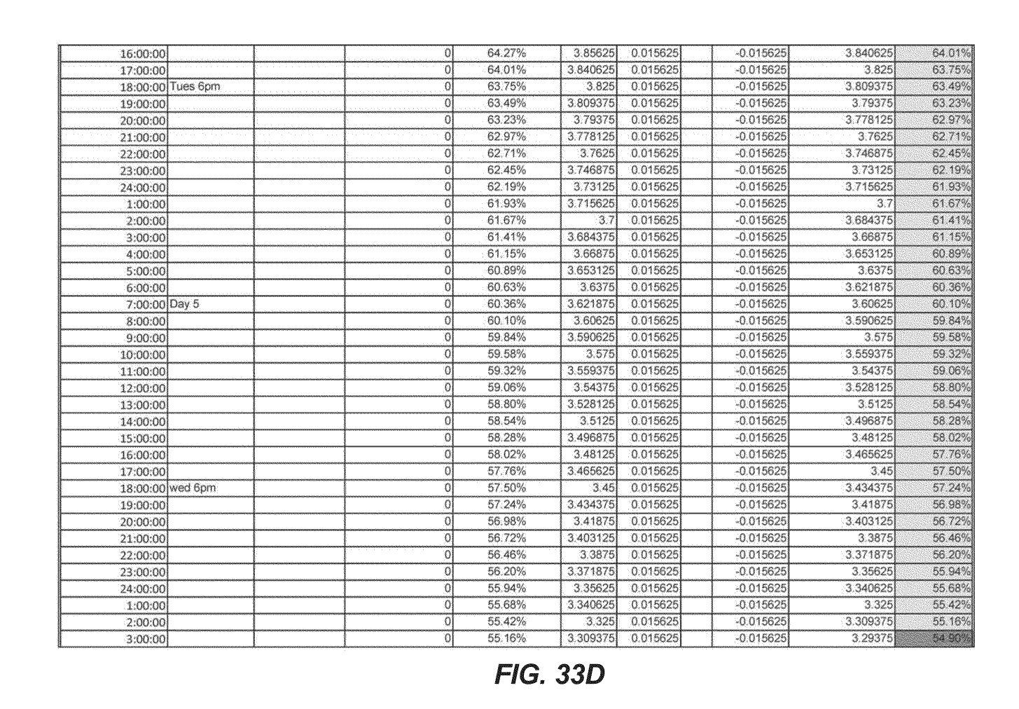

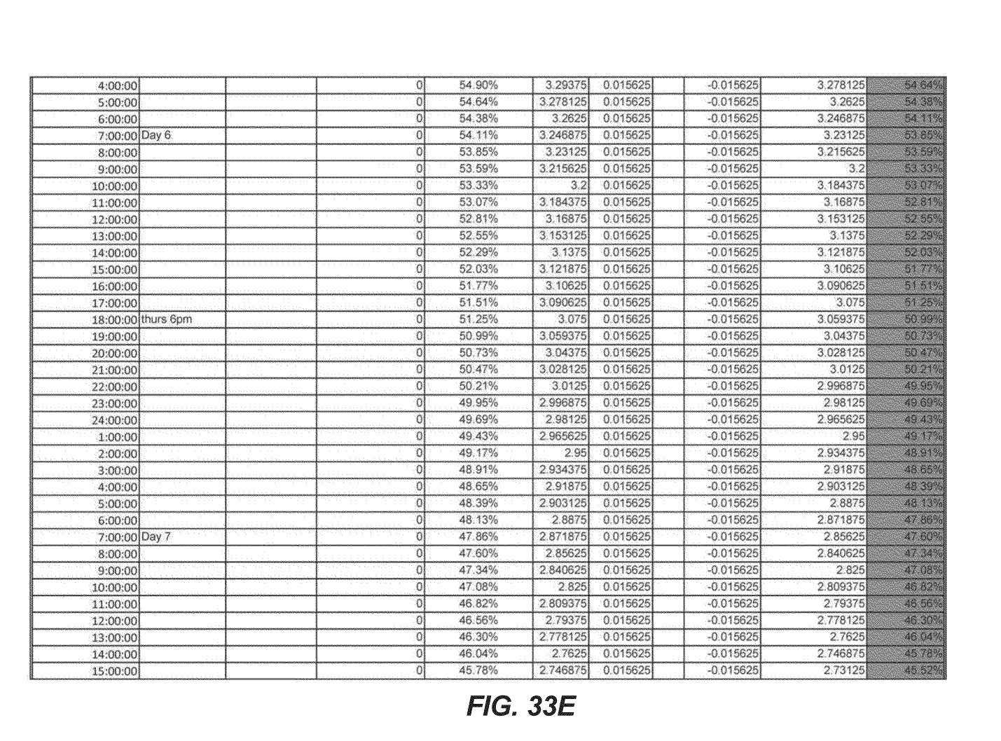

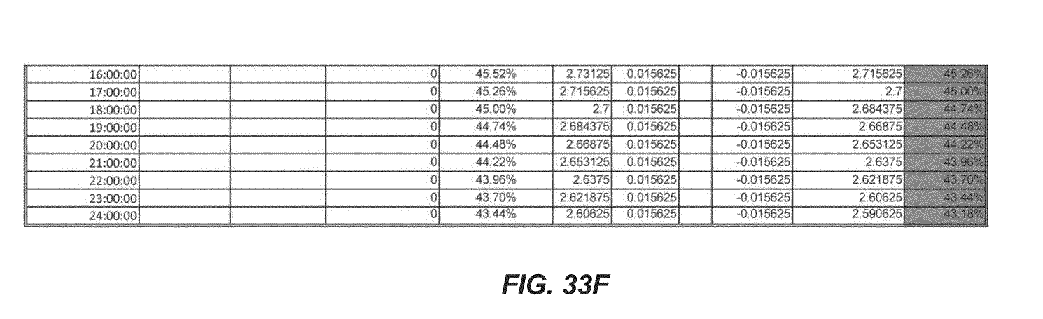

With reference to FIGS. 33-35, exemplary manners of the system 20 determining end soil moistures and visually demonstrating various end soil moistures to users are illustrated. These examples are not intended to be limiting upon the present disclosure. Rather, these examples are provided to demonstrate principles of the present disclosure and many other examples and manners are possible, all of which are intended to be within the spirit and scope of the present disclosure. Additionally, these examples include various values and assumptions. However, such values and assumptions are purely for exemplary purposes to demonstrate principles of the present disclosure, and should not limit the present disclosure. Other values and assumptions are certainly possible and are intended to be within the spirit and scope of the present disclosure.

Referring now to FIGS. 33A-33F, one example of a chart is shown and illustrates one example of calculating soil moisture on an hourly basis over multiple days. In this example, the beginning soil moisture is 60%, the beginning soil water volume is 3.6, the temperature utilized for the calculations is 66° F., and the soil moisture capacity is 6 inches. These chosen quantities are purely exemplary and are not intended to limit the present disclosure. Soil moisture capacity may be dependent on the type of soil. Many different types of soil exist (e.g., about 20,000 different types of soil) and, therefore, the soil moisture capacity may be a variety of different values. The soil moisture capacity represented in the figures is one example of many possible soil moisture capacity, is provided to demonstrate principles of the present disclosure, and is not intended to limit the present disclosure. Additionally, in this example, soil dryout rate is determined as follows:

If temperature <50° F., soil dryout rate=0.25 inches/day

If 50° F.<temperature <80° F., soil dryout rate=0.375 inches/day

If temperature >80° F., soil dryout rate=0.5 inches/day.

With continued reference to FIGS. 33A-33F, the exemplary chart includes a plurality of columns representing various characteristics. It should be understood that the chart may include any number of columns representing any type of characteristics and all of such possibilities are intended to be within the spirit and scope of the present disclosure. In this example of the chart, a first column represents the hour of the day since this example is an hourly soil moisture, a second column is a notes column, a third column is a daily rain (or irrigation) value comprised of a sum of the hourly rain over the day, a fourth column is a hourly rain value, a fifth column is a beginning soil moisture, a sixth column is a beginning soil water volume, a seventh column is a soil dryout value/rate, an eighth column is a crop uptake value (not used in this example), a ninth column is a soil moisture change, a tenth column is an end soil water volume, and an eleventh column is an end soil moisture. This exemplary chart is one example of a visual format of data generated and displayed by the system 20 and/or the computing element 32. The visual chart may be display on any device including, but not limited to, devices 48, 52, 56 or any other device with a monitor or display. It should be understood that the data generated by the system 20 and/or the computing element 32 may be represented in various other formats including, but not limited to, any other visual format, audio formats, or other types of formats.

In the exemplary chart, a first row represents 7:00 AM on Friday, May 31^{st}. During the 7:00 AM hour, it rained 0.1 inches (see column 4), which results in a soil moisture change of 0.1. Formula (1) is utilized to calculate or determine the end soil water volume for the 7:00 AM hour on May 31^{st}. The beginning soil water volume is 3.6 inches (see column 6) and the soil moisture change of 0.1 inches is added to 3.6 to obtain an end soil water volume of 3.7 (see column 10). Formula (2) is utilized to calculate the end soil moisture for the 7:00 AM hour on May 31^{st}. The end soil water volume is 3.7 inches, which is divided by the soil water holding capacity of 6 inches to arrive at 0.6167. To change this calculation to a percentage, the end soil moisture is multiplied by 100% to arrive at 61.67% (see column 11). The end soil moisture and the end soil water volume for the 7:00 AM hour on May 31^{st} respectively become the beginning soil moisture (see column 5) and beginning soil water volume (see column 6) for the 8:00 AM hour on May 31^{st}. This repeats for each hour on the chart. For the 8:00 AM hour on May 31^{st}, it did not rain. Thus, the soil moisture change will be negative. Since the temperature is 66° F. in this example, the dryout rate is −0.375 inches/day, which is −0.015625 inches/hour (0.375/24=0.015625) (see column 9). Utilizing Formula (1) for the 8:00 AM hour on May 31^{st}, the end soil water volume is 3.684375 inches (3.7 inches−0.015625 inches) (see column 10). Utilizing Formula (2) for the 8:00 AM hour on May 31^{st}, the end soil moisture is 61.41% ((3.684375 inches÷6 inches)×100%) (see column 11). These two formulas can be used for every hour on the chart.

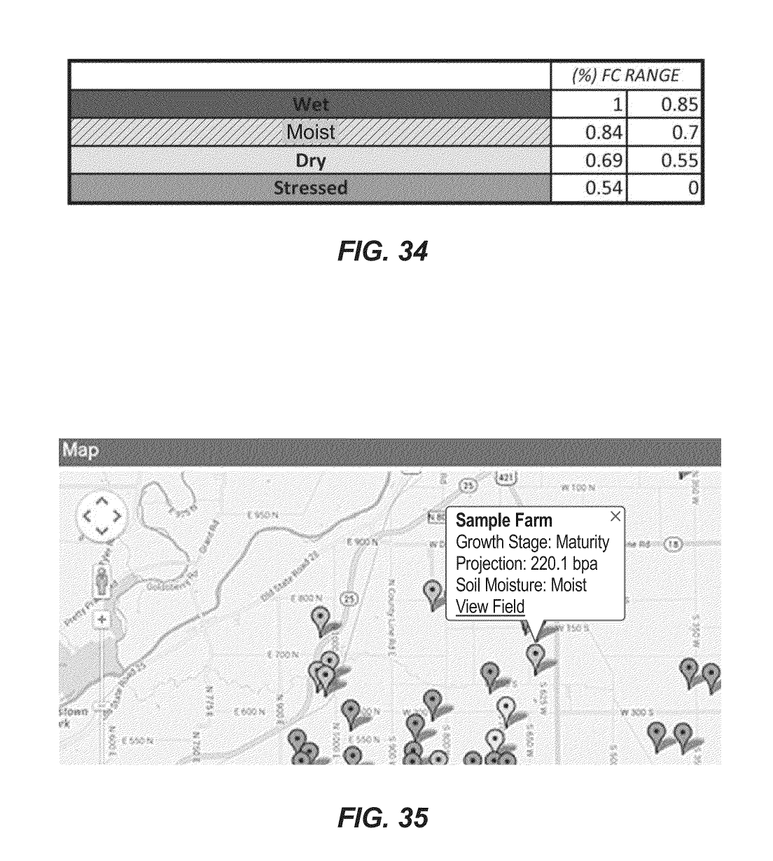

As indicated above, the end soil moisture may be divided into as many categories as desired and demonstrated to users in a variety of manners. With reference to FIG. 34, in this example the end soil moisture is separated into four categories and a color coding scheme is associated with the four categories to demonstrate variance in end soil moistures. In this example, the four exemplary categories include wet, moist, dry and stressed and each category includes a range of end soil moistures. The end soil moisture values in the associated column (see column 11) in the chart illustrated in FIGS. 33A-33F when compared to the exemplary category ranges illustrated in FIG. 34 determine the category for each hour of the day. The ends or limits of the ranges defining the various categories may be any value to define any possible ranges. In the illustrated example, the value of 0.54 defining the beginning or lower limit of the “stressed” range may be an important value because a plant at this level of soil moisture may not have sufficient moisture to maintain crop yield potential, whereas at a soil moisture value of 0.55 a plant may be dry, but has sufficient soil moisture to maintain yield potential. Additionally, in the illustrated example, the value of 0.85 defining the beginning or lower limit of the “wet” range may be an important value because a field at this level of soil moisture may be too wet to be navigated by equipment such as a harvester, sprayer, etc. Navigating a field that is too wet may damage the crop and/or equipment may get stuck in the saturated soil. Conversely, a field having a soil moisture of 0.84 may not be too wet and equipment may be able to navigate the field without damaging the crop or becoming stuck in the soil.

With reference to FIG. 35, one exemplary manner of demonstrating variance in soil moisture is illustrated. This example includes a visual format of data generated and displayed by the system 20 and/or the computing element 32 on a device including, but not limited to, devices 48, 52, 56 or any other device. In this example, the visual format 12 is a map including a variety of zones and a color coded indicator for each zone. The color coded indicator is associated with the end soil moisture (see, e.g., column 11 in FIGS. 33A-33F) for that zone at that particular time. Since soil moisture is calculated on an hourly basis in the chart illustrated in FIGS. 33A-33F, the map illustrated in FIG. 35 may be updated on an hourly basis to reflect the soil moisture for that particular hour.

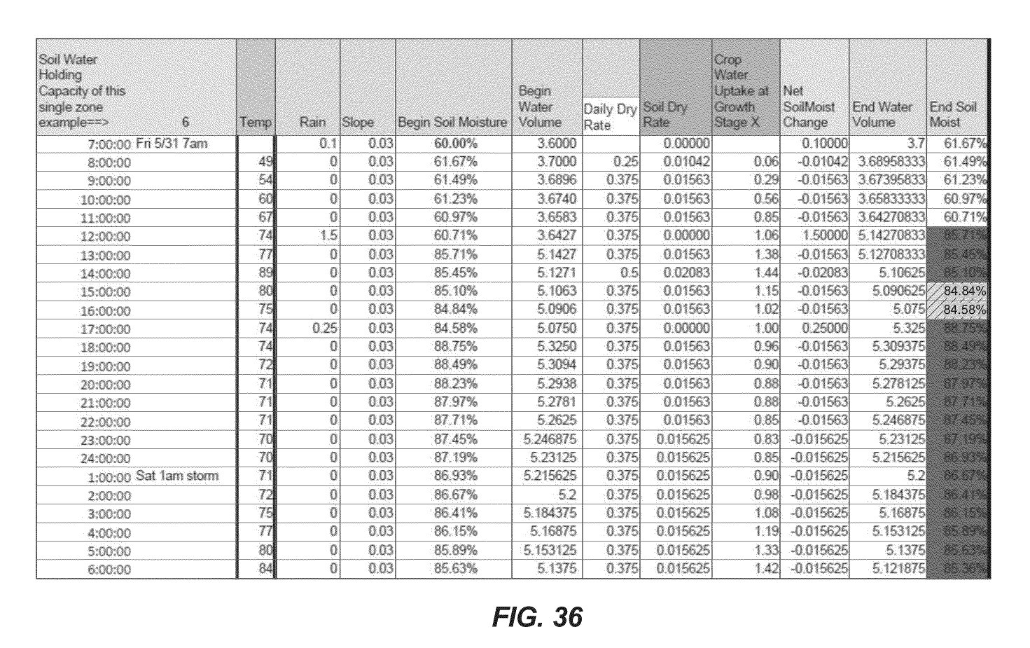

As indicated above, hourly soil moisture may be determined in a variety of manners utilizing a variety of variables and agronomic characteristics. For example, with reference to FIG. 36, hourly soil moisture may take into account temperature (see column 3), rainfall (see column 4), slope of the soil (see column 5), moisture capacity of the soil, weighted average field capacity, dryout values of the soil (see column 9), crop moisture uptake (see column 10), and other variables and characteristics.

With specific reference to FIG. 36, another example of determining hourly soil moisture will be described. This example includes a visual format of data generated an displayed by the system 20 and/or the computing element 32 on a device including, but not limited to, devices 48, 52, 56 or any other device. In this example, the visual format 12 is a map including a variety of columns represented a variety of agronomic characteristics. In this example, the first column is a time column. Since hourly soil moisture is being calculated, the time column includes time in hourly increments. The system 20 monitors time in the chosen time increment (hours in the illustrated examples). The system 20 may utilize other increments of time when calculating soil moisture at different time increments and, in such instances, the system 20 would include other increments in the time column. The next column is a notes column. The third column is a temperature column and the system 20 takes temperature readings at the time increments in the time column. In this example, the system 20 may include a thermometer that takes temperature readings at the associated time increments at the land area of interest, and then populates the temperature column with the temperature. In other examples, the system 20 may retrieve or collect temperature information from a database including temperatures associated with the land area of interest. As indicated above in the example illustrated in FIGS. 33-35, temperature can impact the soil moisture change. Higher temperatures may dryout or decrease the soil moisture at a faster rate than lower temperatures. Dryout values may be determined based on any increment of temperatures. For example, ranges of temperatures may be used to determine a dryout rate, dryout rates may be determined on an individual degree basis, or the dryout rate may change at increments smaller than a single degree.

With respect to the fifth column of FIG. 36, the system 20 utilizes the slope of the soil, which may impact the soil moisture. For example, if the soil is relatively flat, then moisture is more likely to settle or remain on the flat soil. If the soil is steeply sloped then moisture will run-off or otherwise depart the steeply sloped soil. Additionally, if the soil is a valley or location that collects moisture, then the soil is likely to have higher moisture. Further, if the soil is a peak or hill top, then soil is likely to run-off or otherwise depart the peak or hill top location. The slope value may vary depending on the slope of the soil and, therefore, the impact of the slope on the soil moisture may change as the slope varies. In the illustrated example, the slope value is the same for all time increments. However, in other examples, the slope value may vary.

The system 20 introduces beginning soil moisture in column #6 and is represented as a percentage. In the seventh column, the system 20 represents the beginning soil moisture or water volume in inches. In the eighth column, the system 20 includes a daily dry rate, which the system 20 bases on the temperature included in the temperature column. The second row, which represents the 8:00 AM hour on May 31, has a temperature of 49 degrees. In this example, the daily dry rate associated with a temperature of 49 degrees is 0.25. The third row, which represents the 9:00 AM hour on May 31, has a temperature of 54 degrees. In this example, the daily dry rate associated with a temperature of 54 degrees is 0.375. The eighth row, which represents the 2:00 PM hour on May 31, has a temperature of 89 degrees. In this example, the daily dry rate associated with a temperature of 89 degrees is 0.5. In this example, daily dry rates are determined based on three ranges of temperatures. Such ranges are comprised of a first range less than 50 degrees Fahrenheit, which has a daily dry rate of 0.25, a second range including and between 50 degrees Fahrenheit and 85 degrees Fahrenheit, which has a daily dry rate of 0.375, and a third range greater than 85 degrees Fahrenheit, which has a daily dry rate of 0.5. It should be understood that the daily dry rates may be any value and may be determined based on any quantity of temperature ranges and ranges defined by any temperature limits. The illustrated examples are provided to demonstrate principles of the present disclosure. To arrive at the hourly rate, which is represented in the ninth column, the system 20 divides the daily dry rate by 24 (24 hours in a day).

The type of crop and the growth stage of the crop also affect the soil moisture. The system 20 represents crop moisture uptake in the tenth column and may have various values based on the crop type and growth stage of the crop. The illustrated values associated with the crop uptake may be a variety of different values, are provided to demonstrate principles of the present disclosure and should not be limiting upon the present disclosure.

The system 20 represents the net soil moisture in the eleventh column and is the summation of all variables affecting the change in soil moisture. The net soil moisture may be represented in inches. For example, the net soil moisture may be equal to the impacts of crop uptake, crop dryout, slope and other possible variables and/or agronomic characteristics. The system 20 calculates the net soil moisture by subtracting from or adding to (depending on the final value) the beginning water volume (see column 7) to arrive at the end water volume (see column 12). Similarly to the example illustrated in FIGS. 33-35, the system 20 executes Formula (2) to arrive at the end soil moisture, which is converted to a percentage by multiplying by 100%. The system 20 represents the end soil moisture as a percentage in the last or thirteenth column in FIG. 36. The system 20 may represent the end soil moisture to a user in any of the manners described above, alternatives thereof, or equivalents thereof

The above examples illustrated in FIGS. 33-36 illustrate and describe rainfall as the water source affecting soil moisture. However, it should be understood that irrigation, tile systems, and/or any other water related systems may also affect soil moisture and may be considered in lieu of or in combination with rainfall when determining soil moistures.

It should be understood that the customization disclosed herein may be performed by a user, by a 3^{rd} party data source, by the system 20 itself, or any combination thereof

The system 20 and computing element 32 determine projections based on a variety of data or information. Such data and information may be a wide variety of data, such as the various types of data and information described herein, or other types of data. The system 20 and computing element 32 may determine such projections based on quantity of data, combination of data and any permutation of data. The following examples of the system 20 and the computing element 32 determining projections are only examples of the many possible projections and manners of projecting that the system 20 and the computing element 32 are capable of performing. The system 20 and computing element 32 are also capable of providing the projections in a variety of manners. The following examples of the system 20 and the computing element 32 providing projections are only examples of the many possible manners of providing projections. These examples are not intended to be limiting upon the present disclosure, but rather are provided to demonstrate at least some of the principles of the present disclosure.

As indicated above, the system 20 and the computing element 32 are capable of performing pre-season projections and in-season projections. Examples of types of projections include, but are not limited to, limiting growth factor, crop yield, moisture content of a crop, etc.

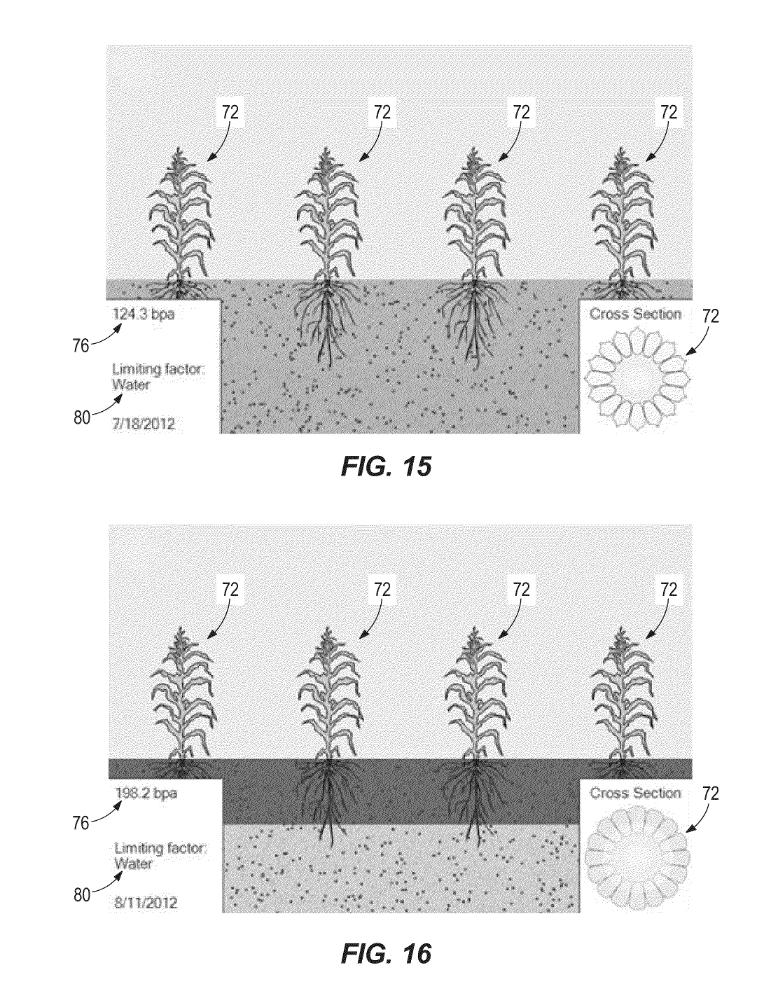

The system 20 and the computing element 32 may provide the projections and other data in a variety of manners. The system 20 and the computing element 32 may communicate the projections and data over one or more networks 44 to one or more devices. In one example, the system 20 and computing element 32 may communicate the projections and/or other data over one or more networks 44 to a device where a user may view the data (see FIG. 3) and/or hear the data. Examples of devices include, but are not limited to, personal computers 48, mobile electronic communication devices 52, agricultural devices 56, etc. The system 20 and computing element 32 may communicate projections and/or other data to the devices 48, 52, 56 in a variety of manners including, but not limited to, email, text, automated telephone call, telephone call from a person, a link to a website, etc. In such examples, the system 20 and computing element 32 may display or audibly produce the projections and/or other data in a variety of manners. For example, the projections and/or communicated data may be in a text format comprised purely of letters, words, and/or sentences. Also, for example, the projections and/or other data may be in a visual or illustrative format. The visual or illustrative format may take on many forms and display a wide variety of types of information. In one example, the visual format may display projections of crop growth at various stages of growth (see FIGS. 15 and 16). In such examples, a plant or plants 72 included in the crop may be shown at the selected growth stage. In the illustrated example, corn 72 is the illustrated crop. In FIG. 15, the corn is illustrated in the form it will likely take on Jul. 18, 2012. Note that the cross-section of the corn on Jul. 18, 2012 is underdeveloped. Then, in FIG. 16, the corn is illustrated again in the form it will likely take on Aug. 11, 2012. In FIG. 16, the cross-section of the corn shows that the corn is much more developed on Aug. 11, 2012. Also note that the projected crop yield 76 is also much higher on Aug. 11, 2012 than it was earlier on Jul. 18, 2012.

It should be understood that corn is shown only as an example and the system 20 may display any type of crop and any such possibility is intended to be within the spirit and scope of the present disclosure. For example, other possibilities for crops include, but are not limited to, soybeans, potatoes, wheat, barley, sorghum, etc.

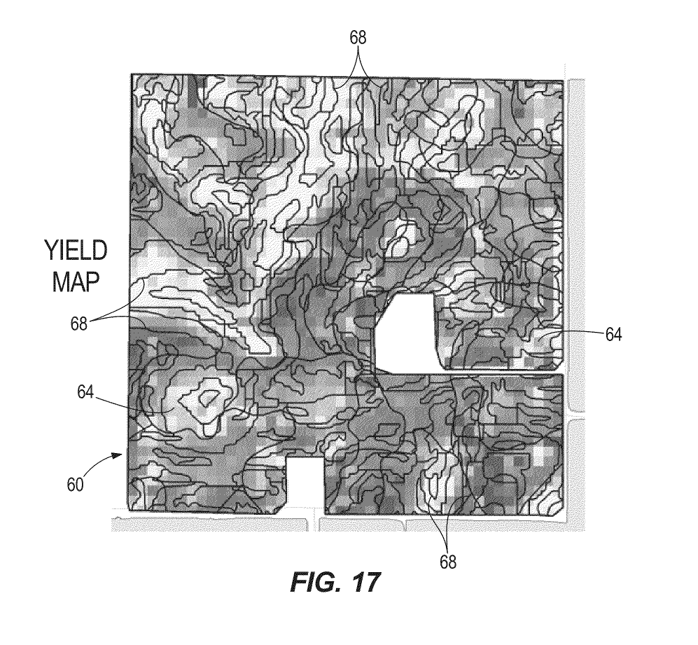

Further, for example, the system 20 and computing element 32 may communicate the projections and/or other data in a combination of text and visual formats. For example, with reference to FIGS. 15 and 16, both text and visual formats are shown. Examples of the text and illustrations shown include, but are not limited to, the date at which the projection is desired, multiple appearances of the plant(s) at the projection date (e.g., profile and cross-section), crop yield of the selected land area of interest and a limiting factor 80. Additionally, for example, the system 20 and computing element 32 may communicate the projections with visual formats only. For example, with reference to FIG. 17, estimated or projected crop yields are determined by the system 20 and the computing element 32, and the system 20 and computing element 32 illustrate the crop yield in a map format. The system 20 and computing element 32 may display the map format on a wide variety of devices including, but not limited to, one or more of the devices 48, 52, 56 or other devices. In the illustrated example, the varying greyscale colors represent different crop yields over a land area of interest. In one example, darker colors may represent higher crop yields and lighter or white colors may represent lower crop yields.

In one example, a user may view projections and/or other data at a land area of interest level, which may be comprised of a single zone, a single field including a plurality of zones, a group of fields associated with one another, or any other land area size.

In one example, a user may select via the system 20 a group including a plurality of fields. The system 20 and the computing element 32 will provide (in any of the manners described above or alternatives thereof, all of which are intended to be within the sprit and scope of the present disclosure) the projections and/or other data associated with a group. If a group is selected, the projection may include a weighted average sum of the crop yield for all of the crops included in the selected group of fields. This projection provided at this level by the system 20 may be beneficial to a user who manages a large quantity of fields and desires to know their overall crop yield. As data inputted into the system 20 and the computing element 32 changes (e.g., weather, inputs, etc.), the crop yield may change. The system 20 and the computing element 32 may communicate this change to one or more devices (e.g., 48, 52, 56) over one or more networks 44. This communication may also be referred to as an alert. The amount of change necessary to initiate an alert may be any size. In one example, the amount of change may be a unit of measure associated with crop yield such as, for example, bushels per acre (bpa).

In another example, the data communicated by the system 20 and computing element 32 with respect to the group of fields may be a limiting factor, which is an agronomic factor or characteristic that limits the crop yield. A wide variety of agronomic factors or characteristics may limit the crop yield and at least some of the limiting factors are described above. In one example, the communicated limiting factor may be the limiting factor for the entire group. Providing the limiting factor via the system 20 at the group level may be beneficial to a user who manages a large quantity of fields and desires to know the limiting factor that is having the largest impact on their entire group of fields. As data inputted into the system 20 and the computing element 32 changes (e.g., weather, inputs, etc.), the limiting factor may change. The system 20 and the computing element 32 may communicate this change to one or more devices (e.g., devices 48, 52, 56) over one or more networks 44. This communication may also be referred to as an alert. An alert may be communicated anytime the limiting factor changes. The user may then take appropriate action to account for the limiting factor.

In one example, a user may select a field including a plurality of zones. The system 20 and the computing element 32 will provide (in any of the manners described above or alternatives thereof, all of which are intended to be within the spirit and scope of the present disclosure) the projections and/or other data associated with the field and its zones. If a field is selected, the projection may include a crop yield for the single field and its zones. This projection provided at this level by the system 20 and the computing element 32 may be beneficial to a user who only has a single field or wants to drill down to a more detailed level where individual fields can be analyzed. As data inputted into the system 20 and the computing element 32 change (e.g., weather, inputs, etc.), the crop yield may change. The system 20 and the computing element 32 may communicate this change to one or more devices (e.g., devices 48, 52, 56) over one or more networks 44. This communication may also be referred to as an alert. The amount of change necessary to initiate an alert may be any size. In one example, the amount of change may be a unit of measure associated with crop yield such as, for example, bushels per acre (bpa).

In another example, the data communicated by the system 20 and the computing element 32 with respect to the single field and its zones may be a limiting factor, which is an agronomic factor or characteristic that limits the crop yield of the field. A wide variety of agronomic factors may limit the crop yield and at least some of the limiting factors are described above. The limiting factor communicated by the system 20 and the computing element 32 may be the limiting factor for the entire field. Providing the limiting factor with the system 20 and computing element 32 at the field level may be beneficial to a user who has only a single field or has a field with many zones and wishes to understand the limiting factor of the entire field. As data inputted into the system 20 and the computing element 32 changes (e.g., weather, inputs, etc.), the limiting factor may change. The system 20 and the computing element 32 may communicate this change to one or more devices (e.g., devices 48, 52, 56) over one or more networks 44. This communication may also be referred to as an alert. An alert may be communicated anytime the limiting factor changes. The user may then take appropriate action to account for the limiting factor.

In one example, a user may select, via the system 20, a particular zone of a field or fields comprised of a plurality of zones. The system 20 and the computing element 32 will provide (in any of the manners described above or alternatives thereof, all of which are intended to be within the spirit and scope of the present disclosure) the projections and/or other data associated with the single zone. If a zone is selected, the projection may include a crop yield for the single zone within the field. This projection provided at this level may be beneficial to a user that desires to know how each zone is performing. As data inputted into the system 20 and the computing element 32 changes (e.g., weather, inputs, etc.), the crop yield for a zone may change. The system 20 and the computing element 32 may communicate this change to one or more devices (e.g., devices 48, 52, 56) over one or more networks 44. This communication may also be referred to as an alert. The amount of change necessary to initiate an alert may be any size. In one example, the amount of change may be a unit of measure associated with crop yield such as, for example, bushels per acre (bpa).

In another example, the data communicated by the system 20 and computing element 32 with respect to a zone within one or more fields may be a limiting factor, which is an agronomic factor or characteristic that limits the crop yield. A wide variety of factors may limit the crop yield and at least some of the limiting factors are described above. The communicated limiting factor may be the limiting factor for just that zone. Other zones in the field or fields may have other limiting factors. Providing the limiting factor, via the system 20 and computing element 32, at the zone level may be beneficial because it provides the ability to drill down to a very specific level and allow understanding and crop planning for the specific zone. Rather than treat an entire field the same way, each zone within a field may be treated differently (e.g., irrigation, input, nutrients, etc.) to optimize crop yield in each zone, thereby optimizing crop yield over the entire land area of interest. As data inputted into the system 20 and the computing element 32 changes (e.g., weather, inputs, etc.), the limiting factor may change. The system 20 and the computing element 32 may communicate this change to one or more devices (e.g., devices 48, 52, 56) over one or more networks 44. This communication may also be referred to as an alert. An alert may be communicated anytime the limiting factor changes. The user may then take appropriate action to account for the limiting factor.

In one example, a plurality of projections and/or other data may be provided by the system 20 and computing element 32 for a plurality of zones or a plurality of fields. The system 20 and computing element 32 may provide such projections and/or other data in a list or multiple visual elements. This provides the ability to easily identify those zones or fields that may be underperforming or at least performing at a lower level than other zones or fields. A user may then address, via the system 20 and computing element 32, the underperforming zone(s)/field(s), determine a cause for low or lower performance, determine a remedy, and take appropriate action to remedy the low or lower performance.

In one example, the system 20 and the computing element 32 may communicate the projections and/or other data to one or more agricultural devices 56 to assist with controlling the one or more agricultural devices 56 in accordance with the communicated data.

As indicated above, the projections and/or other data may be used to plan or take appropriate action to improve the agronomics of a land area of interest. In one example, the projections and/or other data may be used to determine the best seed variety of a given land area of interest. A user may evaluate seed varieties, typically recommended by a user's agronomist or seed salesman, and a date of planting and the system 20 and the computing element 32 will analyze this inputted information along with other inputted information and determine a maximum crop yield and lowest input rate for each zone within the land area of interest. Once a desired result has been achieved, the result may be used for crop planning. In one example, a user takes action in accordance with the desired result. In another example, data associated with the desired result may be downloaded and communicated, via the system 20 and computing element 32, to one or more agricultural devices 56 where the one or more agricultural devices 56 may operate in accordance with the data. This feature may be valuable for crop planning purposes and provides users to tryout different seed varieties on different zone properties (e.g., soil, etc.) given a user's tolerance to risk and diversity. Growth conditions may change in-season and running many pre-season scenarios with the system 20 can prepare users for any potential changes.

In one example, the system 20 and computing element 32 may use the projections and/or other data to determine when nitrogen or other inputs should be applied and how much nitrogen or other input to apply. Crops have various growth stages and require different attention at the various growth stages. The system 20 and the computing element 32 may be used to determine at what growth stage to apply nitrogen and how much nitrogen to apply. A user may select, via the system 20 and one or more devices 48, 52, 56, a growth stage associated with the seed variety planted and/or select, via the system 20 and one or more devices 48, 52, 56, a date at which the user intends to apply nitrogen. The system 20 and computing element 32 analyze this information along with other inputted data such as, for example, soil data, seed data, weather data, etc. Growth characteristics change as the growth season progresses (e.g., soil condition, water levels, weather, etc.), which impacts the amount of nitrogen required by the crop. Examples of growth conditions that can affect nitrogen demand include, but are not limited to, large rain events, favorable soil mineralization, etc. This feature of the system 20 provides users with the ability to tryout different growth conditions and determine how these variances in growth conditions affect the crop's nitrogen demand so that the user will be ready to foresee and/or resolve nitrogen deficiencies before they occur or immediately after they occur during the growing season. In this example, the system 20 and the computing element 32 may communicate an alert to a user (e.g., via devices 48, 52) and/or an agricultural device 56 (in any of the manners described herein) indicating that a nitrogen deficiency is about to occur or has just occurred. The user and/or the agricultural device 56 can then take appropriate action to resolve the nitrogen deficiency.

In one example, the system 20 and computing element 32 may use the projections and/or other data to determine moisture content of a crop. In the past, farmers guessed the moisture content of the crop and determined a harvest date based on that guess. Also, in the past, farmers may have used a handheld moisture tester. In one example, the system 20 and the computing element 32 allow a user to determine the moisture content of the crop without guessing and without performing tests in the actual field or land area of interest. The system 20 and the computing element 32 receive and analyze various inputted data and determine the moisture content of the crop based on the inputted data. In one example, the inputted data relied upon by the system 20 and the computing element 32 to determine moisture content of the crop includes, but is not limited to, weather data, planting date and seed profile of the seed variety planted in the land area of interest. By having the system 20 and the computing element 32 calculate the moisture content of the crop, the user saves time and money by not having to perform tests in the field. An accurate moisture content informs the user about when the crop should be harvested. Certain crops require certain levels of moisture before they are ready for use, storage, sale, etc. If a user harvests a crop prior to the crop reaching the desired moisture content, the user must dry the crop the remaining amount. This drying process can be expensive and lengthy. Thus, the system 20 and the computing element 32 provide the necessary information with respect to crop moisture content to allow the user to make an educated decision of when to harvest a crop and how much drying will be required. It's up to the user to then perform a cost benefit analysis of harvesting versus letting the crop stand longer for additional drying.

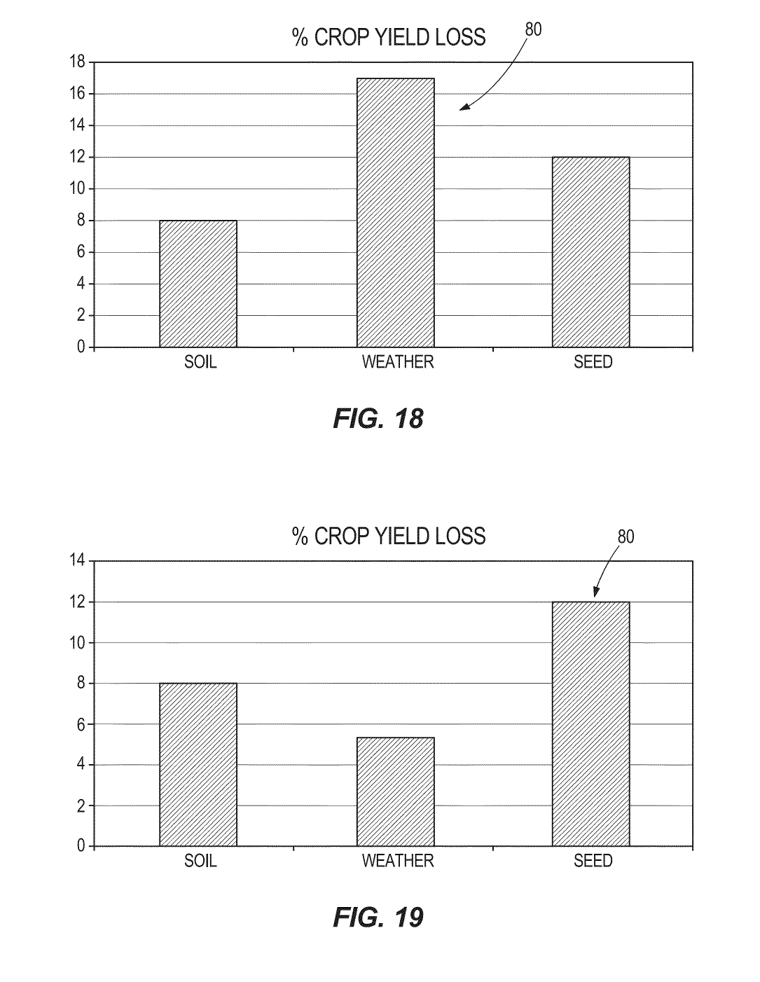

Referring now to FIGS. 18 and 19, one example of the system 20 and the computing element 32 determining a limiting factor 80 is illustrated and described. This example is provided to demonstrate principles of the present disclosure and is not intended to be limiting upon the present disclosure. Rather, the system 20 and the computing element 32 are capable of determining a limiting factor in a variety of other manners and all such manners are intended to be within the spirit and scope of the present disclosure.

In this example, the system 20 and the computing element 32 initially determine a percentage crop yield loss and then use the yield loss to determine the limiting factor. However, it is not necessary for the system 20 and computing element 32 to utilize only percentage crop yield loss in determining the limiting factor for in-season adjustments or pre-season crop planning. For example, the system 20 and computing element 32 may consider changes in yield loss/day, bushels per acre, bushels per seed, bushels per thousand seeds, bushels per inch of rain, bushels per pound of nitrogen, or frost risk in determining the limiting factor. In this sense, the limiting factor is the agronomic factor that impacts the yield loss the most or has the largest yield loss relative to other agronomic factors. While the system 20 and the computing element 32 can determine a percentage crop yield loss for any number of agronomic factors, this example considers three agronomic factors. The three agronomic factors are soil, seed and weather. Thus, the system 20 and the computing element 32 determine which one of these three agronomic factors results in the largest yield loss. The one of soil, seed and weather that results in the largest yield loss is determined to be the limiting factor.

Each of the three agronomic factors has subcategories or sub-factors that impact the system's and the computing element's calculation of the yield loss. For example, with respect to the soil agronomic factor, the system 20 and the computing element 32 may receive and analyze data associated with, for example, nitrogen rates, water holding capacity, soil type, soil pH, organic matter in the soil, CEC, percent of field capacity, mineralization, etc. In one example, nitrogen rates may be calculated by evaluating soil pH, organic matter, and CEC. CEC and pH may affect availability of nitrogen. The system 20 and the computing element 32 may retrieve organic matter data from a variety of sources including, but not limited to, a 3^{rd} party source, from a soil test performed by a soil testing device, a combination of the two, or other sources. In one example, field capacity is important in establishing the ideal nitrogen rate. A field may be completely saturated (e.g., 100 percent field capacity) or dry (e.g., about 50 percent field capacity). When the field is dry or has a low percent field capacity, no or very little mineralization is occurring. Mineralization is generally a conversion of organic nitrogen to ammonia. Between the saturated and dry boundaries, nitrogen will be mineralized at different rates. For example, more nitrogen will mineralize on hotter days compared to less mineralization on cooler days.

Also, for example with respect to the seed agronomic factor, the system 20 and the computing element 32 may receive and analyze data associated with seed rate and seed variety (includes seed profile data). The system 20 and the computing element 32 can extrapolate projected yields for different varieties of seeds having different relative maturity dates. Further, for example with respect to the weather agronomic factor, the system 20 and the computing element 32 may receive and analyze data associated with actual weather, historical weather, irrigation, growing degree days (GDD). The system 20 and computing element 32 receive or collect weather data from one or more sources including, but not limited to, a 3rd party source, a sensor or other testing device in the land area of interest, etc.

The system 20 and the computing element 32 receive and analyze all the subcategories of the three main agronomic factors and determine the percentage crop yield loss for each of the soil agronomic factor, the seed agronomic factor and the weather agronomic factor. In one example, the system 20 and the computing element 32 analyze all possible iterations of agronomic factors, to solve for the limiting agronomic factor. In another example, the system 20 and computing element 32 do not analyze all of the possible iterations but picks random combinations of agronomic factors, establishes upper and lower limits for yield loss, and continues iterating until the dataset has been narrowed down to only a handful of combinations from which the user can identify the limiting agronomic factor.

In one example, a user inputs a value associated with one of the agronomic factors (e.g., soil, seed, or weather). This inputted value may be any value, but, in some instances, may be based on historical data such as, for example, a typical quantity of seeds planted in past years, a typical amount of nitrogen applied in past years, or typical weather forecasts from past years. The system 20 and computing element 32 then select a lower value that is less than the inputted value and a higher value that is higher than the inputted value. The system 20 and computing element 32 then determine crop yields based on the inputted value, the higher value and the lower value. The system 20 and the computing element 32 may select any quantity of higher and lower values and determine corresponding crop yields. The system 20 and computing element 32 select higher and lower values moving outward and away from the inputted value or the system 20 and computing element 32 may select higher and lower values moving inward and toward the inputted value. The selected higher and lower values may have an interval or increment between consecutive values. This increment can be the same between all selected values or the increment may be different between selected values. This increment or increments may be selected by the computing element 32 or a user may select the increment or increments. The system 20 and the computing element 32 continue these iterations a predetermined quantity of times, a quantity of times selected by a user, or until determined crop yields resulting from the selected values change less than a predetermined or selected quantity. For example, if a change from one determined crop yield to a subsequent determined crop yield is less than a predetermined or selected quantity, the system 20 and the computing element 32 will stop selecting values and stop determining crop yields. The system 20 and the computing element 32 may then compare the determined crop yields and identify the highest crop yield and the associated agronomic factors for the highest crop yield. In one example, values of the other agricultural characteristics may remain the same while the value of the one of the agricultural characteristics changes as described above. In one example, values of the other agricultural characteristics may remain the same while the one of the agricultural characteristics changes as described above and may be associated with values resulting in maximum or optimal crop yields or other results. For example, a seed rate or value may remain the same at an optimal or maximum seed rate or value, the water may remain the same at an optimal or maximum water value and the nitrogen value may be iterated until an optimal rate of nitrogen is determined or identified. Also, for example, a nitrogen value may remain the same at an optimal or maximum nitrogen rate or value, the water may remain the same at an optimal or maximum water value and the seed rate may be iterated until an optimal seed rate is determined or identified. Further, for example, a nitrogen value may remain the same at an optimal or maximum nitrogen rate or value, the seed rate may remain the same at an optimal or maximum seed rate or value and the water may be iterated until an optimal water value is determined or identified.

In one example, the system 20 and computing element 32 selects a beginning value associated with the agronomic factor to begin iterations. The beginning value may be at or near a known top end of a range of values associated with the agronomic factor and the system 20 and the computing element 32 may perform iterations with the selected values decreasing. The beginning value may alternatively be at or near a known low end of a range of values associated with the agronomic factor and the system 20 and the computing element 32 may perform iterations with the selected values increasing. The iterations may be at a constant interval or increment or at different intervals or increments. The increment or increments may be selected by the system 20 and the computing element 32 or a user may select the increment or increments. The system 20 and the computing element 32 continue these iterations a predetermined quantity of times, a quantity of times selected by a user, or until determined crop yields resulting from the selected values change less than a predetermined or selected quantity. For example, if a change from one determined crop yield to a subsequent determined crop yield is less than a predetermined or selected quantity, the system 20 and the computing element 32 will stop selecting values and stop determining crop yields. The system 20 and the computing element 32 may then compare the determined crop yields and identify the highest crop yield and the associated agronomic factors for the highest crop yield. In one example, values of the other agricultural characteristics may remain the same while the value of the one of the agricultural characteristics changes as described above. In one example, values of the other agricultural characteristics may remain the same while the one of the agricultural characteristics changes as described above and may be associated with values resulting in maximum or optimal crop yields or other results. For example, a seed rate or value may remain the same at an optimal or maximum seed rate or value, the water may remain the same at an optimal or maximum water value and the nitrogen value may be iterated until an optimal rate of nitrogen is determined or identified. Also, for example, a nitrogen value may remain the same at an optimal or maximum nitrogen rate or value, the water may remain the same at an optimal or maximum water value and the seed rate may be iterated until an optimal seed rate is determined or identified. Further, for example, a nitrogen value may remain the same at an optimal or maximum nitrogen rate or value, the seed rate may remain the same at an optimal or maximum seed rate or value and the water may be iterated until an optimal water value is determined or identified.

For illustrative purposes and to demonstrate principles of the disclosure, these three exemplary agronomic factors and their yield losses may be presented in a visual format by the system 20 and computing element 32 by communicating data to one or more displays or monitors in one or more devices including, but not limited to, devices 48, 52, 56. In this example, the visual format is a graph. This exemplary visual representation is not intended to be limiting upon the present disclosure. Rather, the agronomic factors and their yield loss may be represented in a variety of manners or forms and all of such possibilities are intended to be within the spirit and scope of the present disclosure.

With particular reference to FIG. 18, an example of possible yield losses for the three agronomic factors is illustrated. In this example, the system 20 and computing element 32 determine that weather (e.g., water or other resultant of weather) has the highest percentage crop yield loss compared to seed and soil. Thus, in this example, the system 20 and computing element 32 determine that weather is the limiting factor. As a result of this determination, the system 20 and the computing element 32 communicate the limiting factor to one or more devices (e.g., devices 48, 52, 56) over one or more networks 44 as described elsewhere in the present disclosure. The user then may store the information for later use (e.g., document for crop planning purposes and use at a later time when planting crops), the user may take action, and/or the system 20 and computing element 32 communicate the limiting factor to one or more agricultural devices 56 where the one or more agricultural devices 56 may operate in accordance with limiting factor data.

In this illustrated example, weather is the limiting factor. The system 20 and the computing element 32 may communicate to a user, via one or more devices 48, 52, 56, that weather is the limiting factor. In one example, if water is the weather condition that contributes to weather being the limiting factor, the user may activate the irrigation system associated with the land area of interest to control the water supply, thereby decreasing the percentage crop yield loss associated with weather.

In some examples, activation of the irrigation system may include activating an above grade irrigation system or a below grade irrigation system. With respect to an above grade example such as a center pivot, the center pivot irrigation system may be activated to turn on the water supply or may be activated to turn off the water depending on how the water is limiting the crop yield (e.g., too much water or too little water). With respect to a below grade example such as a tiling system, the tiling irrigation system may be closed to maintain water in the soil or may be opened to allow water to run out of the soil depending on how the water is limiting the crop yield (e.g., too little water or too much water). In any of the above examples, the activation may either be performed manually by a user after viewing the associated data on one or more devices (e.g., devices 48, 52, 56) or by the system 20 and the computing element 32 communication data directly to the agricultural device 56 (e.g., an irrigation system). When the yield loss associated with weather decreases below a percentage crop yield loss for another agronomic factor, then the other agronomic factor becomes the limiting factor. In FIG. 19, the yield loss for weather has dropped below the yield loss for seed, which now has the highest yield loss. Thus, the system 20 and computing element 32 determine that seed is now the limiting factor (see FIG. 19). The system 20 and the computing element 32 communicate data (e.g., an alert) associated with the new or change in limiting factor (e.g., see as illustrated in FIG. 19) to one or more devices (e.g., devices 48, 52, 56) over one or more networks 44. The system 20 and the computing element 32 continually analyze inputted data to determine the limiting factor and communicate any changes in limiting factor so appropriate action can be taken.

It should be understood that the system 20 and/or computing element 32 may create zones of a land area of interest based on any agronomic factor, soil characteristic, seed characteristic, and/or weather characteristic either individually or in combination in any quantities and in any proportions, and all of such possibilities are intended to be within the spirit and scope of the present disclosure.

The system 20 of the present disclosure may also determine a limiting factor based on different variables or characteristics. In one example, the system 20 determines a limiting factor by relying on economic indicators or variables, either in part or in whole. For example, the system 20 determines a limiting factor for providing a highest crop yield at a lowest cost. In this example, the system 20 determines costs associated with a wide variety of factors, variables, steps during the growth process, analyzes the costs, and considers the costs to determine a limiting factor. Some of the possible costs associated with the growth process include, but are not limited to: input costs from, for example, seeds, nitrogen, irrigation, pesticides, etc.; fuel charges; labor costs; etc. Additionally, the system 20 may determine and rely on other economic factors such as, for example, cost per seed (e.g., may be different at different planting rates—bulk discount or efficiency goes up as more seeds are planted resulting in lower cost per seed); break even cost; various cost breakdowns of inputs (e.g., nitrogen cost per pass in zone/field, cost of a unit of measure of nitrogen (e.g., pound, etc.), fuel efficiency, etc.); or a wide variety of other factors. In this manner, the system 20 may be able to provide optimal results of both agriculture and economics.

It should also be understood that any feature, function, process, and/or method of the present disclosure may be customizable by a user and all of such customization is intended to be within the spirit and scope of the present disclosure. For example, zones and/or slopes may be customized by a user as desired.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the systems, methods, processes, apparatuses and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the systems, apparatuses, devices, methods and/or processes via the use of block diagrams, schematics, flowcharts, examples and/or functional language. Insofar as such block diagrams, schematics, flowcharts, examples and/or functional language contain one or more functions and/or operations, it will be understood by those within the art that each function and/or operation within such block diagrams, schematics, flowcharts, examples or functional language can be implemented, individually and/or collectively, by a wide range of hardware, software, firmware, or virtually any combination thereof. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a computer readable memory medium such as a magnetic medium like a floppy disk, a hard disk drive, and magnetic tape; an optical medium like a Compact Disc (CD), a Digital Video Disk (DVD), and a Blu-ray Disc; computer memory like random access memory (RAM), flash memory, and read only memory (ROM); and a transmission type medium such as a digital and/or an analog communication medium like a fiber optic cable, a waveguide, a wired communications link, and a wireless communication link.

The herein described subject matter sometimes illustrates different components associated with, comprised of, contained within or connected with different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two or more components herein combined to achieve a particular functionality can be seen as “associated with” each other such that the desired functionality is achieved, irrespective of architectures or intermediate components. Likewise, any two or more components so associated can also be viewed as being “operably connected”, or “operably coupled”, to each other to achieve the desired functionality, and any two or more components capable of being so associated can also be viewed as being “operably couplable”, to each other to achieve the desired functionality. Specific examples of operably couplable include, but are not limited to, physically mateable and/or physically interacting components, and/or wirelessly interactable and/or wirelessly interacting components, and/or logically interacting and/or logically interactable components.

Unless specifically stated otherwise or as apparent from the description herein, it is appreciated that throughout the present disclosure, discussions utilizing terms such as “accessing,” “aggregating,” “analyzing,” “applying,” “brokering,” “calibrating,” “checking,” “combining,” “communicating,” “comparing,” “conveying,” “converting,” “correlating,” “creating,” “defining,” “deriving,” “detecting,” “disabling,” “determining,” “enabling,” “estimating,” “filtering,” “finding,” “generating,” “identifying,” “incorporating,” “initiating,” “locating,” “modifying,” “obtaining,” “outputting,” “predicting,” “receiving,” “reporting,” “retrieving,” “sending,” “sensing,” “storing,” “transforming,” “updating,” “using,” “validating,” or the like, or other conjugation forms of these terms and like terms, refer to the actions and processes of a computer system or computing element (or portion thereof) such as, but not limited to, one or more or some combination of: a visual organizer system, a request generator, an Internet coupled computing device, a computer server, etc. In one example, the computer system and/or the computing element may manipulate and transform information and/or data represented as physical (electronic) quantities within the computer system's and/or computing element's processor(s), register(s), and/or memory(ies) into other data similarly represented as physical quantities within the computer system's and/or computing element's memory(ies), register(s) and/or other such information storage, processing, transmission, and/or display components of the computer system(s), computing element(s) and/or other electronic computing device(s). Under the direction of computer-readable instructions, the computer system(s) and/or computing element(s) may carry out operations of one or more of the processes, methods and/or functionalities of the present disclosure.

Those skilled in the art will recognize that it is common within the art to implement apparatuses and/or devices and/or processes and/or systems in the fashion(s) set forth herein, and thereafter use engineering and/or business practices to integrate such implemented apparatuses and/or devices and/or processes and/or systems into more comprehensive apparatuses and/or devices and/or processes and/or systems. That is, at least a portion of the apparatuses and/or devices and/or processes and/or systems described herein can be integrated into comprehensive apparatuses and/or devices and/or processes and/or systems via a reasonable amount of experimentation.

Although the present disclosure has been described in terms of specific embodiments and applications, persons skilled in the art can, in light of this teaching, generate additional embodiments without exceeding the scope or departing from the spirit of the present disclosure described herein. Accordingly, it is to be understood that the drawings and description in this disclosure are proffered to facilitate comprehension of the present disclosure, and should not be construed to limit the scope thereof.

1. A method of operating an agricultural system, the method comprising:
obtaining, with a computing element, first data associated with a plurality of agronomic characteristics from at least one source;
identifying one of the plurality of agronomic characteristics that limits the yield of an agricultural crop with the computing element based on the first data;
generating second data associated with the one of the plurality of agronomic characteristics that limits the yield of an agricultural crop with the computing element; and
communicating, with the computing element, the second data associated with the one of the plurality of agronomic characteristics that limits the yield of an agricultural crop over a network to an electronic device.

2. The method of claim 1, wherein the source includes at least one of a database, a data collection device, an agricultural device and an electronic device.

3. The method of claim 2, wherein the electronic device associated with the source is at least one of a personal computer and a mobile electronic communication device.

4. The method of claim 2, wherein the data collection device is at least one of a sensor, a soil testing device, a thermometer, a barometer, an aerial vehicle, an image capturing device, a wind speed determining device, a moisture sensor, and a satellite.

5. The method of claim 2, wherein the electronic device associated with the source is the same as the electronic device to which the second data is communicated.

6. The method of claim 1, wherein the source includes at least two of a database, a data collection device, an agricultural device and an electronic device.

7. The method of claim 1, wherein the electronic device is at least one of a personal computer, a mobile electronic communication device and an agricultural device.

8. The method of claim 7, wherein the agricultural device is at least one of a tractor, a planter, a harvester, a sprayer, an irrigation system, and a soil working implement.

9. The method of claim 7, wherein the electronic device is an agricultural device, the method further comprising displaying an image associated with the one of the plurality of agronomic characteristics that limits the yield of an agricultural crop on a display in the agricultural device.

10. The method of claim 1, wherein the plurality of agricultural characteristics is associated with at least one of seed characteristics, weather characteristics and soil characteristics.

11. The method of claim 10, wherein the plurality of agricultural characteristics is associated with at least two of seed characteristics, weather characteristics and soil characteristics.

12. The method of claim 1, wherein the plurality of agricultural characteristics is associated with at least two of tillage practices, drainage, irrigation, seed traits, seed population, row width, vegetative state, sunlight, soil properties, nutrient uptake, micronutrient uptake, organic matter, root room, aeration, soil temperature, soil moisture, cation exchange capacity, soil pH, historical weather, plant moisture, water quality, slope of land area, as applied planting data, historical planting data, historical yield data, as applied fertilizer data, historical fertilizer data, historical weather data, current weather data, pests, diseases, weeds, and economic data.

13. The method of claim 1, wherein the obtaining first data further comprises obtaining first data associated with planting date, row width, seed traits, seed population, soil properties, nutrient uptake, organic matter, a soil sample, historical weather data and current weather data.

14. The method of claim 1, wherein obtaining first data further comprises obtaining first data associated with a tillage practice, drainage, irrigation, planting date, relative maturity, plot trial data, growing degree days, ear flex, crop water requirements, crop nutrient and micronutrient needs, actual seed population, row width, current vegetative state, soil properties, previous and current crop nutrient uptake, previous and current crop micronutrient uptake, organic matter, initial nitrogen content, initial potassium content, initial phosphorous content, nitrogen losses, nitrogen form, soil water holding capacity, mineralization, C:N ratio, root room, aeration, soil temperature, soil moisture, cation exchange capacity, soil pH, historical weather, plant moisture, sodicity, salinity, boron, chloride, fpH of available water, slope of land area, as applied and historical planting data, historical harvest data, as applied and historical fertilizer data, weather patterns, short range weather forecast, long range weather forecast, rainfall, frost, wind, air temperature, humidity, barometric pressure, sunlight, type of weather events, pests, diseases, weeds and economic data.

15. The method of claim 1, wherein obtaining further comprises obtaining the first data associated with the plurality of agronomic characteristics from a plurality of sources.

16. The method of claim 1, further comprising outputting information associated with the second data with an output device of the electronic device.

17. The method of claim 16, wherein outputting further comprises displaying the one of the plurality of agronomic characteristics that limits the yield of an agricultural crop on a display.

18. The method of claim 16, further comprising performing an agricultural action with an agricultural device based on the information outputted by the output device.

19. The method of claim 1, further comprising performing an agricultural action with an agricultural device based on the second data communicated by the computing element.

20. The method of claim 1, wherein the second data comprises identification of the one of the agricultural characteristics that limits yield of a crop and a recommendation of an agricultural action to be taken to address the one of the agricultural characteristics that limits yield of a crop as being the limiting agronomic characteristic.

21. The method of claim 1, further comprising displaying an image associated with the one of the plurality of agronomic characteristics that limits the yield of an agricultural crop on a display of the electronic device.

22. The method of claim 1, wherein the network is at least one of a cellular network, an Internet, an intranet, a local area network (LAN), a wide area network (WAN), and a cable network.

23. The method of claim 1, further comprising:
determining a crop yield with the computing element based on the first data;
generating third data associated with the crop yield with the computing element; and
communicating, with the computing element, the third data associated with the crop yield over a network to the electronic device.

24. The method of claim 23, wherein the crop yield is a first crop yield, the method further comprising:
obtaining, with the computing element, fourth data associated with the plurality of agronomic characteristics from the at least one source, wherein the fourth data is different than the first data;
identifying one of the plurality of agronomic characteristics that limits the yield of an agricultural crop with the computing element based on the fourth data;
determining a second crop yield with the computing element based on the fourth data;
generating, with the computing element, fifth data associated with the second crop yield;
generating, with the computing element, sixth data associated with the one of the plurality of agronomic characteristics that limits the yield of an agricultural crop based on the fourth data; and
communicating, with the computing element, the fifth data and the sixth data over a network to the electronic device.

25. The method of claim 24, further comprising altering at least one of the plurality of agronomic characteristics to provide the fourth data.

26. The method of claim 24, further comprising altering at least one of the plurality of agronomic characteristics with an input device on the electronic device to provide the fourth data.

27. The method of claim 26, wherein altering occurs subsequent to communicating the second data to the electronic device and prior to obtaining the fourth data.

28. The method of claim 1, wherein the plurality of agricultural characteristics is associated with at least one of a seed characteristic, a weather characteristic, a soil characteristic and an economic characteristic.

29. The method of claim 28, wherein the economic characteristic is associated with at least one of seed cost, cost per seed, input cost, fuel cost, labor cost, break even cost and fuel efficiency of equipment.

30. The method of claim 29, wherein the input cost is associated with at least one of nitrogen cost, irrigation cost and pesticide cost.

31-122. (canceled)
